(19) United States
(12) Patent Application Publication
(10) Pub. No.: US 2009/0232351 A1
(43) Pub. Date: Sep. 17, 2009

(54) Authentication method, authentication device, and recording medium

(75) Inventors: Kenji Kagitani, Kanagawa (JP); Yumiko Kishi, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/382,235

(22) Filed: Mar. 11, 2009

(30) Foreign Application Priority Data
Mar. 12, 2008 (JP) 2008-063170
Sep. 11, 2008 (JP) 2008-234029

(51) Int. Cl. G06K 9/00

(52) U.S. Cl. 382/100

(57) ABSTRACT

An authentication method performed by an authentication device to authenticate a user includes an authentication-use image generating step of generating an authentication-use image including authentication-use information corresponding to an image expressing one or more characters and/or symbols which is provided on a background, wherein an edge formed by a difference in image density does not exist between the background and the image expressing the characters and/or the symbols; an authentication-use image presenting step of presenting, to the user, the authentication-use image generated at the authentication-use image generating step; and an authentication step of performing authentication by comparing character and/or symbol information input by the user based on the authentication-use image presented at the authentication-use image presenting step, with the characters and/or the symbols in the authentication-use image.

### BACKGROUND OF THE INVENTION

1. Field of the Invention

The present invention relates to an authentication method, an authentication device, and a recording medium.

2. Description of the Related Art

The recent years have witnessed the increasing pervasiveness of user-participation-type content generating systems on the Internet, such as electronic bulletin boards, weblogs, and Wikis. Many of these systems not only allow users to view information, but also to freely post information upon undergoing a simple user registration operation.

However, public nuisances are also increasing, which are made by taking advantage of such features. For example, a computer program called “bot” is used, which automatically interacts with the server to indiscriminately acquire a large number of accounts of such websites, and to post advertisements that are totally unrelated to the respective websites. Furthermore, the “bot” uses a charge-free e-mail address acquiring service to automatically and fraudulently acquire a large number of e-mail addresses. The acquired e-mail addresses are used for making various nuisances on the Internet, such as indiscriminately sending junk e-mails to a large indefinite number of addresses, or for making nuisances in the user-participation-type content generating systems.

In order to prevent such nuisances, there has been conceived a system for determining whether the user is actually a human being or the above-described “bot”, and allowing posting only when the user is determined to be a human being. This system is generally referred to as an anti-robot test. Information that can be identified by human beings, but not by currently-available computer programs (or difficult to be identified by computer programs), is displayed as a test. Only when this information is identified, the user is allowed to post information. Specifically, the program called “bot” analyzes messages exchanged in the form of character information between the clients and the server, and automatically generates a camouflaged message from the client. Therefore, in order for the client to send a message, the system requires a result indicating that information from the server other than character information, which can only be identified by an actual human being, has been identified.

A visual type anti-robot test is often used. Specifically, an image including rasterized characters and symbols is displayed, and the user is prompted to read the characters and symbols in the image, and to input the read results into an input form. This system is based on the fact that a human being can easily read characters in the image, whereas it is difficult for a computer program to read such characters. This system may also be based on the fact that the profit gained by making the above-described nuisances may not be worth the cost required for executing such a program.

However, with the advancement of the technology that enables a computer to recognize characters in images, such as OCR (Optical Character Recognition), the above-described defense against nuisances is becoming weaker year after year. In an attempt to prevent character recognition by OCR, a technology referred to as Captcha (registered trademark) has been developed, which uses image data with characters and symbols that are distorted or covered.

Patent Document 1: Japanese Laid-Open Patent Application No. 2005-322214

However, given the recent advancement in the technology that enables computers to recognize images, it is presumed that in the near future, there may be devised an easy and low-cost technology for deceiving and breaking through the system of the visual type anti-robot test described in patent document 1 and in “the description of the related art”. Accordingly, such a system may inevitably become weaker.

### SUMMARY OF THE INVENTION

The present invention provides an authentication method, an authentication device, and a recording medium, in which one or more of the above-described disadvantages are eliminated.

A preferred embodiment of the present invention provides an authentication method, an authentication device, and a recording medium, which can reinforce security by making it difficult for a “bot”, which has a function of recognizing characters in an image to make a nuisance.

According to an aspect of the present invention, there is provided an authentication method performed by an authentication device to authenticate a user, the authentication method including an authentication-use image generating step of generating an authentication-use image including authentication-use information corresponding to an image expressing one or more characters and/or symbols which is provided on a background, wherein an edge formed by a difference in image density does not exist between the background and the image expressing the characters and/or the symbols; an authentication-use image presenting step of presenting, to the user, the authentication-use image generated at the authentication-use image generating step; and an authentication step of performing authentication by comparing character and/or symbol information input by the user based on the authentication-use image presented at the authentication-use image presenting step, with the characters and/or the symbols in the authentication-use image.

According to an aspect of the present invention, there is provided an authentication method performed by an authentication device to authenticate a user, the authentication method including an authentication-use video generating step of generating an authentication-use video including authentication-use information corresponding to an image expressing one or more characters and/or symbols constituted by a second texture which is provided on a background constituted by a first texture, wherein a positional relationship between the background and the authentication-use information changes with time; an authentication-use video presenting step of presenting, to the user, the authentication-use video generated at the authentication-use video generating step; and an authentication step of performing authentication by comparing character and/or symbol information input by the user based on the authentication-use video presented at the authentication-use video presenting step, with the characters and/or the symbols in the authentication-use video.

According to an aspect of the present invention, there is provided an authentication device for authenticating a user, the authentication device including an authentication-use image/video generating unit configured to generate any one of an authentication-use image including authentication-use information corresponding to an image expressing one or more characters and/or symbols which is provided on a background, wherein an edge formed by a difference in image density does not exist between the background and the image expressing the characters and/or the symbols, the authentication-use image wherein the background is constituted by a first texture and the authentication-use information corresponding to the image expressing the characters and/or the symbols is constituted by a second texture that is different from the first texture, the authentication-use image corresponding to a stereogram image in which the image expressing the characters and/or the symbols is embedded, the authentication-use image wherein in the image expressing the characters and/or the symbols, each of the characters and/or the symbols is constituted by plural characters and/or symbols, and an authentication-use video including the authentication-use information corresponding to the image expressing the characters and/or symbols constituted by the second texture which is provided on the background constituted by the first texture, wherein a positional relationship between the background and the authentication-use information changes with time; an authentication-use image/video presenting unit configured to present, to the user, the authentication-use image or the authentication-use video generated by the authentication-use image/video generating unit; and

an authentication unit configured to perform authentication by comparing character and/or symbol information input by the user based on the authentication-use image or the authentication-use video presented by the authentication-use image/video presenting unit, with the characters and/or the symbols in the authentication-use image or the authentication-use video.

According to one embodiment of the present invention, an authentication method, an authentication device, and a recording medium are provided, which can reinforce security by making it difficult for a “bot”, which has a function of recognizing characters in an image, to make a nuisance.

### BRIEF DESCRIPTION OF THE DRAWINGS

Other objects, features and advantages of the present invention will become more apparent from the following detailed description when read in conjunction with the accompanying drawings, in which:

FIGS. 1A and 1B illustrate an example of an authentication system according to a first embodiment of the present invention;

FIG. 2 illustrates an example of the functional configuration of the authentication system according to the first embodiment of the present invention;

FIG. 3 is a flowchart illustrating an example of operations of the authentication system according to the first embodiment of the present invention;

FIG. 4 is a flowchart illustrating another example of operations of the authentication system according to the first embodiment of the present invention;

FIG. 5 illustrates an example of an authentication-use image used in a conventional authentication system;

FIG. 6 illustrates a first example of the authentication-use image according to the first embodiment of the present invention;

FIG. 7 is for giving a supplemental description for the first example of the authentication-use image according to the first embodiment of the present invention;

FIG. 8 illustrates a second example of the authentication-use image according to the first embodiment of the present invention;

FIGS. 9A and 9B illustrate an example of an authentication-use video according to the first embodiment of the present invention;

FIGS. 10A and 10B are for giving a supplemental description (part 1) for the authentication-use video shown in FIGS. 9A and 9B;

FIGS. 11A and 11B are for giving a supplemental description (part 2) for the authentication-use video shown in FIGS. 9A and 9B;

FIG. 12 illustrates a third example of the authentication-use image according to the first embodiment of the present invention;

FIGS. 13A, 13B, and 13C are for giving a supplemental description for the authentication-use image shown in FIG. 12;

FIG. 14 illustrates a fourth example of the authentication-use image according to the first embodiment of the present invention;

FIG. 15 is for giving a supplemental description for the authentication-use image shown in FIG. 14;

FIG. 16 illustrates a fifth example of the authentication-use image according to the first embodiment of the present invention;

FIG. 17 illustrates a sixth example of the authentication-use image according to the first embodiment of the present invention;

FIG. 18 illustrates a seventh example of the authentication-use image according to the first embodiment of the present invention;

FIG. 19 illustrates an eighth example of the authentication-use image according to the first embodiment of the present invention;

FIG. 20 illustrates a ninth example of the authentication-use image according to the first embodiment of the present invention;

FIGS. 21A and 21B illustrate a tenth example of the authentication-use image according to the first embodiment of the present invention;

FIG. 22 illustrates a first example of a screen page for presenting an authentication-use video according to a second embodiment of the present invention;

FIG. 23 illustrates a first example of the authentication-use video according to the second embodiment of the present invention;

FIG. 24 is for giving a supplemental description for FIG. 23;

FIG. 25 illustrates a second example of the authentication-use video according to the second embodiment of the present invention;

FIG. 26 illustrates a second example of a screen page presenting the authentication-use video according to the second embodiment of the present invention;

FIG. 27 illustrates a third example of the authentication-use video according to the second embodiment of the present invention;

FIG. 28 illustrates a fourth example of the authentication-use video according to the second embodiment of the present invention;

FIG. 29 illustrates an example of a screen page presenting the authentication-use video according to a third embodiment of the present invention;

FIG. 30 is a flowchart illustrating an example of operations of the authentication system according to the third embodiment of the present invention;

FIG. 31 is a flowchart illustrating another example of operations of the authentication system according to the third embodiment of the present invention;

FIG. 32 is a flowchart illustrating modification 1 of operations of the authentication system according to the third embodiment of the present invention;

FIG. 33 is a flowchart illustrating modification 2 of operations of the authentication system according to the third embodiment of the present invention;

FIG. 34 is a flowchart illustrating modification 3 of operations of the authentication system according to the third embodiment of the present invention;

FIG. 35 illustrates a system configuration of the authentication system according to the third embodiment of the present invention;

FIG. 36 illustrates a data structure of the authentication-use image;

FIG. 37 illustrates a data structure for classifying the authentication-use images;

FIG. 38 is for describing how a user operates an image database;

FIG. 39 is for describing an operation when a service using the image database is implemented as a WEB application;

FIG. 40 illustrates an example of a screen page presenting authentication-use images presented by the WEB application;

FIG. 41 illustrates a screen page displayed for prompting a user to input a user name and a password;

FIG. 42 illustrates a screen page displayed for prompting a user to select “search for image” or “post image”;

FIG. 43 illustrates a screen page displayed for prompting a user to input information pertaining to “search for image”;

FIG. 44 illustrates an example of a screen page displaying results of the image search;

FIG. 45 illustrates a screen page displayed for prompting a user to input information pertaining to “post image”;

FIG. 46 is a block diagram of a hardware configuration of an authentication device according to a fourth embodiment of the present invention;

FIG. 47 is a flowchart illustrating an example of operations of the authentication system according to the fourth embodiment of the present invention;

FIG. 48 is a flowchart illustrating an example of operations of the authentication system according to the fourth embodiment of the present invention;

FIG. 49 is a flowchart illustrating an example of operations for acquiring an account performed by the authentication system according to the fourth embodiment of the present invention;

FIG. 50 shows a first example of authentication-use images according to the fourth embodiment of the present invention;

FIG. 51 shows a second example of authentication-use images according to the fourth embodiment of the present invention;

FIG. 52 shows a third example of authentication-use images according to the fourth embodiment of the present invention;

FIG. 53 shows a fourth example of authentication-use images according to the fourth embodiment of the present invention;

FIG. 54 shows a fifth example of authentication-use images according to the fourth embodiment of the present invention;

FIG. 55 shows a sixth example of authentication-use images according to the fourth embodiment of the present invention;

FIG. 56 is a flowchart illustrating operations of a test program according to a fifth embodiment of the present invention;

FIGS. 57A, 57B, and 57C illustrate examples of images displayed by the test program according to the fifth embodiment of the present invention;

FIG. 58 is a timing chart indicating operations of the test program according to the fifth embodiment of the present invention;

FIG. 59 is a timing chart indicating operations of the test program according to the fifth embodiment of the present invention;

FIG. 60 is a timing chart indicating operations of the test program according to the fifth embodiment of the present invention;

FIG. 61 is a timing chart indicating operations of the test program according to the fifth embodiment of the present invention;

FIG. 62 is a timing chart indicating operations of the test program according to the fifth embodiment of the present invention;

FIG. 63 is a timing chart indicating operations of the test program according to the fifth embodiment of the present invention;

FIG. 64 is a timing chart indicating operations of the test program according to the fifth embodiment of the present invention;

FIG. 65 is a timing chart indicating operations of the test program according to the fifth embodiment of the present invention;

FIG. 66 illustrates an example of an image to be combined with another image according to a sixth embodiment of the present invention;

FIG. 67 illustrates an example of an image to be combined with another image according to the sixth embodiment of the present invention;

FIG. 68 illustrates an example of an image to be combined with another image according to the sixth embodiment of the present invention;

FIG. 69 illustrates an example of an image to be combined with another image according to the sixth embodiment of the present invention;

FIG. 70 illustrates an example of an image to be combined with another image according to the sixth embodiment of the present invention;

FIG. 71 illustrates an example of an image to be combined with another image according to the sixth embodiment of the present invention;

FIG. 72 illustrates an example of an image to be combined with another image according to the sixth embodiment of the present invention;

FIG. 73 illustrates an example of an image to be combined with another image according to the sixth embodiment of the present invention;

FIG. 74 illustrates an example of an image to be combined with another image according to the sixth embodiment of the present invention;

FIG. 75 illustrates an example of an image to be combined with another image according to the sixth embodiment of the present invention;

FIG. 76 illustrates an example of an image to be combined with another image according to the sixth embodiment of the present invention; and

FIG. 77 illustrates an example of an image to be combined with another image according to the sixth embodiment of the present invention.

### DETAILED DESCRIPTION OF THE PREFERRED EMBODIMENTS

A description is given, with reference to the accompanying drawings, of embodiments of the present invention. A visual anti-robot test system is taken as an example of the authentication system according to an embodiment of the present invention, although the present invention is not so limited. Furthermore, a server device which is a typical computer device is taken as an example of an authentication device according to an embodiment of the present invention, although the present invention is not so limited.

### First Embodiment

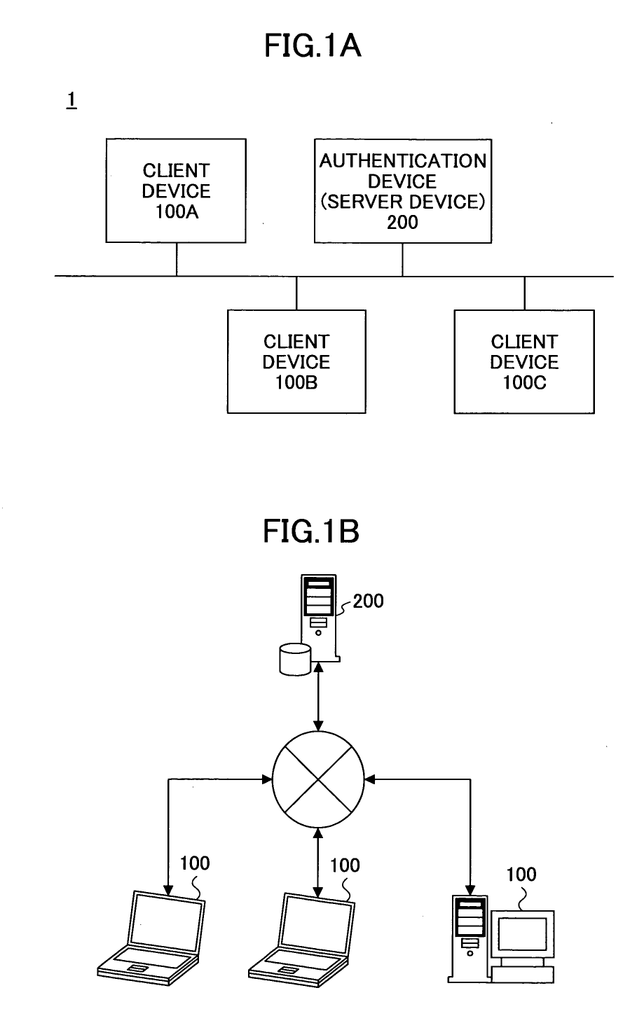

A description is given of a first embodiment of the present invention with reference to FIGS. 1A through 21B.

(Authentication System)

FIGS. 1A and 1B illustrate an example of an authentication system according to the first embodiment. As shown in FIG. 1A, an authentication system 1 is a client/server system including client devices 100A, 100B, and 100C (hereinafter, collectively referred to as a client device 100) and an authentication device (server device) 200.

The client device 100 and the authentication device 200 are typical computer devices including a CPU (Central Processing Unit), a RAM (Random Access Memory), and a ROM (Read Only Memory) (not shown). FIG. 1B illustrates an example in which the client device 100 and the server device 200 are connected via a network such as the Internet.

With the above system configuration, the authentication system 1 can determine whether a user of the client device 100 is an actual human being or an automated computer program. Communications between the client device 100 and the server device 200 are performed by HTTP (HyperText Transfer Protocol) or HTTPS (HyperText Transfer Protocol Security) which is encrypted HTTP. The server device 200 sends information in the HTML (HyperText Markup Language) format to the client device 100, in response to a request from the client device 100.

The communication protocol used for the communication between the client device 100 and the server device 200 is not limited to HTTP or HTTPS.

(Functional Configuration)

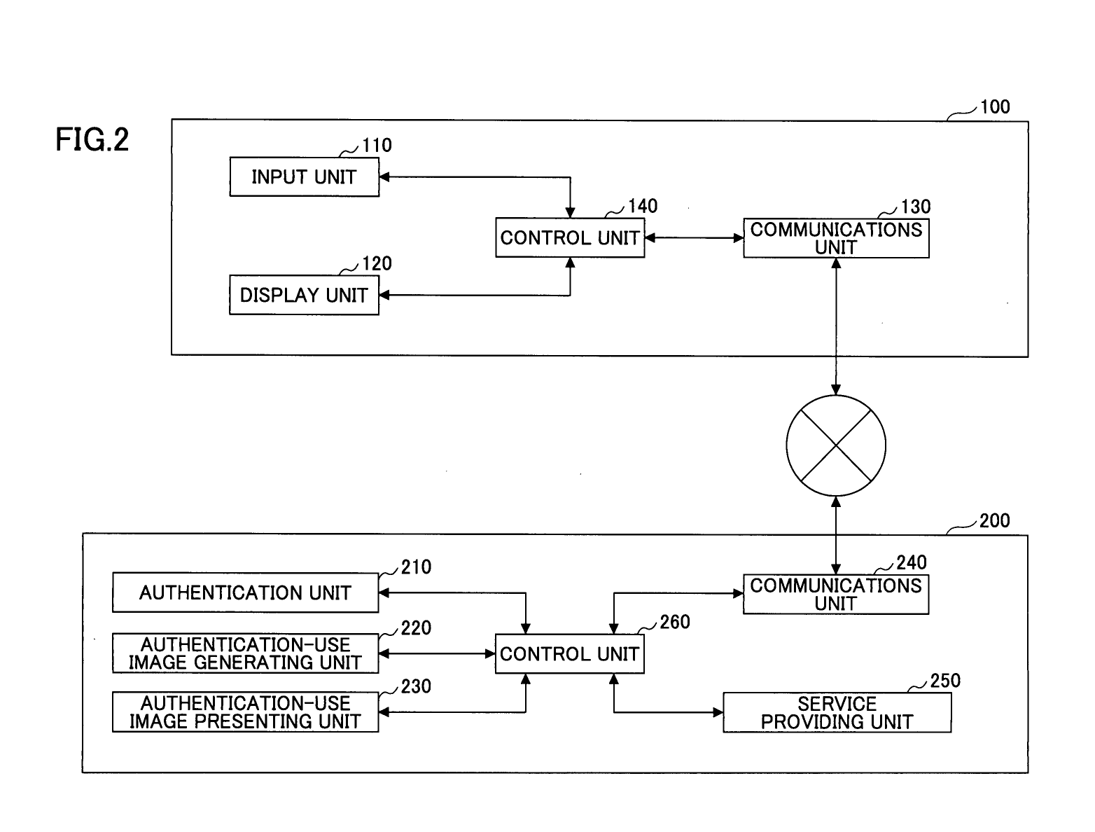

FIG. 2 illustrates an example of the functional configuration of the authentication system according to the first embodiment. As shown in FIG. 2, the client device 100 includes an input unit 110, a display unit 120, a communications unit 130, and a control unit 140. The server device 200 includes an authentication unit 210, an authentication-use image generating unit (authentication-use video generating unit) 220, an authentication-use image presenting unit (authentication-use video presenting unit) 230, a communications unit 240, a service providing unit 250, and a control unit 260.

First, a description is given of the functional units included in the client device 100.

The input unit 110 receives various instructions input by the user of the client device 100. An example is a service request for receiving services such as a Web service from the server device 200.

The display unit 120 displays a screen page on a display device such as a liquid crystal display device (not shown) of the client device 100. The communications unit 130 is an interface for performing communications with the server device 200. The control unit 140 implements various control operations for the client device 100, including those for the input unit 110, the display unit 120, and the communications unit 130.

Next, a description is given of the functional units of the server device 200.

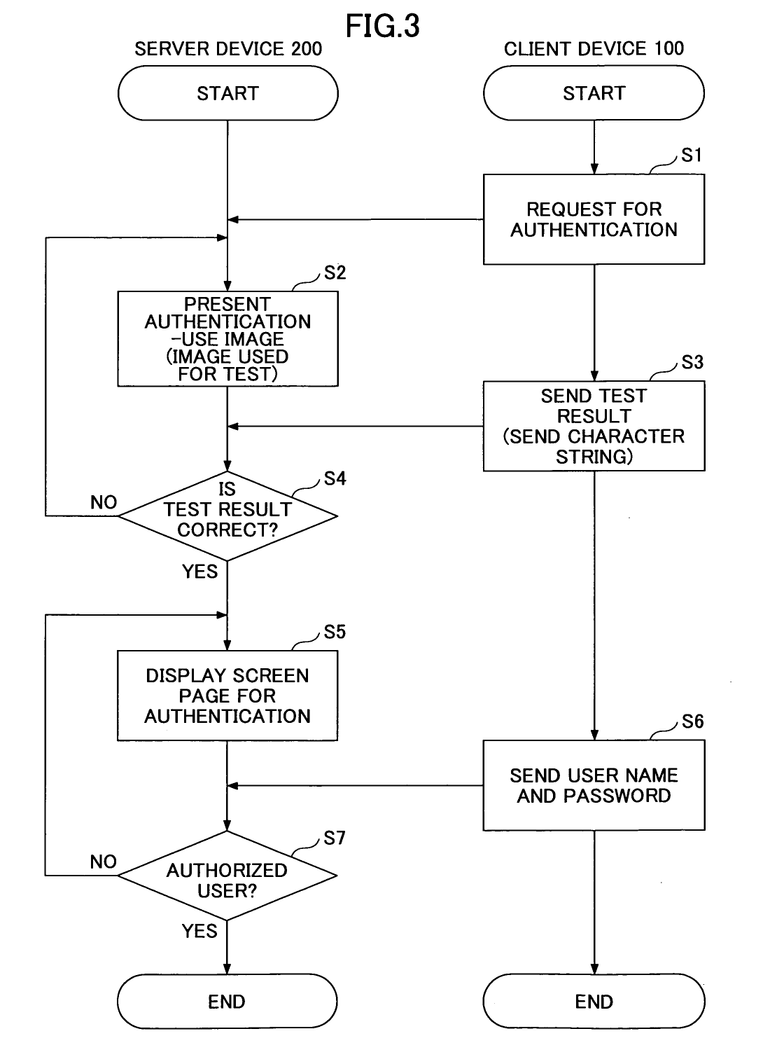

The authentication unit 210 performs authentication based on information received from the client device 100. For example, the authentication unit 210 determines (authenticates) whether the user of the client device 100 is an actual human being or an automated computer program. Furthermore, the authentication unit 210 performs user authentication of the client device 100 based on a user name or a password received from the client device 100. These operations are described below with reference to FIG. 3.

The authentication-use image generating unit 220 generates an authentication-use image (or an authentication-use video) according to an embodiment of the present invention. Examples of the authentication-use image (or authentication-use video) are described below with reference to FIGS. 6 through 21B. The authentication-use image presenting unit 230 presents, to the client device 100, an authentication-use image (or an authentication-use video) which has been generated by the authentication-use image generating unit 220.

The communications unit 240 is an interface for performing communications with the client device 100. The service providing unit 250 provides services to the client device 100 in response to a service request received from the client device 100, in the event that the authentication is successful at the authentication unit 210. The control unit 260 implements various control operations for the server device 200, including those for the authentication unit 210, the authentication-use image generating unit (authentication-use video generating unit) 220, the authentication-use image presenting unit (authentication-use video presenting unit) 230, the communications unit 240, and the service providing unit 250.

(Operation Examples of Authentication System)

FIG. 3 is a flowchart illustrating an example of operations of the authentication system according to the first embodiment. The server device 200 performs an authentication operation for determining whether the user of the client device 100 is an actual human being.

First, the client device 100 requests the server device 200 to perform authentication (step S1). In this example, the user sends a request from the client device 100 to the server device 200, to perform authentication. The request can be a service request for receiving a service.

In step S2, the server device 200 presents an authentication-use image (or an authentication-use video) to the client device 100 (step S2). The authentication-use image generating unit 220 generates an authentication-use image (or an authentication-use video) (for example, an image corresponding to characters and/or symbols as shown in FIG. 6). Next, the authentication-use image presenting unit 230 presents the authentication-use image generated by the authentication-use image generating unit 220 to the client device 100. Next, the display unit 120 of the client device 100 displays the authentication-use image.

In step S3, the client device 100 sends test result information to the server device 200 (step S3). The user reads the characters and/or symbols in the authentication-use image presented at step S2, and inputs, with the input unit 110, information expressing the test result, i.e., the read characters and/or symbols. The test result information input with the input unit 110 is transmitted to the server device 200.

In step S4, the server device 200 determines whether the test result information received at step S3 is correct (step S4). The authentication unit 210 makes the determination (authentication) by comparing the test result information received at step S3 with the characters and/or the symbols in the authentication-use image presented at step S2, to determine whether they are the same. When it is determined that the information is correct (Yes in step S4), the process proceeds to step S5. When it is determined that the information is incorrect (No in step S4), the process returns to step S2.

In step S5, the server device 200 displays the screen page for authentication at the client device 100 (step S5). For example, the server device 200 presents a screen page for authenticating the user, which includes a user name (user identification character string) input form and a password input form, and prompts the user to input this information for user authentication.

In step S6, the client device 100 sends the user name and the password to the server device 200 (step S6). The user inputs, with the input unit 110, the user name and the password into the screen page for authentication presented at step S5. The information including the user name and the password input with the input unit 110 is transmitted to the server device 200.

In step S7, the server device 200 determines whether the user is an authorized user based on the information including the user name and the password received at step S6 (step S7). The authentication unit 210 makes the determination (authentication) by comparing the information including the user name and the password received at step S6 with user information managed in a storage unit (not shown).

When the user is determined to be an authorized user (Yes in step S7), the service providing unit 250 starts providing a service, such as displaying a content posting form, for example. When a service request has been received in step S1, the service providing unit 250 can start providing the service in accordance with the service request that has been received. When the user is determined to be an unauthorized user (No in step S7), the process returns to step S5.

By the above-described process, the server device 200 can perform the authentication operation of determining (authenticating) whether the user of the client device 100 is an actual human being.

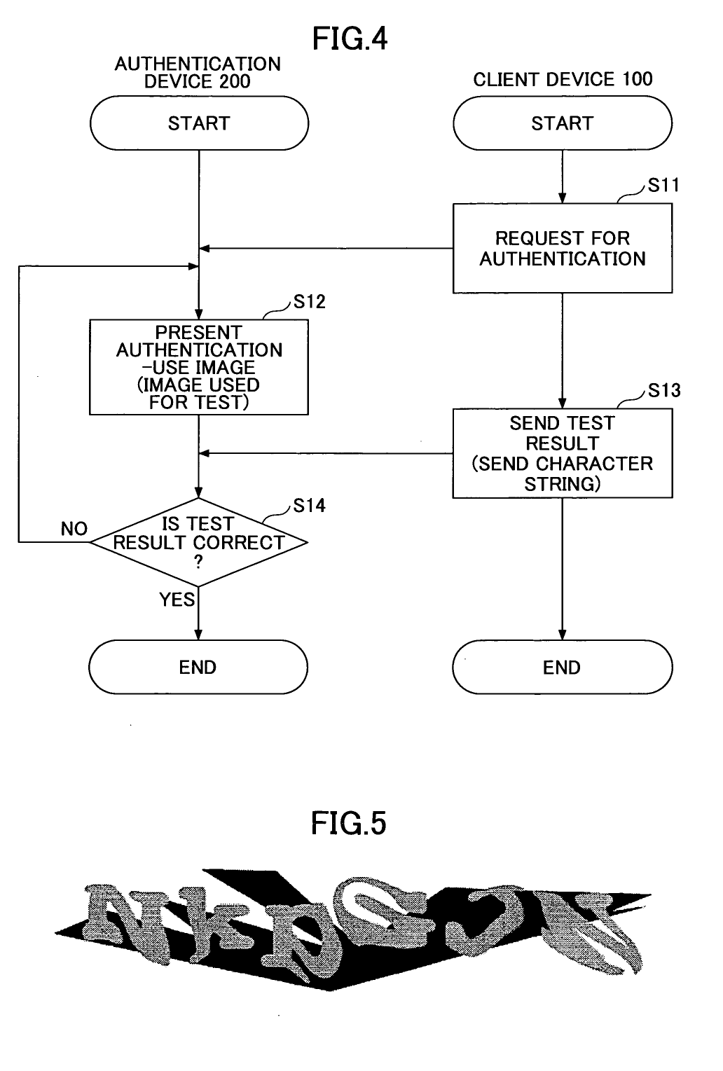

The procedures of steps S2 through S4 and the procedures of steps S5 through S7 can be performed in the inverse order. Furthermore, when the request from the client device 100 to the server device 200 is to acquire an account from the server device 200, only the procedures of steps S11 through S14 shown in FIG. 4 are performed, and the user registration can be performed after these steps. FIG. 4 is a flowchart illustrating another example of operations of the authentication system according to the first embodiment. The procedures of steps S11 through S14 are the same as those of steps S1 through S4 shown in FIG. 3, respectively, and are therefore not further described.

(Authentication Operation Using Conventional Authentication-Use Image)

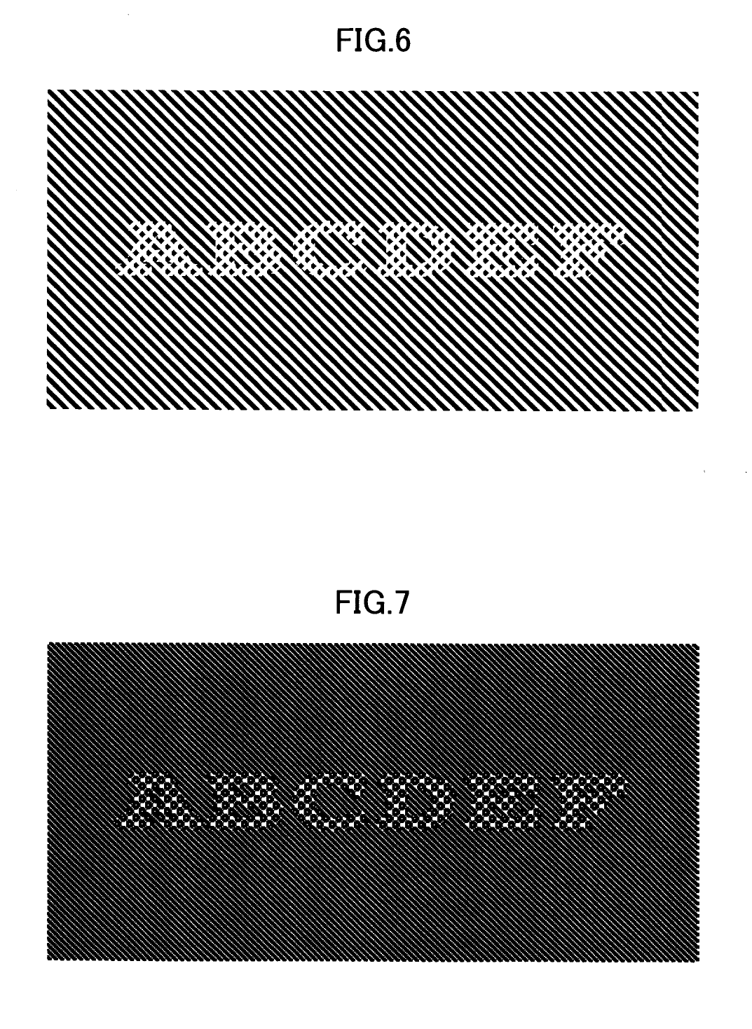

Next, a description is given of a conventional authentication operation (visual anti-robot test) with reference to FIGS. 4 and 5.

FIG. 5 is an example of an authentication-use image used in a conventional authentication system. The image shown in FIG. 5 is the authentication-use image presented at the client device 100 by the server device 200 at step S12 in FIG. 4.

A human being can read the image shown in FIG. 5 as “NkpGJN”. However, a computer program would need to have a special character recognition function such as OCR, in order to recognize characters and symbols that are rasterized as an image as shown in FIG. 5. Furthermore, characters and/or symbols that are deformed or covered as those shown in FIG. 5 are difficult to recognize even with OCR. Accordingly, when the client device 100 is a so-called “bot”, it would need to be provided with at least an OCR function. Even if the client device 100 is provided with an OCR function, characters and/or symbols that are deformed or covered as those shown in FIG. 5 are difficult to recognize even with OCR. Accordingly, the computer program would require an OCR program that has undergone a high-level learning process.

However, such a learning process requires considerably complex technology, as well as being high cost. Therefore, it is very difficult for a low-cost computer program to indiscriminately recognize a large number of such characters/symbols.

In the above-described manner, a conventional authentication system (visual anti-robot test system) determines whether the client device 100 is an actual human being or an automated computer program. However, in view of recent advancements and price-reductions of the OCR technology, the above method may not be totally safe.

With reference to FIGS. 6 through 21B, a description is given of various examples of authentication-use images (or authentication-use videos) according to the first embodiment of the present invention for solving such a problem. In each of the examples of authentication-use images (or authentication-use videos), there is an image provided on the background in accordance with the characters and/or symbols. Between such a background image and the characters and/or symbols, there is no “edge” that appears due to a difference in image density.

(First Example of Authentication-Use Image)

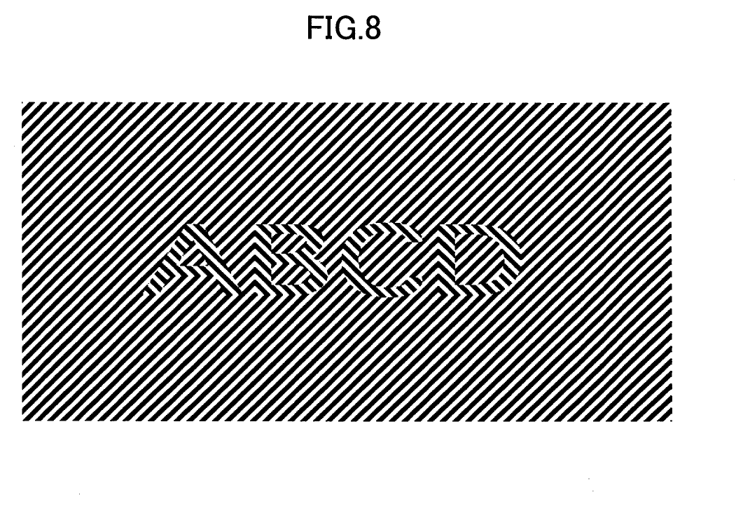

With reference to FIGS. 6 and 7, a description is given of a first example of an authentication-use image according to the first embodiment of the present invention. The image shown in FIG. 6 is the first example of the authentication-use image presented to the client device 100 by the server device 200 in step S2 of FIG. 3.

In the image shown in FIG. 6, on a background expressed by a first texture, there is provided authentication-use information corresponding to an image of characters and/or symbols expressed by a second texture which is different from the first texture.

In the example shown in FIG. 6, the first texture is an image of black and white oblique stripes which are slanted at a certain angle. In the example shown in FIG. 6, the second texture is an image of dotted lines corresponding to the oblique stripes of the first texture.

The images corresponding to the characters and/or symbols have a combination of plural characters and/or symbols that are arbitrarily selected. The selected characters and/or symbols can be different for each of the sessions (each of the operations shown in FIG. 3).

A human being can read the image shown in FIG. 6 as “ABCDEF”. That is, a human being can correctly recognize characters and/or symbols in such an image.

However, when the computer program uses a regular OCR program to acquire a first derivation of luminance, only the edges of each of the texture components are extracted as shown in FIG. 7. Thus, it is not possible to extract the edges between the characters and/or symbols, and the background, which edges are for separating the characters and/or symbols from the background.

Therefore, in order for a “bot” to recognize the characters and/or symbols, in addition to the OCR, a complex image processing operation needs to be performed as a preprocess before the OCR. Such an image processing operation performed as the preprocess requires a large memory and a high-speed CPU, which inevitably leads to increased cost.

Accordingly, increased complexity in the technology for passing the authentication test using the first example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Second Example of Authentication-Use Image)

With reference to FIG. 8, a description is given of a second example of an authentication-use image according to the first embodiment of the present invention. The image shown in FIG. 8 is the second example of the authentication-use image presented to the client device 100 by the server device 200 in step S2 of FIG. 3.

In the image shown in FIG. 8, on a background expressed by a first texture, there is provided authentication-use information corresponding to an image of at least one character and/or symbol expressed by a second texture which is different from the first texture.

In the example shown in FIG. 8, the first texture is an image of black and white oblique stripes which are slanted at a certain angle. In the example shown in FIG. 8, the second texture is an image of black and white oblique stripes which are slanted at a different angle from that of the first texture.

In this example, the difference between the first texture and the second texture is the form of the texture (in this example, the direction). Furthermore, the average density value (luminance) of the image corresponding to the characters and/or symbols is equal to or substantially equal to that of the background image.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 6 as “ABCDEF”. That is, a human being can correctly recognize characters and/or symbols in such an image.

However, it is difficult for a computer program to detect edges between characters and/or symbols and the background, based on the difference in the average density of the image corresponding to the characters and/or symbols, in addition to the reason described in the first example of the authentication-use image.

Therefore, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the second example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Example of Authentication-Use Video)

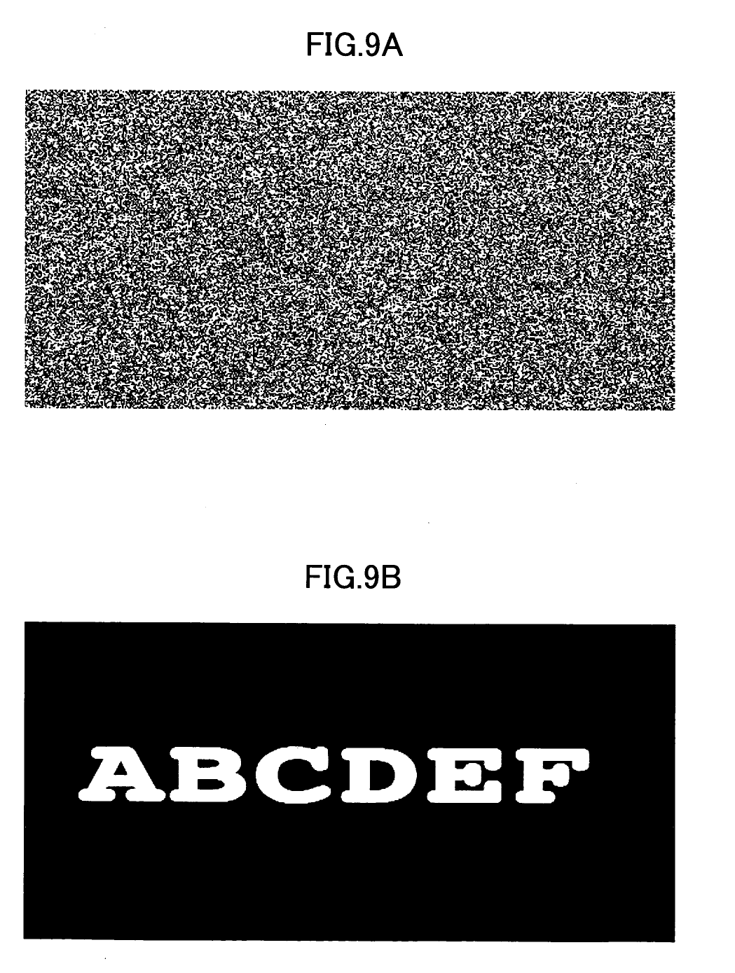

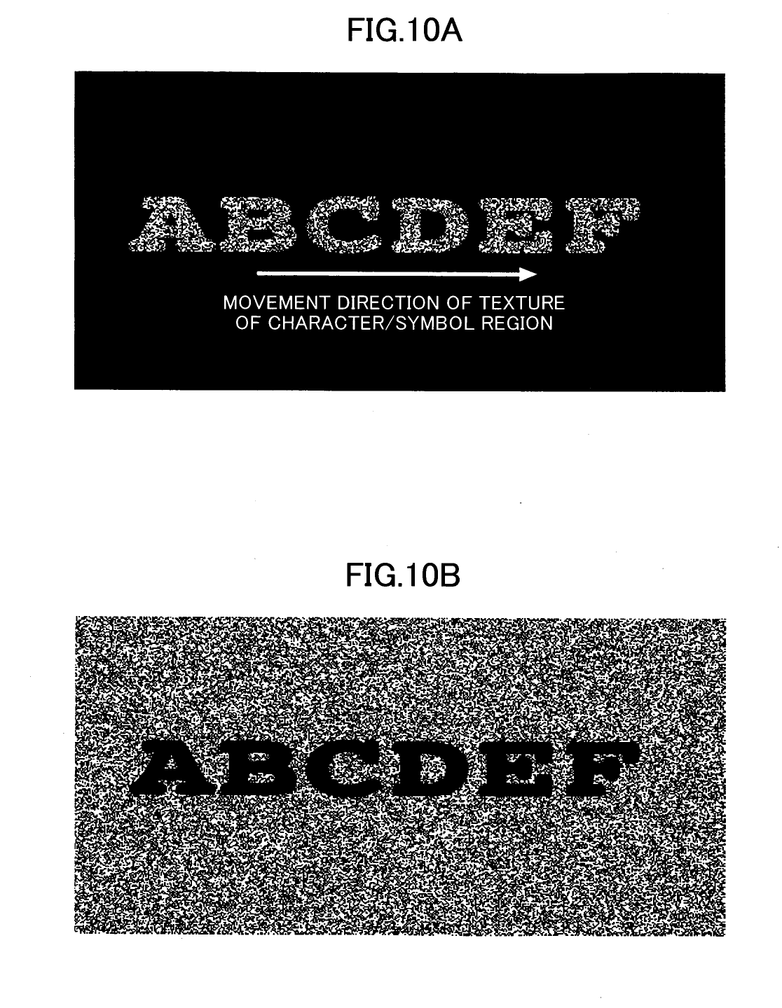

With reference to FIGS. 9A, 9B, 10A, and 10B, a description is given of an example of an authentication-use video according to the first embodiment of the present invention.

The images shown in FIGS. 9A and 9B are the authentication-use images constituting an authentication-use video presented to the client device 100 by the server device 200 in step S2 of FIG. 3.

In the authentication-use image shown in FIG. 9A, the images of the background region and the foreground region are expressed with a texture including random dots in which the ratio between white pixels and black pixels is 1:1.

The foreground region of the authentication-use image is an image cut out from the image shown in FIG. 9A, in shapes of the regions of characters and/or symbols, with the use of mask data shown in FIG. 9B (the cut-out foreground image is shown in FIG. 10A). The background region of the authentication-use image is an image cut out from the image shown in FIG. 9A, in shapes of the regions of characters and/or symbols, with the use of mask data corresponding to an inverted version of the mask data shown in FIG. 9B (the cut-out background image is shown in FIG. 10B).

Accordingly, with the use of the authentication-use images thus generated, an authentication-use video can be generated, in which the positional relationship between the background region and the foreground region changes with time. In an example of the authentication-use video, the texture of the foreground region moves in a parallel manner in a predetermined direction with the passage of time as shown in FIG. 10A, while maintaining the positional relationships among the dots. The direction of movement can be in any direction.

This example of the authentication-use video is constituted by an authentication-use image displayed by superposing the foreground region on the background region.

The authentication-use video shows random dots during a predetermined length of time. However, a human being can detect the edges by just perceiving the movement, even when there is no other visual information. Accordingly, when a human being observes this video for a certain length of time, the characters and/or symbols can be recognized.

However, in order for a “bot” to recognize the characters and/or symbols, it is necessary to calculate temporal derivations or differences from the video as the preprocess of regular OCR, which requires a large memory and a high-speed CPU, inevitably leading to increased cost.

Accordingly, increased complexity in the technology for passing the authentication test using this example of the authentication-use video leads to increased cost. Thus, in order to make a nuisance with the use of a “bot”, hardware of higher performance is required, or the frequency of nuisances per unit time needs to be decreased. Therefore, it will become more impractical to make a nuisance.

In this example of the authentication-use video, the texture of random dots which is to be cut out with the mask data shown in FIG. 9B has a sufficiently large region in advance with respect to the movement of the foreground region, or this texture is generated every time there is insufficient texture at the trailing edge portion of movement of the foreground region. However, the present invention is not so limited. For example, the direction of movement may be inverted before the texture becomes insufficient due to the movement of the foreground region.

Furthermore, in this example of the authentication-use video, the foreground region moves in a parallel manner in a predetermined direction with the passage of time while maintaining the positional relationships among the dots. However, the present invention is not so limited. The background region may move in a parallel manner in a predetermined direction with the passage of time while maintaining the positional relationships among the dots.

(Another Example of Authentication-Use Video)

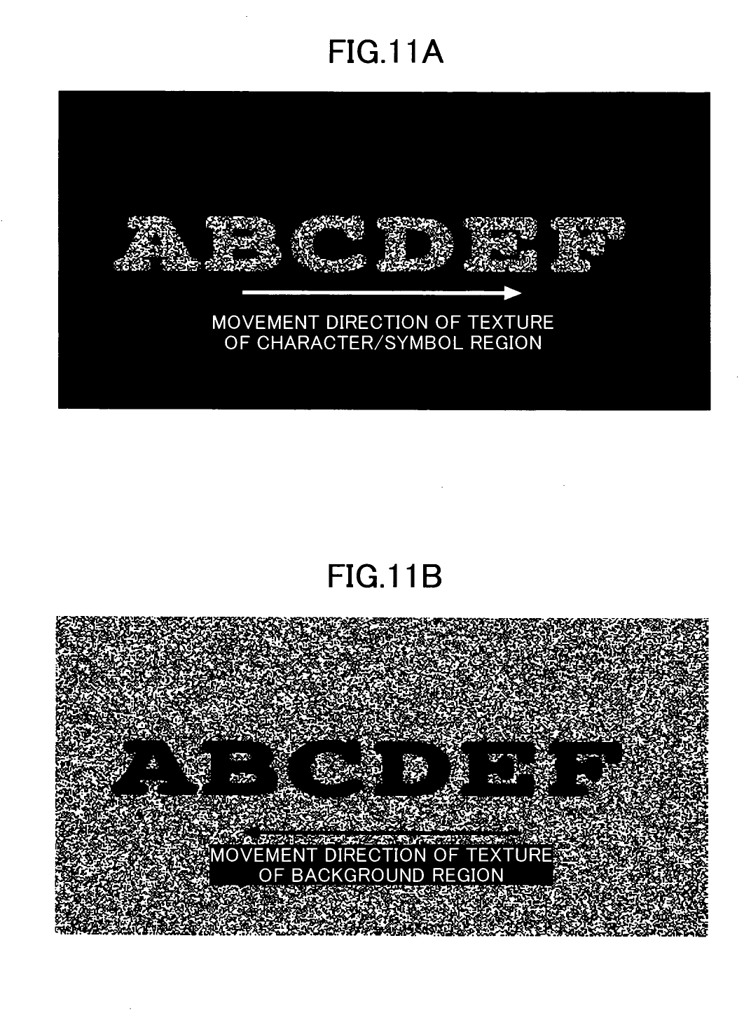

With reference to FIGS. 11A and 11B, a description is given of another example of an authentication-use video according to the first embodiment of the present invention.

The images shown in FIGS. 11A and 11B are the authentication-use images constituting an authentication-use video presented to the client device 100 by the server device 200 in step S2 of FIG. 3.

The foreground region of the authentication-use image is an image cut out from the image shown in FIG. 9A, in shapes of the regions of characters and/or symbols, with the use of mask data shown in FIG. 9B (the cut-out foreground image is shown in FIG. 11A). The background region of the authentication-use image is an image cut out from the image shown in FIG. 9A, in shapes of the regions of characters and/or symbols, with the use of mask data corresponding to an inverted version of the mask data shown in FIG. 9B (the cut-out background image is shown in FIG. 11B).

Accordingly, with the use of the authentication-use image thus generated, an authentication-use video can be generated, in which the positional relationship between the background region and the foreground region changes according to time. In an example of the authentication-use video, the textures of the foreground region and the background region move in a parallel manner in different directions with the passage of time as shown in FIGS. 11A and 11B, while maintaining the positional relationships among the dots. As long as the textures of the foreground region and the background region move in different directions, they can move in any direction.

This example of the authentication-use video is constituted by an authentication-use image displayed by superposing the foreground region on the background region.

The authentication-use video shows random dots during a predetermined length of time. However, a human being can detect the edges only by perceiving the movement, even when there is no other visual information. Accordingly, when a human being observes this video for a certain length of time, the characters and/or symbols can be recognized.

Furthermore, unlike the previous example of the authentication-use video, both the texture of the foreground region and the texture of the background region move in different direction. This difference in the movement direction provides more indications for the human being to recognize the edges. Accordingly, it is even easier for the human being to recognize the characters and/or symbols.

However, even if a “bot” attempts to recognize the characters and/or symbols by calculating temporal derivations or differences from the image, the dot patterns are random, and therefore such calculation results only form random dot images. Accordingly, edges between the regions cannot be detected from temporal derivations or differences alone.

Thus, in order for a “bot” to recognize the characters and/or symbols, it is necessary to detect temporal corresponding points of the patterns and to also detect the movement direction, as the preprocess of regular OCR, which requires a large memory and a high-speed CPU, inevitably leading to increased cost.

Accordingly, increased complexity in the technology for passing the authentication test using this example of the authentication-use video leads to increased cost. Thus, in order to make a nuisance with the use of a “bot”, hardware of higher performance is required, or the frequency of nuisances per unit time needs to be decreased. Therefore, it will become more impractical to make a nuisance.

In this example of the authentication-use video, the texture of random dots which is to be cut out with the mask data shown in FIG. 9B has a sufficiently large region in advance with respect to the movement of the foreground region, or this texture is generated every time there is insufficient texture at the trailing edge portion of movement of the foreground region. However, the present invention is not so limited. For example, the direction of movement may be inverted before the texture becomes insufficient due to the movement of the foreground region.

(Third Example of Authentication-Use Image)

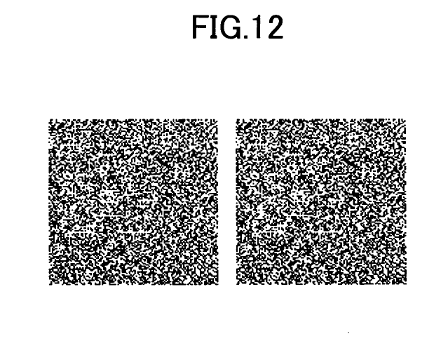

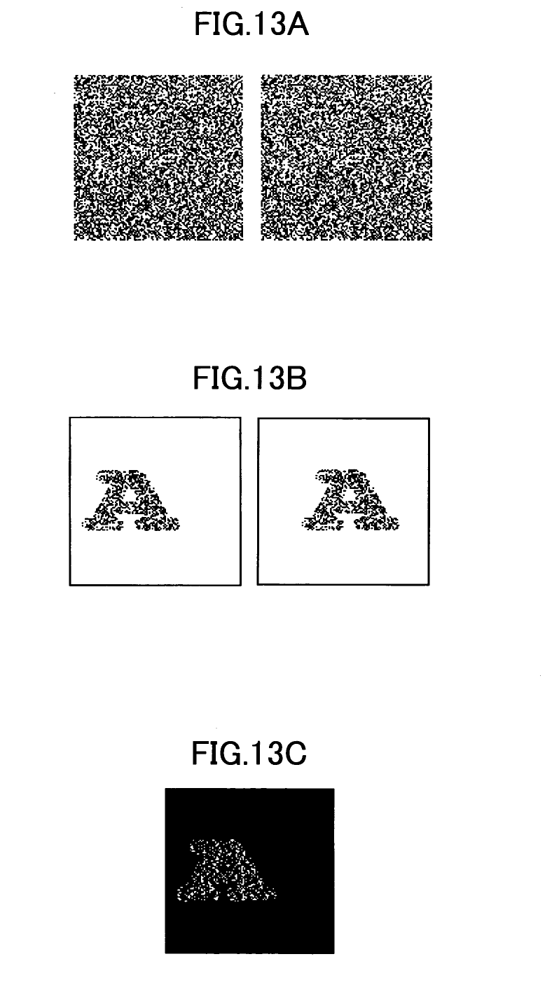

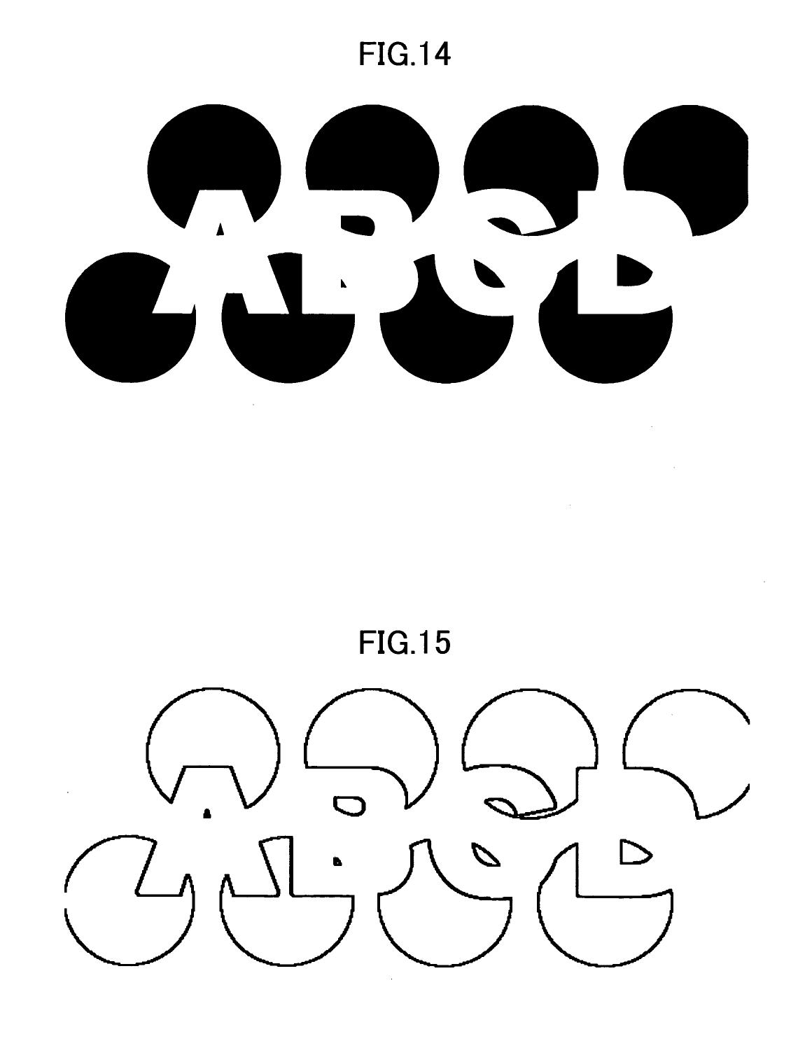

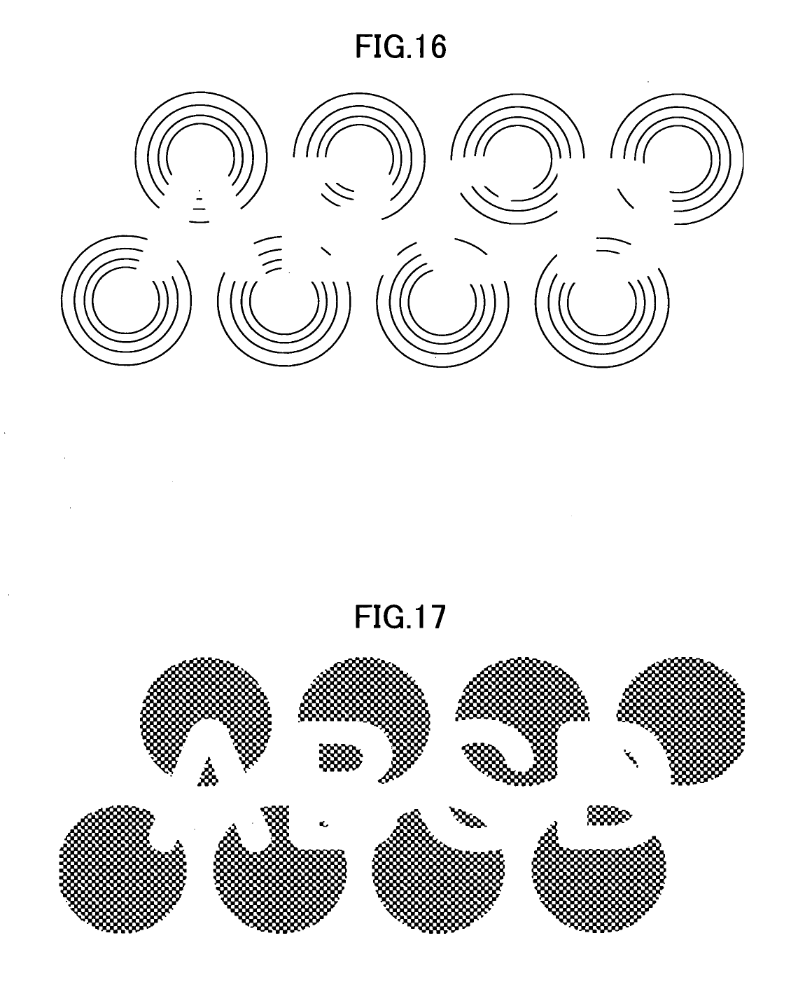

With reference to FIGS. 12, 13A, 13B, and 13C, a description is given of a third example of an authentication-use image according to the first embodiment of the present invention. The image shown in FIG. 12 is the third example of the authentication-use image presented to the client device 100 by the server device 200 in step S2 of FIG. 3.

The image shown in FIG. 12 is a random dot stereogram image, in which images corresponding to characters and/or symbols are embedded. In the random dot stereogram image shown in FIG. 12, two authentication-use information items shown in FIG. 13B are superposed on two background regions shown in FIG. 13A. The two background regions correspond to the same first texture pattern. The two authentication-use information items correspond to second texture patterns forming different images from those of the background regions, i.e., the second texture patterns form images of the same characters and/or symbols disposed at different positions.

The images corresponding to the characters and/or symbols are expressed by a combination of plural characters and/or symbols that are arbitrarily selected. The selected characters and/or symbols can be different for each of the sessions (each of the operations shown in FIG. 3).

The user observes the images with both eyes by a paralleling method (observe the right image with the right eye and observe the left image with the left eye), or by a cross method (observe the left image with the right eye and observe the right image with the left eye), combines the two images, and observes the image by binocular stereopsis. Accordingly, in the example shown in FIG. 12, the character “A” can be observed at the back of the image or emerging at the front of the image.

This technology utilizes the fact that the visual information processing system of a human being perceives the depth of vision, by detecting a binocular corresponding point of the two random dot stereogram images, and detecting a so-called binocular parallax, which is the parallax of the character regions of “A”, i.e. the regions of the characters and/or symbols disposed at different positions on the background region.

In such a random dot stereogram image having the above configuration, if only one of the images were provided, it would merely be an assembly of random dots, and it would be impossible to extract a region of the image corresponding to characters and/or symbols.

When the binocular parallax of the regions of the images corresponding to the characters and/or symbols is small, i.e., when the difference in the positions of the characters and/or symbols is small, if subtraction is merely performed between the two images, the regions of the characters and/or symbols may partially overlap each other as shown in FIG. 13C.

Accordingly, with this method, the edges of the image region corresponding to characters and/or symbols cannot be correctly extracted. If a “bot” were to attempt to recognize the characters and/or symbols, it would be necessary to perform operations such as detecting a binocular corresponding point among both images, as a preprocess of regular OCR. Such an operation requires a large memory and a high-speed CPU, which inevitably leads to increased cost.

Accordingly, increased complexity in the technology for passing the authentication test using the third example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

In the third example of the authentication-use image, a random dot stereogram image requiring two images is described. However, the present invention is not so limited. For example, it is possible to use a single image random dot stereogram image with which binocular stereopsis can be performed with one image, or a stereogram image including a specific texture having meaning instead of random dots.

(Fourth Example of Authentication-Use Image)

With reference to FIGS. 14 and 15, a description is given of a fourth example of an authentication-use image according to the first embodiment of the present invention. The image shown in FIG. 14 is the fourth example of the authentication-use image presented to the client device 100 by the server device 200 in step S2 of FIG. 3.

The image shown in FIG. 14 includes a group of objects arranged on a monochrome background, which objects have one or more colors which are different from that of the background. Furthermore, images corresponding to characters and/or symbols having the same color as that of the background, are rendered so as to partially overlap with the group of objects.

In the example shown in FIG. 14, the objects are images of black circles having a predetermined size. In the example shown in FIG. 14, the images corresponding to the characters and/or symbols have the same white color as the background.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 14 as “ABCD”. That is, a human being can recognize that a character string having the same color as the background is emerging on the same plane as the objects, from images with regions that do not have actual outlines. Even from such images, the characters and symbols can be correctly estimated and recognized. An outline perceived in the aforementioned manner is referred to as a subjective outline.

However, when a computer program performs regular OCR to acquire a first derivation of luminance, only incomplete edges of characters and/or symbols and incomplete objects can be extracted, as shown in FIG. 15. Thus, the characters and/or symbols cannot be recognized separately from the objects.

Therefore, in order for a “bot” to recognize the characters and/or symbols, in addition to OCR, a more complex image processing operation needs to performed as the preprocess. Such an image processing operation performed as the preprocess requires a large memory and a high-speed CPU, which inevitably leads to increased cost.

Accordingly, increased complexity in the technology for passing the authentication test using the fourth example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Fifth Example of Authentication-Use Image)

With reference to FIG. 16, a description is given of a fifth example of an authentication-use image according to the first embodiment of the present invention.

The image shown in FIG. 16 is the fifth example of the authentication-use image presented to the client device 100 by the server device 200 in step S2 of FIG. 3.

The image shown in FIG. 16 includes a group of objects arranged on a background, which objects are rendered with line images having a different color from that of the background. Furthermore, images corresponding to characters and/or symbols having the same color as that of the background, are rendered so as to partially overlap with the group of objects.

In the example shown in FIG. 16, the objects are images of circles rendered with black lines. In the example shown in FIG. 16, the images corresponding to the characters and/or symbols have the same white color as the background.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 16 as “ABCD”. That is, a human being can correctly recognize the characters and/or symbols from such an image.

However, due to the reasons described in the third example of the authentication-use image, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the fifth example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Sixth Example of Authentication-Use Image)

With reference to FIG. 17, a description is given of a sixth example of an authentication-use image according to the first embodiment of the present invention.

The image shown in FIG. 17 is the sixth example of the authentication-use image presented to the client device 100 by the server device 200 in step S2 of FIG. 3.

The image shown in FIG. 17 includes a group of objects constituted by at least one type of texture, arranged on a monochrome background. Furthermore, images corresponding to characters and/or symbols having the same color as that of the background, are rendered so as to partially overlap with the group of objects.

In the example shown in FIG. 17, the objects are circular images constituted by a texture in which black pixels and white pixels are arranged alternately to one another. In the example shown in FIG. 17, the images corresponding to the characters and/or symbols have the same white color as the background.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 17 as “ABCD”. That is, a human being can correctly recognize the characters and/or symbols from such an image.

In addition to the reasons described in the third example of the authentication-use image, it is difficult to detect the edges between the images corresponding to the characters and/or symbols and the background, based on the difference in the average density between the images corresponding to the characters and/or symbols and the background.

Thus, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the sixth example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Seventh Example of Authentication-Use Image)

With reference to FIG. 18, a description is given of a seventh example of an authentication-use image according to the first embodiment of the present invention.

The image shown in FIG. 18 is the seventh example of the authentication-use image presented to the client device 100 by the server device 200 in step S2 of FIG. 3.

The image shown in FIG. 18 includes a group of objects filled out with one or more colors, arranged on a background constituted by a first texture. Furthermore, images corresponding to one or more characters and/or symbols having the same texture as that of the background, are rendered so as to partially overlap with the group of objects.

In the example shown in FIG. 18, the objects are black circular images. In the example shown in FIG. 18, the images corresponding to the characters and/or symbols are constituted by a texture in which black pixels and white pixels are arranged alternately to one another.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 18 as “ABCD”. That is, a human being can correctly recognize the characters and/or symbols from such an image.

However, due to the reasons described in the third example of the authentication-use image, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the seventh example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Eighth Example of Authentication-Use Image)

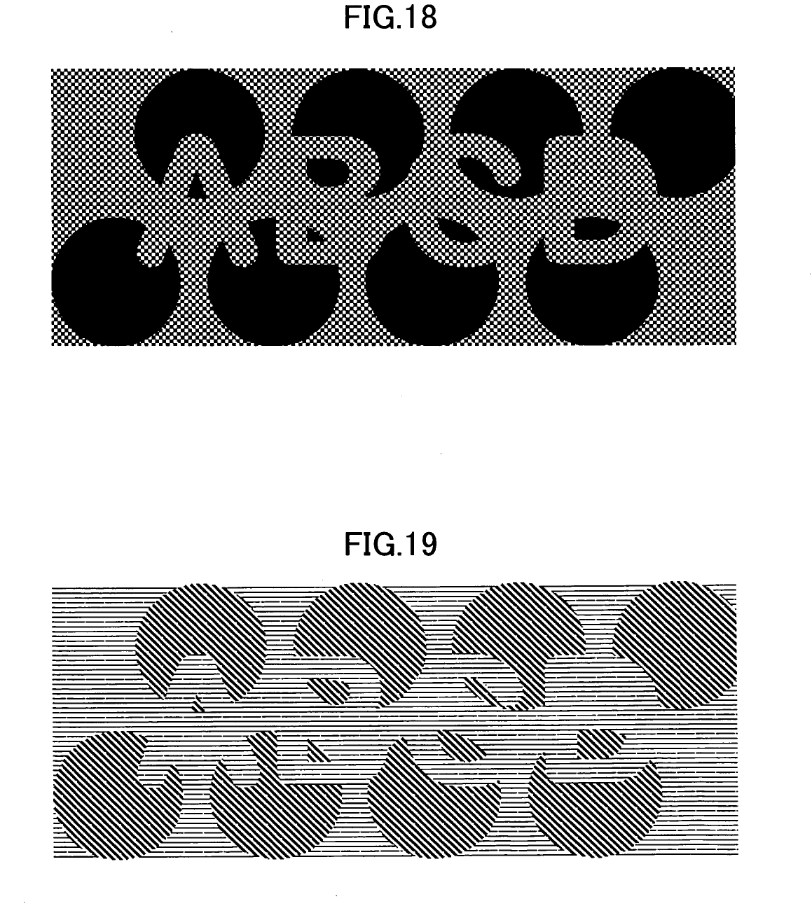

With reference to FIG. 19, a description is given of an eighth example of an authentication-use image according to the first embodiment of the present invention.

The image shown in FIG. 19 is the eighth example of the authentication-use image presented to the client device 100 by the server device 200 in step S2 of FIG. 3.

The image shown in FIG. 19 includes a group of objects arranged on a background constituted by a first texture. The objects are constituted by one or more types of texture (second texture) which is different from the first texture. Furthermore, images corresponding to characters and/or symbols having the same first texture as that of the background, are rendered so as to partially overlap with the group of objects.

In the example shown in FIG. 19, the first texture is an image including black and white horizontal lines (solid line and dashed line) arranged alternately. In the example shown in FIG. 19, the second texture is an image including black and white oblique lines arranged alternately and slanted at a certain angle.

In the example shown in FIG. 19, the objects are circular images constituted by the second texture. In the example shown in FIG. 19, the images corresponding to the characters and/or symbols are constituted by the first texture.

The images corresponding to the characters and/or symbols are expressed by a combination of plural characters and/or symbols that are arbitrarily selected. The selected characters and/or symbols can be different for each of the sessions (each of the operations shown in FIG. 3).

A human being can read the image shown in FIG. 19 as “ABCD”. That is, a human being can correctly recognize the characters and/or symbols from such an image.

However, due to the reasons described in the third example of the authentication-use image, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the eighth example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

(Ninth Example of Authentication-Use Image)

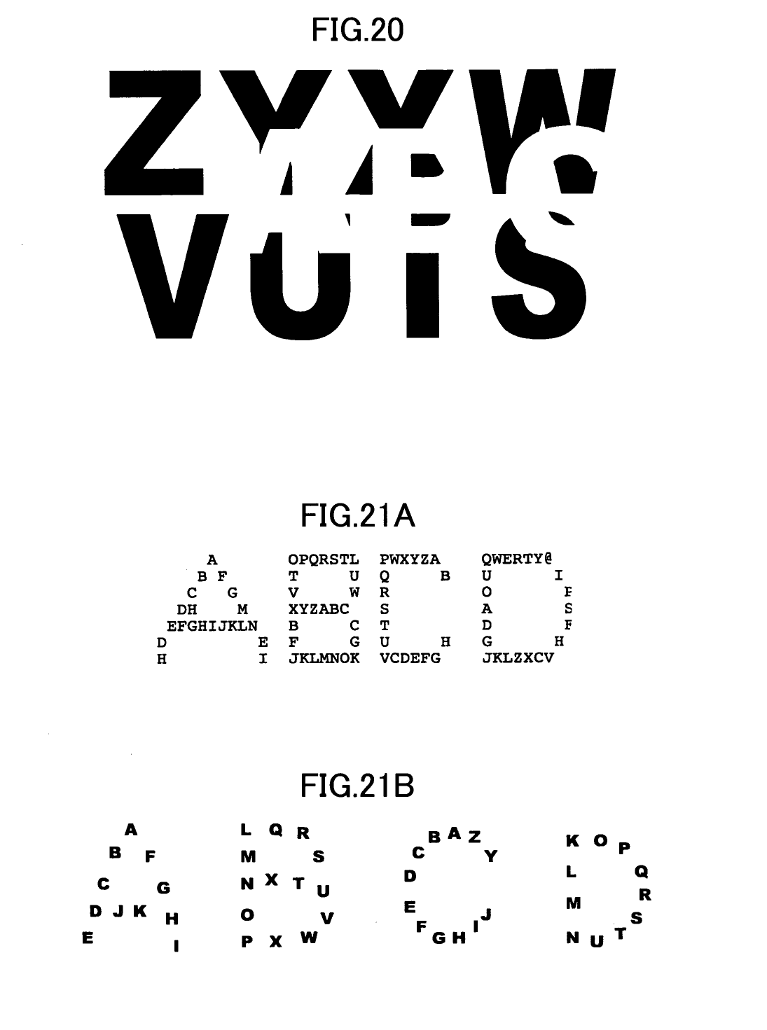

With reference to FIG. 20, a description is given of a ninth example of an authentication-use image according to the first embodiment of the present invention.

The image shown in FIG. 20 is the ninth example of the authentication-use image presented to the client device 100 by the server device 200 in step S2 of FIG. 3.

The image shown in FIG. 20, the group of objects corresponding to the third to eighth examples of the authentication-use image are constituted by images corresponding to dummy characters and/or dummy symbols. In the example shown in FIG. 20, the dummy characters are “ZYXWVUTS”.

The images corresponding to the dummy characters and/or dummy symbols are expressed by a combination of plural characters and/or symbols that are arbitrarily selected. The selected characters and/or symbols can be different for each of the sessions (each of the operations shown in FIG. 3).

A human being can read the image shown in FIG. 20 as “ABC”. That is, a human being can correctly recognize characters and/or symbols in such an image.

However, due to the reasons described in the third example of the authentication-use image, in order for a “bot” to recognize the characters and/or symbols, it is necessary to perform, as the preprocess of regular OCR, a convolution operation for a secondary derivation filter, which requires a large memory and many calculations, inevitably leading to increased cost.

Accordingly, increased complexity in the technology for passing the authentication test using the ninth example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance.

Even if a “bot” attempted to recognize this image with OCR, the “bot” would detect not only authentication-use information without an explicit outline with respect to the background, but also the dummy characters and/or symbols whose outlines can be detected relatively easily with respect to the background. Accordingly, the “bot” would give a clearly erroneous answer (in the example shown in FIG. 20, an answer starting with Z or V).

For example, the server device 200 can register, in an access prohibition list, the client device 100 which sends a clearly erroneous answer at step S3 of FIG. 3 to prevent the client device 100 from subsequently accessing the server device 200. Accordingly, a measure can be taken to prevent access.

(Tenth Example of Authentication-Use Image)

With reference to FIGS. 21A and 21B, a description is given of a tenth example of an authentication-use image according to the first embodiment of the present invention.

The image shown in FIG. 21A is text information presented to the client device 100 by the server device 200 in step S2 of FIG. 3.

In the text information shown in FIG. 21A, each of the characters and/or symbols (“A, B, C, and D” in the example shown in FIG. 21A) is constituted by plural characters and/or symbols. Specifically, plural spaces, a group of arbitrary characters and/or symbols, and line breaks are included, so that the group of arbitrary characters and/or symbols is used as elements of another character and/or symbol, thereby forming information called ASCII art. This is not presented as an image to the client device 100 by the server device 200, but as text information.

The text information corresponding to the characters and/or symbols are expressed by a combination of plural characters and/or symbols that are arbitrarily selected. The selected characters and/or symbols can be different for each of the sessions (each of the operations shown in FIG. 3).

A human being can read the text information shown in FIG. 21A as “ABCD”. That is, a human being can correctly recognize characters and/or symbols in such text information.

When a human being observes such text information presented in this manner, a perceptual mechanism called grouping is used to simultaneously recognize each character/symbol element as well as each group of characters/symbols made by these elements, i.e., “ABCD” in this example.

However, it is considerably difficult for a “bot” to analyze text information presented in such a manner. The “bot” would first need to rasterize the text, and then to perform, as the preprocess of regular OCR, a convolution operation for a secondary derivation filter, which requires a large memory and many calculations, inevitably leading to increased cost.

Furthermore, in a case of a “bot” that can only perform processes with low precision, instead of recognizing the characters and/or symbols “ABCD” that are supposed to be identified, each of the elements “AOPQR” constituting such characters and/or symbols are recognized. Thus, it would be considerably easy for the server device 200 to identify whether the client device 100 is a “bot”.

The server device 200 can register, in an access prohibition list, the client device 100 which sends a clearly erroneous answer at step S3 of FIG. 3, to prevent the client device 100 from subsequently accessing the server device 200. Accordingly, a measure can be taken to prevent access.

The image shown in FIG. 21B is an example of the authentication-use image presented to the client device 100 by the server device 200 in step S2 of FIG. 3.

The authentication-use image shown in FIG. 21B is image information instead of text information, but is otherwise the same as the text information shown in FIG. 21A, and is therefore not further described.

(Modification)

An embodiment of the present invention is described above. The above examples of authentication-use images (or authentication-use videos) have images corresponding to characters and/or symbols arranged on a background. There are no edges formed by differences in image density between the background and the images corresponding to characters and/or symbols.

Thus, even a human being may not be able to stably perceive the edges, and therefore erroneous recognitions may increase compared to the case of recognizing regular characters and/or symbols.

Accordingly, in the following modification of the embodiment of the present invention, the authentication-use image presented by the server device 200 does not include characters and/or symbols that may be confused with each other, such as the capital alphabetic letter “I”, the small alphabetic letter “1”, and the number “1”; or the small alphabetic letter “o”, the capital alphabetic letter “0”, and the number “0”; or the symbol “:” and the symbol “;”. Accordingly, erroneous recognitions by the human being can be decreased.

Furthermore, in the examples of the aforementioned authentication-use images, when an authentication operation (visual anti-robot test) is performed by the same method every time, the person attempting to make a nuisance may create a “bot” that is dedicated to the particular authentication operation, in order to pass the test. Particularly, if the website has a considerably large number of accesses per day, the cost of creating such a “bot” may be decreased to an acceptable amount.

In a modification of the first embodiment of the present invention, there is provided a procedure (step) of randomly selecting one of the examples of the authentication-use images to be presented by the server device 200 for each of the sessions (each of the operations shown in FIG. 3). This would make it difficult to create a “bot”, and would increase the difficulty and costs for making the nuisance, thereby reinforcing security.

In a modification of the first embodiment of the present invention, there is provided a procedure (step) of presenting the examples of the authentication-use images to be presented by the server device 200 in each of the sessions (each of the operations shown in FIG. 3), in a random order, for example, side by side. Each authentication-use image may include one character and/or symbol. In this case, the work load on an authorized user is the same as the case of using only one type of authentication-use image, while increasing the technical difficulty and the cost required for the “bot” to make a nuisance. This makes it difficult to make a nuisance, thereby further reinforcing security.

### Second Embodiment

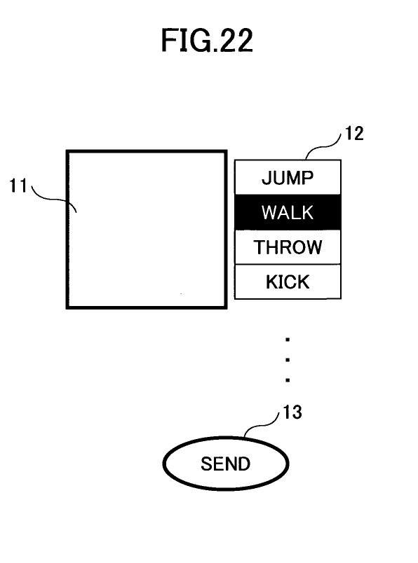

A description is given of a second embodiment of the present invention with reference to FIGS. 22 through 28.

The system configuration, functional configuration, and operations of an authentication system according to the second embodiment are the same as those of the first embodiment (see FIGS. 1, 2, and 3), and are therefore not further described. A supplemental description is given of the authentication-use image presenting unit 230 (authentication-use video presenting unit) shown in FIG. 2.

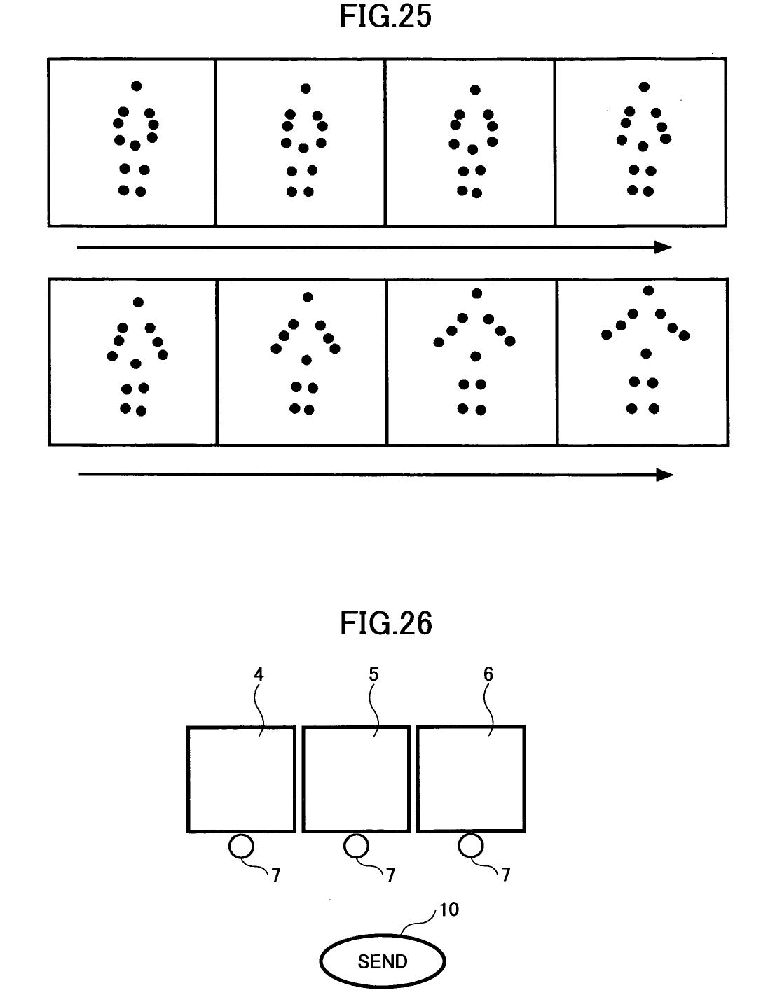

The authentication-use image presenting unit 230 (authentication-use video presenting unit) according to the first embodiment presents authentication-use images (authentication-use videos) generated by the authentication-use image generating unit 220. In the second embodiment, in addition to the authentication-use image (authentication-use video), a selection screen page is presented, including list boxes and tick boxes for prompting the user to make a selection in accordance with the presented authentication-use image, as shown in FIG. 22 or FIG. 26. Examples of the selection screen page are described below with reference to FIG. 22 or FIG. 26. In the second embodiment, the selection screen page is presented in addition to an authentication-use video; however, the selection screen page may be presented in addition to an authentication-use image.

(First Example of Presentation Screen Page of Authentication-Use Video)

With reference to FIG. 22, a description is given of a first example of a screen page for presenting an authentication-use video according to the second embodiment of the present invention.

The image shown in FIG. 22 is an example of a displayed screen page that is presented to the client device 100 by the server device 200 in step S2 of FIG. 3.

The screen page display contents shown in FIG. 22 include an authentication-use video section 11 where the authentication-use video is presented, selection boxes 12 including a list of selections to be selected by the user, and a send button 13 for sending, to the server device 200, the selection of the user selected from the selection boxes 12.

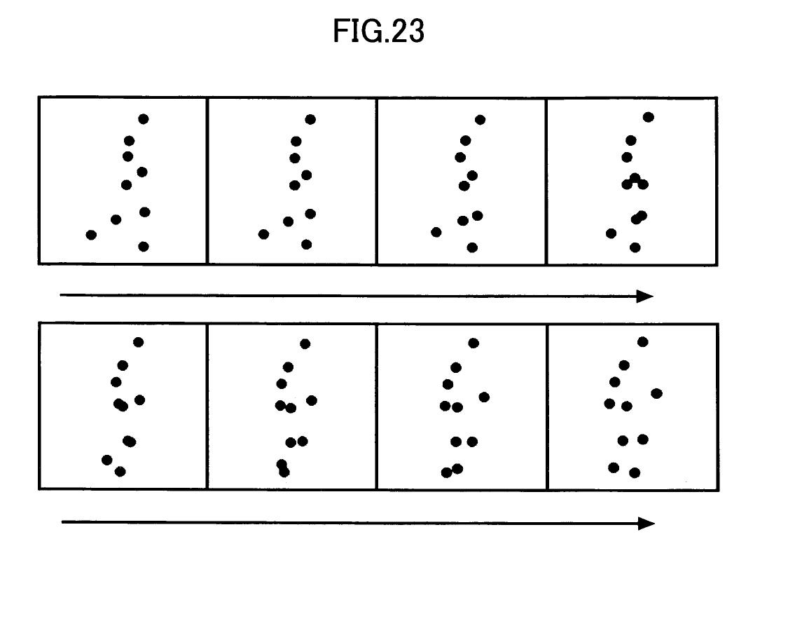

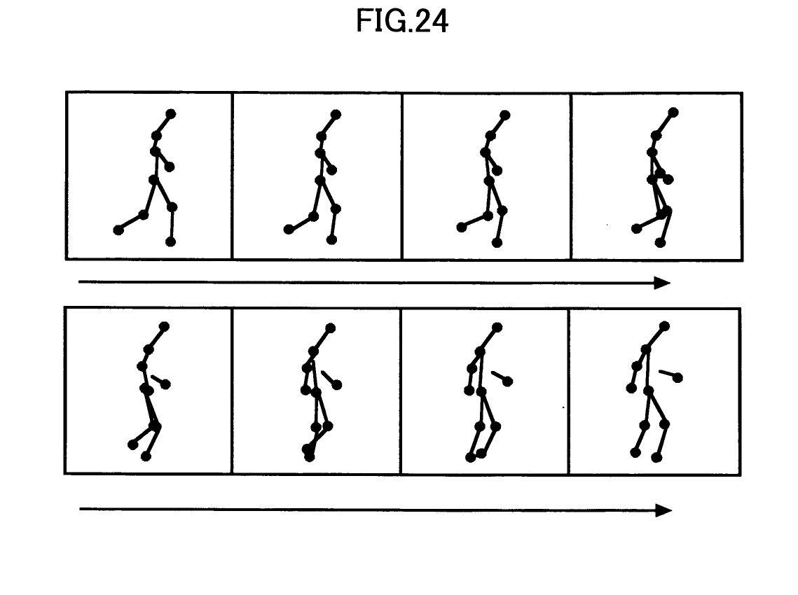

Examples of the authentication-use video presented in the authentication-use video section 11 are described below with reference to FIGS. 23 through 25. In the screen page shown in FIG. 22, the user observing the authentication-use video section 11 selects, from the list of selection boxes 12, a selection indicating the type of physical movement perceived by the user, as the test result. Furthermore, by pressing the send button 13, the selected test result is sent to the server device 200 by a POST method of HTTP, for example. The server device 200 performs authentication by determining whether the test result is correct upon comparing the received test result and the contents of the presented authentication-use video.

Examples of the authentication-use video presented by the authentication-use video section 11 are described below.

(First Example of Authentication-Use Video)

FIG. 23 shows a first example of the authentication-use video according to the second embodiment of the present invention. The images shown in FIG. 23 are the first example of the images (authentication-use images) constituting the authentication-use video presented to the client device 100 by the server device 200 in step S2 of FIG. 3. FIG. 24 is for providing a supplementary description for FIG. 23.

In FIG. 23, each image includes a background and a group of dots moving on the background. When a human being observes these images, it is perceived as a video of a walking human being. The dots in each image correspond to characteristic areas of a walking human body, such as the head, shoulders, elbows, wrists, hips, legs, and ankles. The dots corresponding to various positions of the human body move in correspondence with the movement of a walking human being while maintaining appropriate lengths in the body.

The series of images are continuously presented as a video, in an order starting from the left image in the top row to the right image in the top row, and then from the left image in the bottom row to the right image in the bottom row, as viewed in FIG. 23. Accordingly, a mere group of dots is perceived as a human body connected by a skeleton as shown in FIG. 24. Therefore, the human observing this video perceives the dots as a walking human being.

This is considered as attributable to a perception mechanism that is acquired for quickly recognizing another moving human being or another moving creature.

However, it is considerably difficult for a computer program to determine the biological motion video shown in FIG. 23 as a walking human being. Even if a computer algorithm that can make such a determination were developed and implemented as a program, it would require considerably complex processes such as grouping and identifying the moving dots. Furthermore, such processes would require a large memory and a high-speed CPU, which inevitably leads to increased cost.

Accordingly, increased complexity in the technology for passing the authentication test using the above example of the authentication-use video leads to increased cost. Thus, in order to make a nuisance with the use of a “bot”, hardware of higher performance is required, or the frequency of nuisances per unit time needs to be decreased. Therefore, it will become more impractical to make a nuisance.

In this example of an authentication-use video, the human observing the dots perceives them as a walking or jumping human being by biological motion perception. Instead, the video may show other movements such as throwing an object or kicking an object, which are perceived by biological motion perception.

As described above, the authentication system according to the present embodiment determines whether the user is a human being by using a video with which the human observer can perceive a biological motion from a group of dots moving on a background.

Accordingly, it possible to make it even more difficult to make a nuisance with the use of a computer program that automatically exchanges information with a server by a service on a computer network.

(Second Example of Authentication-Use Video)

FIG. 25 shows a second example of the authentication-use video according to the second embodiment of the present invention. The images shown in FIG. 25 are the second example of the images (authentication-use images) constituting the authentication-use video presented to the client device 100 by the server device 200 in step S2 of FIG. 3.

FIG. 25 illustrates a biological motion video divided in time series, which can be perceived as a human being jumping while opening his arms. Actually, each of these dots is moving irregularly. However, the human being has a visual mechanism of perceiving a movement by relating the movement of each dot with the movement of another dot. This is referred to as perception of biological motion. This is considered as attributable to a perception mechanism that is acquired for quickly recognizing another moving human being or another moving creature.

(Second Example of Presentation Screen Page of Authentication-Use Video)

A description is given of a second example of a screen page presenting an authentication-use video according to the second embodiment with reference to FIG. 26. The image shown in FIG. 26 is an example of a displayed screen page that is presented to the client device 100 by the server device 200 in step S2 of FIG. 3.

The screen page display contents shown in FIG. 26 include authentication-use video sections 4, 5, and 6 in which plural authentication-use videos are presented, tick boxes 7 provided at each of the authentication-use video sections 4, 5, and 6 the user to make a selection, and a send button 8 for sending, to the server device 200, the selection of the user selected with the tick boxes 7.

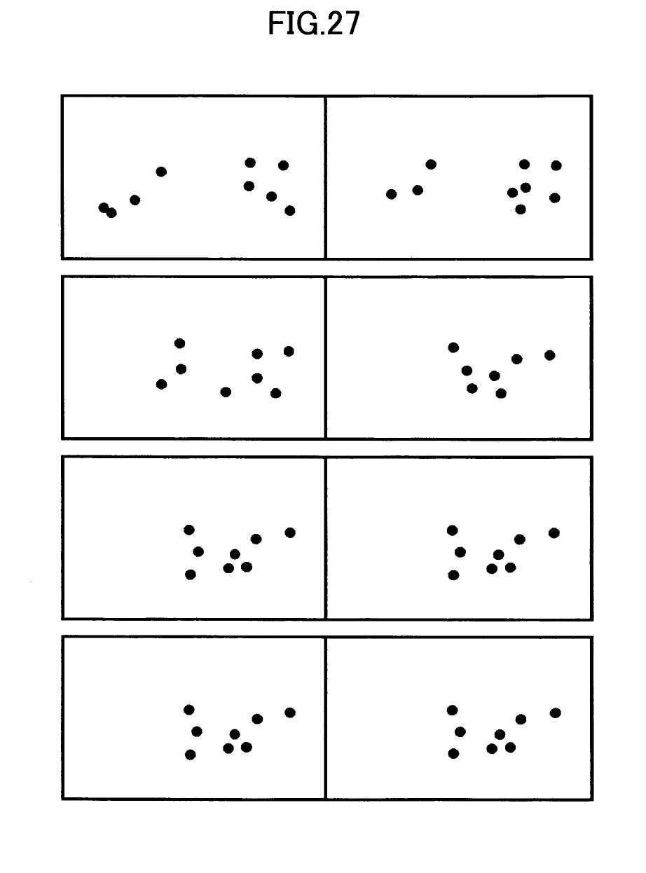

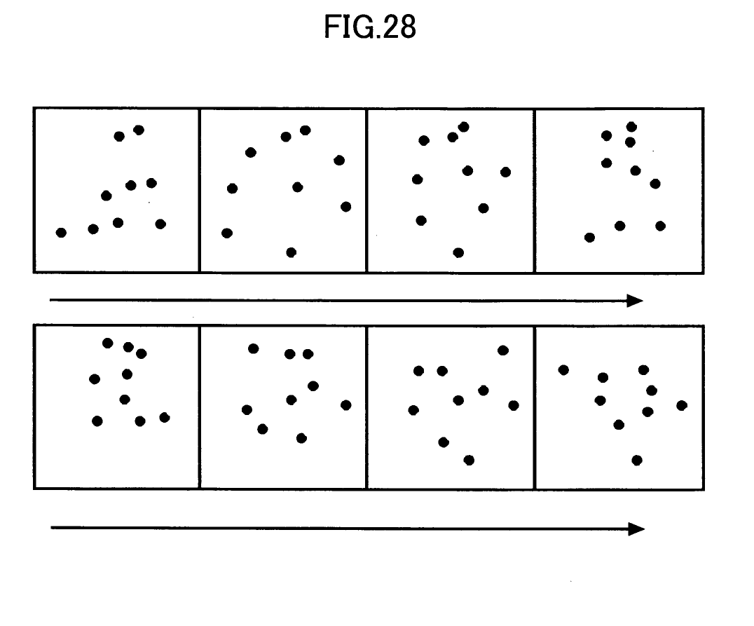

Examples of the authentication-use videos presented in the authentication-use video sections 4, 5, and 6 are described below with reference to FIGS. 27 and 28. In the screen page shown in FIG. 26, an instruction is given in writing or vocally, to select one (or plural) authentication-use video section(s) displaying a video from which a movement can be perceived, from among the authentication-use video sections 4, 5, and 6. For example, the video is perceived to be showing a walking human being. In this case, in one (or plural) authentication-use video section(s) 4, 5, and 6, a biological motion video perceived as a walking human being is randomly displayed. When two or more videos are perceived as showing the same type of movement, the sizes of the perceived human beings or the speeds of the movements can be different.

The tick boxes 7 are appended in correspondence with the videos. At the client device 100, the user ticks the tick boxes provided under all of the videos which are perceived as walking human beings. Furthermore, by pressing the send button 8, the selected test result is sent to the server device 200 by a POST method of HTTP, for example. The server device 200 performs authentication by determining whether the test result is correct upon comparing the received test result with the contents of the presented authentication-use video.

However, it is considerably difficult for a computer program to determine the type of movement by biological motion perception. Even if a computer algorithm that can make such a determination were developed and implemented as a program, it would be require considerably complex processes such as grouping and identifying the moving dots. Furthermore, such processes would require a large memory and a high-speed CPU, which inevitably leads to increased cost.

Accordingly, increased complexity in the technology for passing the authentication test using the above example of the authentication-use video leads to increased cost. Thus, in order to make a nuisance with the use of a “bot”, hardware of higher performance is required, or the frequency of nuisances per unit time needs to be decreased. Therefore, it will become more impractical to make a nuisance.

In this example of an authentication-use video, three types of videos are presented. However, the number of presented videos is not particularly limited to three videos as long as plural videos are presented. It is better to have as many videos presented as possible. However, the number of videos is in a tradeoff relationship with the time required for presentation. Therefore, the number of videos is to be determined in consideration of the importance, the degree of risk, and the operability of the authentication system.

(Third Example of Authentication-Use Video)

FIG. 27 shows a third example of the authentication-use video according to the second embodiment of the present invention. The images shown in FIG. 27 are the third example of the images (authentication-use images) constituting the authentication-use video presented to the client device 100 by the server device 200 in step S2 of FIG. 3.

In FIG. 27, each image includes a background and a group of dots moving on the background. When a human being observes these images, it is perceived as a video of a moving animal (in FIG. 27, an animal of the felidae family). The dots in each image correspond to characteristic areas of a moving animal's body, such as the head, shoulders, elbows, wrists, hips, legs, and ankles. The dots corresponding to various positions of the animal's body move in correspondence with the movement of the moving animal while maintaining appropriate lengths of the body.

The series of images are continuously presented as a video, in an order starting from the left image in the top row to the right image in the top row, and then from the left image in the bottom row to the right image in the bottom row, as viewed in FIG. 27. Accordingly, a mere group of dots is perceived as the body of an animal of the felidae family connected by a skeleton. Therefore, the human observing this video perceives the dots as a moving animal of the felidae family.

The images in the video can be perceived by biological motion perception. The videos divided in time series shown in FIGS. 23 and 25 which can be perceived by a human being as moving human beings when the dots move, and the video divided in time series shown in FIG. 27 which can be perceived by a human being as a moving animal, are randomly displayed in the authentication-use video sections 4, 5, and 6.

As described above, the biological motion perception functions not only for moving human beings but also for animals. As described above, the biological motion perception is considered as attributable to a perception mechanism that is acquired for quickly recognizing another moving human being or another moving creature.

In the screen page shown in FIG. 26, an instruction is given in writing or vocally, to select one (or plural) authentication-use video section(s) displaying a video from which a movement can be perceived, from among the authentication-use video sections 4, 5, and 6. In one (or plural) authentication-use video section(s) 4, 5, and 6, a biological motion video perceived as a moving human being is randomly displayed, and in the other authentication-use video section(s), a biological motion video perceived as an animal is displayed. When two or more videos are perceived as showing the same type of creature (including human beings), the sizes of the perceived creatures or the speeds of the movements can be different.

As described above, the authentication system 1 according to the second embodiment uses a video including a group of dots moving on a background, with which the human observer can perceive a biological motion, to make the user distinguish the type of perceived creature (or movement).

Accordingly, it possible to make it even more difficult to make a nuisance with the use of a computer program that automatically exchanges information with a server by a service on a computer network.

(Fourth Example of Authentication-Use Video)

FIG. 28 shows a fourth example of the authentication-use video according to the second embodiment of the present invention. The images shown in FIG. 28 are the fourth example of the images (authentication-use images) constituting the authentication-use video presented to the client device 100 by the server device 200 in step S2 of FIG. 3.

In FIG. 28, each image includes a background and a group of dots moving on the background. FIG. 28 shows a video (unperceivable video) from which a biological motion cannot be perceived (i.e., the human observing this video cannot perceive a moving animal, etc.), in contrast to a video from which a biological motion can be perceived. The group of dots in each image moves randomly, and thus cannot be perceived as a biological motion. Such a video from which a biological motion cannot be perceived is randomly presented in one of the authentication-use video sections 4, 5, and 6 shown in FIG. 26 for each authentication operation.

In the screen page shown in FIG. 26, an instruction is given in writing or vocally, to select one (or plural) authentication-use video section(s) displaying a video from which a movement can be perceived, from among the authentication-use video sections 4, 5, and 6. In this case, in one (or plural) authentication-use video section(s) 4, 5, and 6, a biological motion video is randomly displayed. When two or more videos are perceived as showing the same type of movement, the sizes of the perceived human beings or the speeds of the movements can be different. When two or more videos are perceived as showing the same type of creature (including human beings), the sizes of the perceived creatures or the speeds of the movements can be different.

(Modification of Authentication-Use Video Presented by Authentication-Use Video Section)

Examples of the authentication-use video are described above with reference to FIGS. 23, 25, 27, and 28. In the following, a description is given of a modification of the images (authentication-use images) constituting the authentication-use video.

Each of the above-described authentication-use videos (or each of the authentication-use images constituting the authentication-use videos) may have only two colors, i.e., a color of the background and a color of the group of dots. With such a configuration, the videos can be compressed by a LZW compression method used in GIF animation, for example.

In the authentication-use video, the area ratio of the group of dots is considerably small with respect to the background, and therefore the compression process can be performed at high speed and with a considerably high compression ratio. This is because with the LZW compression method used in GIF animation, as the same color is continuously used, the compression ratio of the image becomes high.

The modification of the authentication-use video is characterized in that only two colors are used, i.e., the color of the background and the color of the group of dots.

Accordingly, it possible to make it even more difficult to make a nuisance with the use of a computer program that automatically exchanges information with a server by a service on a computer network, and to also reduce the amount of the data being used.

### Third Embodiment

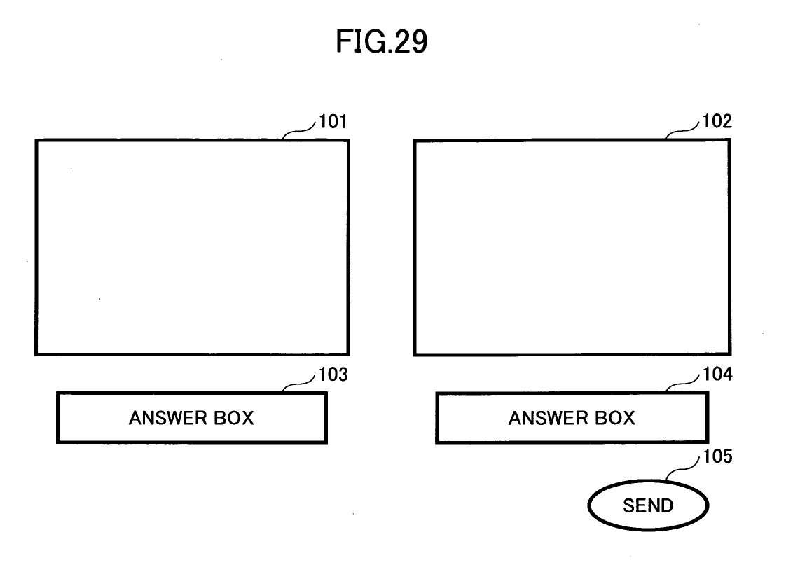

A description is given of a third embodiment of the present invention with reference to FIGS. 29 through 45.

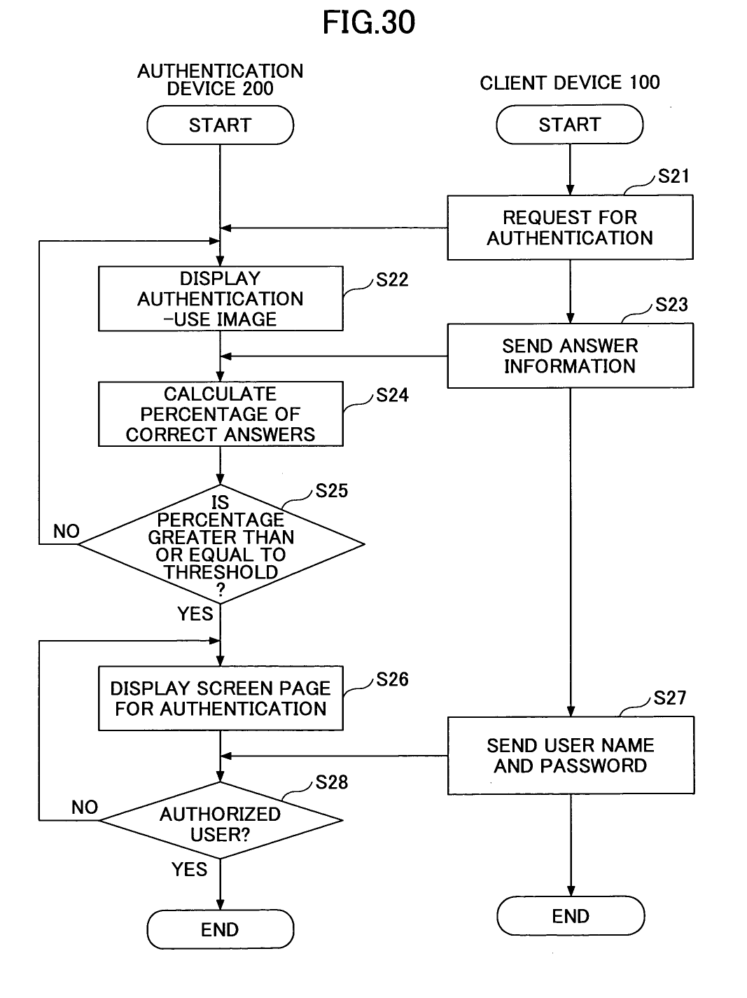

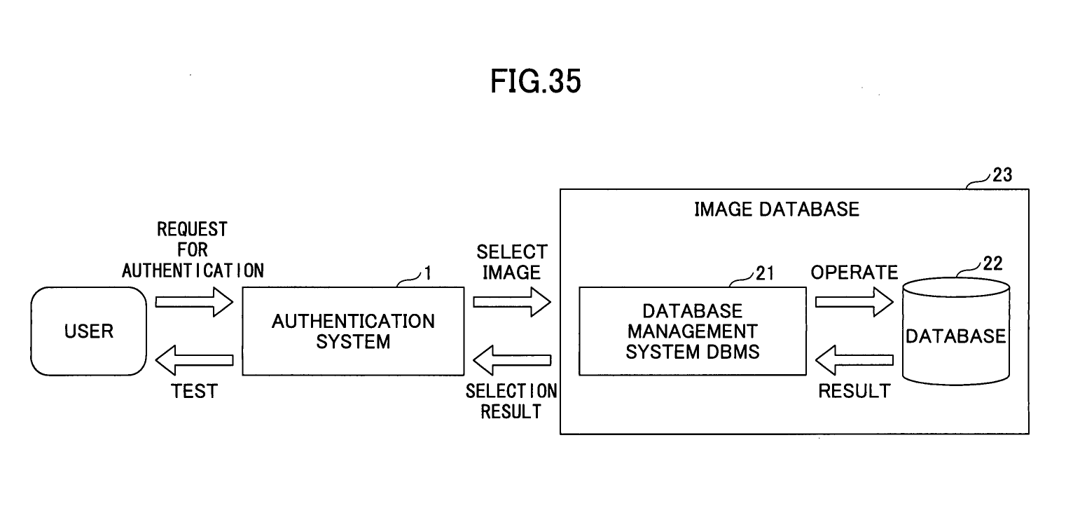

The system configuration and the functional configuration of an authentication system according to the third embodiment are the same as those of the first embodiment (see FIGS. 1 and 2), and are therefore not further described. As for the system configuration, the one shown in FIG. 35 can be applied. As for the functional configuration, a supplemental description is given of the authentication-use image presenting unit 230 (authentication-use video presenting unit). As for the operations, the third embodiment is different from the first embodiment, and therefore a description is given with reference to FIG. 30.

The above-described authentication-use image presenting unit (authentication-use video presenting unit) 230 according to the first embodiment presents authentication-use images (authentication-use videos) generated by the authentication-use image generating unit 220. In the third embodiment, in addition to the authentication-use image (authentication-use video), an answer screen page is presented, including answer boxes for prompting the user to provide answers in accordance with the presented authentication-use images, as shown in FIG. 29. In the third embodiment, the answer screen page is presented in addition to an authentication-use image; however, the answer screen page may be presented in addition to an authentication-use video.

(Example of Presentation Screen Page of Authentication-Use Image)

With reference to FIG. 29, a description is given of an example of an authentication-use video according to the third embodiment of the present invention.

The image shown in FIG. 29 is an example of a displayed screen page that is presented to the client device 100 by the server device 200 in step S2 of FIG. 3.

The screen page display contents shown in FIG. 29 include authentication-use image sections 101 and 102 presenting plural (two in this case) authentication-use images, and answer boxes 103 and 104 for the user to provide answers based on the authentication-use images presented in the authentication-use image sections 101 and 102.

The authentication-use image presented in the authentication-use image section 101 is one photograph or image randomly selected from a group of plural known images (hereinafter, “image group 1”) associated with information corresponding to objects (e.g., a man, a vehicle, a building) or scenes with meanings (e.g., a suburban area, winter) (hereinafter, the information associated with the authentication-use image is referred to as “tag information” or simply a “tag”). Meanwhile, the authentication-use image presented in the authentication-use image section 102 is one photograph or image randomly selected from a group of plural unknown images (hereinafter, “image group 2”) associated with unknown tag information of the authentication-use image.

At the screen page shown in FIG. 29, the user that has observed the authentication-use image sections 101 and 102 inputs tag information considered as appropriate in the answer boxes 103 and 104. Furthermore, by pressing a send button 105, the answers (test results) in the answer boxes 103 and 104 are sent to the server device 200 by a POST method of HTTP, for example. The server device 200 performs authentication by comparing the received answer of the answer box 103 with tag information that is associated beforehand with an image belonging to image group 1. Specifically, the server device 200 calculates the percentage of correct answers, based on how many tag information items in the received answer information correspond to the tag information items associated beforehand with the authentication-use images presented in the authentication-use image section 101. When the calculated percentage of correct answers is greater than or equal to a predetermined threshold (for example, 40% through 50%), the user is determined to be a human being. A detailed description is given below of the above operations.

(Example of Operation of Authentication System)

FIG. 30 is a flowchart illustrating an example of operations of the authentication system according to the third embodiment. The server device 200 performs an authentication operation for determining whether the user of the client device 100 is an actual human being.

First, the client device 100 requests the server device 200 to perform authentication (step S21). In this example, the user sends a request from the client device 100 to the server device 200, to perform authentication. The request can be a service request for receiving a service.

In step S22, the server device 200 presents authentication-use images (or authentication-use videos) to the client device 100 (step S22). The authentication-use image generating unit 220 generates authentication-use images (or authentication-use videos) (for example, an image belonging to image group 1 and an image belonging to image group 2, which are respectively presented in the authentication-use image sections 101 and 102 shown in FIG. 29). Tag information that is associated beforehand with the images belonging to image group 1 is stored in a storage device such as an image database (not shown) (described below with reference to FIG. 35). Next, the authentication-use image presenting unit 230 presents the authentication-use images generated by the authentication-use image generating unit 220 to the client device 100. Furthermore, an answer screen page is presented, including answer boxes for prompting the user to provide answers in accordance with the presented authentication-use images. Next, the display unit 120 of the client device 100 displays the authentication-use images and the screen page.

In step S23, the client device 100 sends the answer information to the server device 200 (step S23). The user inputs, into the input unit 110, tag information that is considered appropriate for the authentication-use image presented at step S22. The answer information input to the input unit 110 is transmitted to the server device 200.

In step S24, the server device 200 calculates the percentage of correct answers based on the answer information received at step S23 (step S24). The authentication unit 210 calculates the percentage of correct answers based on how many tag information items in the received answer information correspond to the tag information items associated beforehand with the authentication-use images presented in the authentication-use image section 101.

In step S25, the server device 200 determines whether the percentage of correct answers calculated at step S24 is greater than or equal to a predetermined threshold (step S25). When it is determined to be greater than or equal to the predetermined threshold (Yes in step S25), the process proceeds to step S26. When it is determined to be less than the predetermined threshold (No in step S25), the process returns to step S22. The threshold may be set at, for example, 40% through 50%, as long as the precision of recognition exceeds that of the most advanced image recognition technology that is currently available (for example, 20% through 30%).

In step S26, the server device 200 presents the screen page for authentication to the client device 100 (step S26). At this step, a screen page for authentication is presented for authenticating the user, including a user name (user identification character string) input form and a password input form, and the user is prompted to input these items for user authentication.

In step S27, the client device 100 sends the user name and the password to the server device 200 (step S27). The user inputs, with the input unit 110, the user name and the password into the screen page for authentication presented at step S26. The information including the user name and the password input with the input unit 110 is transmitted to the server device 200.

In step S28, the server device 200 determines whether the user is an authorized user based on the information including the user name and the password received at step S27 (step S28). The authentication unit 210 makes the determination (authentication) by comparing the information including the user name and the password received at step S27 with user information managed in a storage unit (not shown).

When the user is determined to be an authorized user (Yes in step S28), the service providing unit 250 starts providing a service, such as displaying a content posting form, for example. When a service request had been received in step S21, the service providing unit 250 can start providing the service in accordance with the service request that had been received. When the user is determined to be an unauthorized user (No in step S28), the process returns to step S26.

By the above-described process, the server device 200 can perform the authentication operation of determining (authenticating) whether the user of the client device 100 is an actual human being.

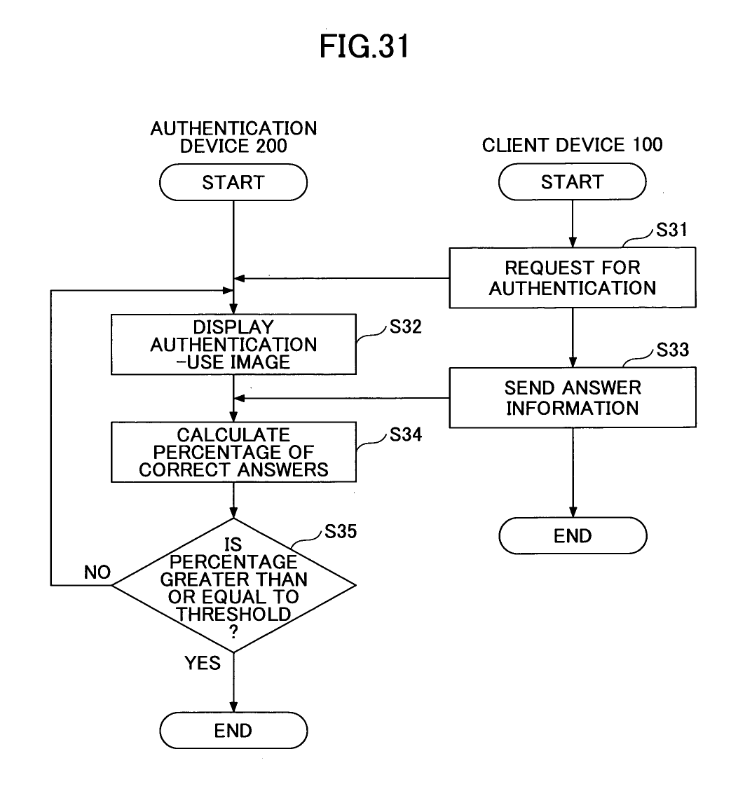

The procedures of steps S22 through S25 and the procedures of steps S26 through S28 can be performed in the inverse order. Furthermore, when the request from the client device 100 to the server device 200 is to acquire an account from the server device 200, only the procedures of steps S31 through S35 shown in FIG. 31 are performed, and the user registration can be performed after these steps. FIG. 31 is a flowchart illustrating another example of operations of the authentication system according to the third embodiment. The procedures of steps S31 through S35 are the same as those of steps S21 through S25 shown in FIG. 30, respectively, and are therefore not further described.

In the above examples of operations, one photograph or image is randomly selected, as the authentication-use image, from each of image group 1 including plural known tag information items and image group 2 including unknown tag information items, and the selected photographs/images are presented. However, an arbitrary plural number of images (more than one) can be selected from each of the image groups, and the plural selected images can be presented.

As described above, in the authentication system according to this operation example, at least two images are presented within the same screen page, and the user is prompted to provide answers corresponding to the objects included in the images or the meanings of the images, to determine whether the user is a human being. At least one photograph or image is randomly selected, as the authentication-use image, from each of image group 1 including plural known words corresponding to names of objects in images or words expressing meanings of scenes in images, and image group 2 including unknown words corresponding to names of objects in images or words expressing meanings of scenes in images, and the selected photographs/images are presented. The determination for authentication is made based on the percentage of correct answers given by the user with respect to the image group including plural known words corresponding to names of objects or scenes.

With such a feature, it possible to make it even more difficult to make a nuisance with the use of a computer program that automatically exchanges information with a server by a service on a computer network.

(Modification 1 of Operation Example of Authentication System)

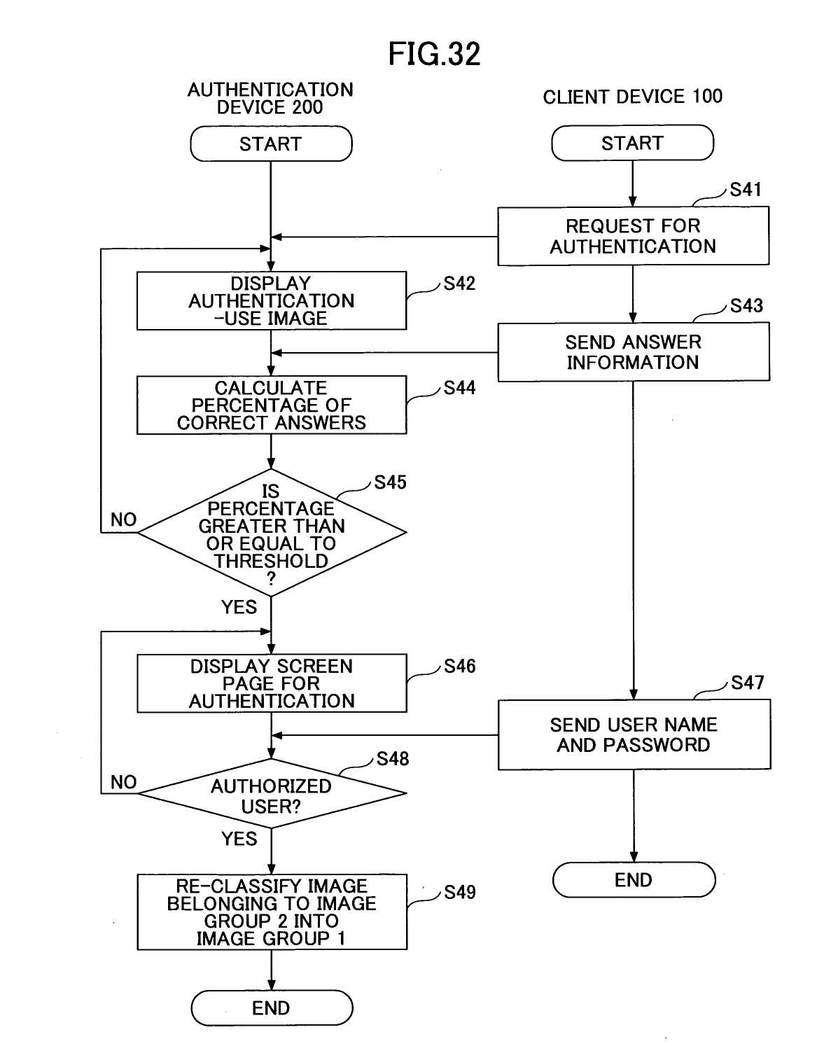

FIG. 32 is a flowchart illustrating modification 1 of operations of the authentication system according to the third embodiment. Modification 1 is based on the operations of FIG. 30. The procedures of steps S41 through S48 shown in FIG. 32 are the same as those of steps S21 through S28 shown in FIG. 30, respectively, and are therefore not further described.

When the user is determined to be an authorized user in step S48 (Yes in step S48), the process proceeds to step S49, where the server device 200 classifies the images belonging to image group 2 presented in the authentication-use image section 102, into image group 1 (step S49). This is because when the input user name and password are those of an authorized user, it can be determined that the answer information for the images presented in the authentication-use image section 102 may be somewhat credible. Accordingly, the corresponding answer information is associated with the images of image group 2 as tag information, and these images are classified into image group 1. The service providing unit 250 starts providing a service to the user.

With such a configuration, it possible to make it even more difficult to make a nuisance with the use of a computer program that automatically exchanges information with a server by a service on a computer network. Furthermore, the number of data items in the image database can be sequentially increased, and therefore the image database required in a system for recognizing contents of a photograph/image can be easily established.

As described above, in the authentication system according to this operation example, when the user is determined to be a human being, the answer information given by the user for a presented image selected from image group 2, is used as tag information of the corresponding image, and the corresponding image is classified into image group 1.

With such a feature, it possible to make it even more difficult to make a nuisance with the use of a computer program that automatically exchanges information with a server by a service on a computer network, and also to make it easy to establish the image database required in a system for recognizing contents of a photograph/image.

(Modification 2 of Operation Example of Authentication System)

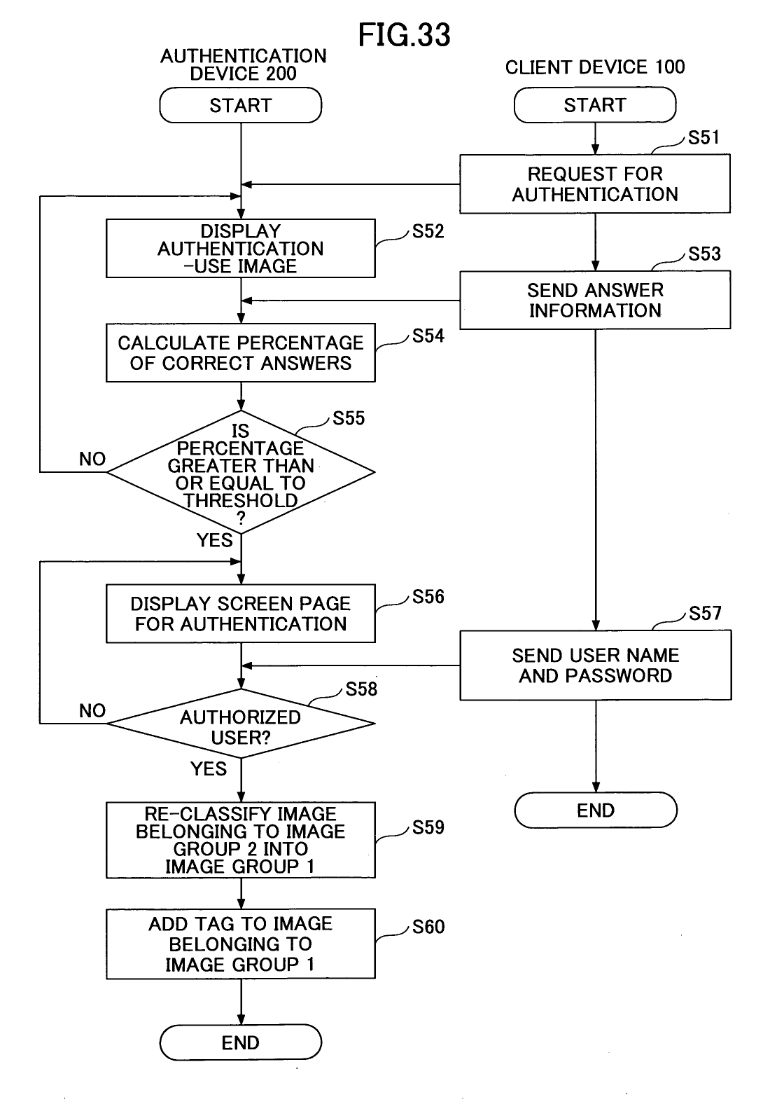

FIG. 33 is a flowchart illustrating modification 2 of operations of the authentication system according to the third embodiment. Modification 2 is based on the operations of FIG. 30. The procedures of steps S51 through S59 shown in FIG. 33 are the same as those of steps S41 through S49 shown in FIG. 32, respectively, and are therefore not further described.

While performing the procedure of step S59, the process proceeds to step S60, where the answer information for the image presented in the authentication-use image section 101 is associated with the same image by the server device 200 as tag information (step S60). When the input user name and password are those of an authorized user, it can be determined that the answer information for the image presented in the authentication-use image section 101, which had not been associated beforehand with the corresponding image as tag information, may be somewhat credible. Accordingly, the answer information is associated with the corresponding image as new tag information.

With such a configuration, the following problem can be solved. That is, even if the user does not have any malicious intent, a word provided for an image by the user observing the image may vary somewhat according to the subjective perception of the user. This may cause erroneous determinations, in which a human user is determined as not being a human being. Such erroneous determinations can be reduced with this configuration.

As described above, in the authentication system according to this operation example, when the user is determined to be a human being, among the answer information items given by the user for presented images selected from image group 1, an answer information item that had not been known before the test is added as new tag information of the corresponding image.

With such a feature, it is possible to improve the precision in determining whether the user is a human being.

(Modification 3 of Operation Example of Authentication System)

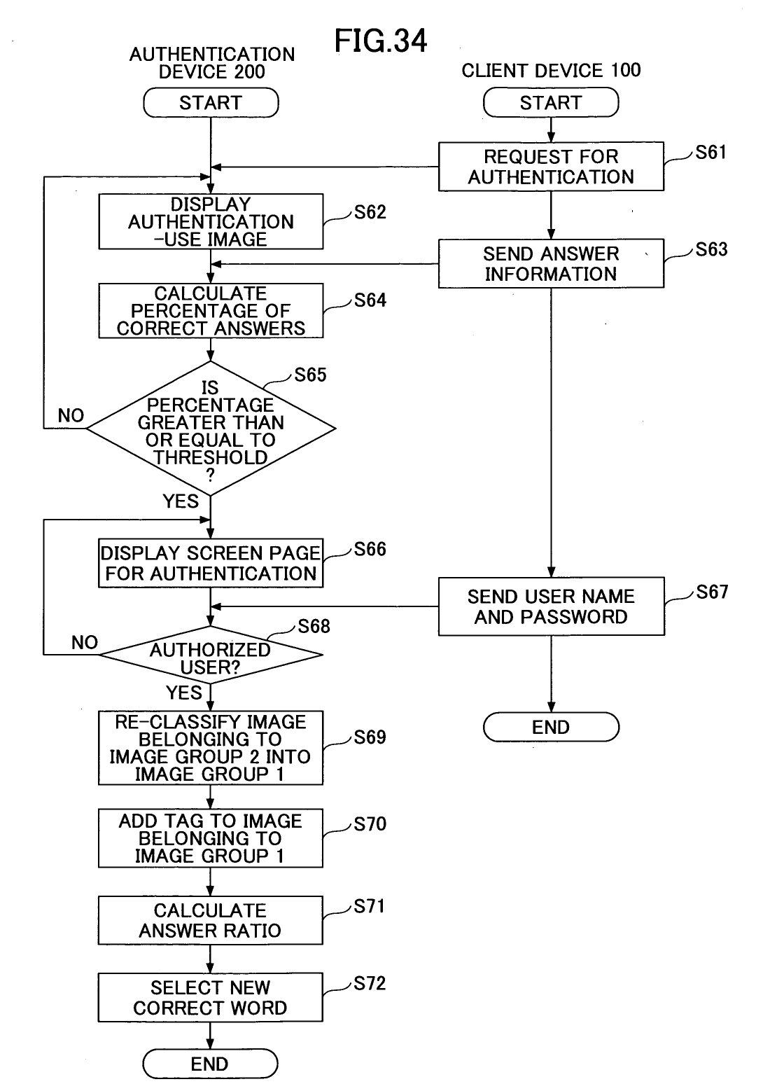

FIG. 34 is a flowchart illustrating modification 3 of operations of the authentication system according to the third embodiment. Modification 3 is based on the operations of FIG. 30. The procedures of steps S61 through S70 shown in FIG. 34 are the same as those of steps S51 through S60 shown in FIG. 33, respectively, and are therefore not further described.

When the procedure of step S70 is finished, the process proceeds to step S71, where the server device 200 calculates the answer ratio for all tag information items appended to the images presented in the authentication-use image section 101 (step S71). The answer ratio is obtained by dividing “the number of times the corresponding tag information item has been included in the answer information for the particular image” by “the number times the particular image has been used for the test”.

In step S72, the server device 200 selects a new correct word (step S72). In this case, when the answer ratio calculated at step S71 exceeds a predetermined threshold such as 50%, the specific tag information item is determined to be the new correct word which is used for calculating the percentage of correct answers for the particular image, starting with the next test.

With such a configuration, the following problem can be solved. That is, even if the user does not have any malicious intent, a word provided for an image by the user observing the image may vary somewhat according to the subjective perception of the user. This may cause erroneous determinations, in which a human user is determined as not being a human being. However, with this configuration, the correct word can be selected based on a larger number of determinations, so that such erroneous determinations can be reduced.

As described above, the authentication system according to this operation example calculates, for each test, the answer ratio of a tag information item given for each image belonging to image group 1 by a user that has been determined to be a human being. Based on the calculated answer ratio, a new correct word is selected for calculating the percentage of correct answers for the particular image, starting with the next test.

With such a feature, it is possible to improve the precision in determining whether the user is a human being.

(Authentication System)

FIG. 35 illustrates a system configuration of the authentication system according to the third embodiment of the present invention. As shown in FIG. 35, the authentication system 1 is connected to an image database system 23 via a network. The image database system 23 includes a database management system (hereinafter, “DBMS”) 21 for managing various image data used for authentication, and a database 22.

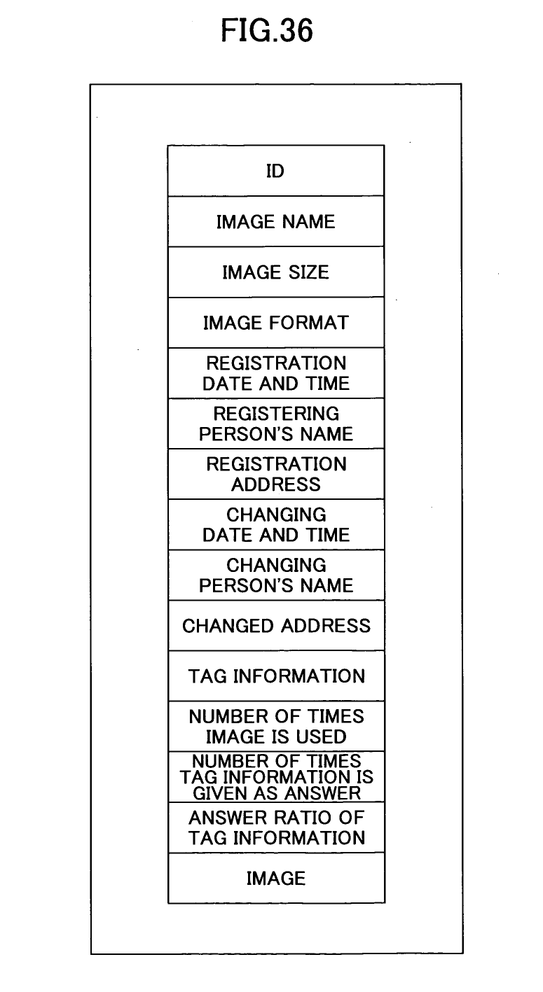

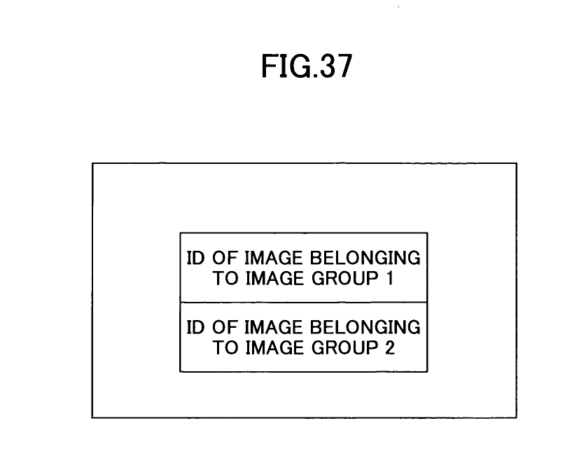

The data pertaining to the authentication-use image managed in the database 22 has a structure including elements such as those shown in FIG. 36, i.e., the ID of the data in the database 22, the image name, the image file size, the image format, the registration date and time, the registering person's name, the IP address or the hostname (registration address) of the computer used by the person registering the data, tag information, number of times the image has been used for authentication, number of times the tag information has been given as an answer for authentication, the answer ratio of the tag information, and the image (image data). When the user adds an image, tag information may or may not be appended to the image. The ID of an image appended with tag information is recorded as image data belonging to image group 1, and the ID of an image that is not appended with tag information is recorded as image data belonging to image group 2. The IDs are recorded in image classification-use data having a structure as shown in FIG. 37, and are saved and managed in the database 22.

By the above system configuration, in the authentication system 1, when a new request for authentication is made by the user, a request is sent to the DBMS 21 for images belonging to image group 1 and images belonging to image group 2 (instruction for selecting images) with a language such as SQL used for making a request to databases.

The DBMS 21 that received the instruction for selecting images randomly selects one image ID from among the image IDs belonging to image group 1 and randomly selects one image ID from among the image IDs belonging to image group 2, with the use of image classification-use data shown in FIG. 37. Then, the DBMS 21 searches the image data in the database 22 for images corresponding to all of the selected IDs, extracts the images found as a result of the search, and returns the selection results to the authentication system 1 together with tag information. The authentication system 1 uses these selection results for authentication, as described in the above operation examples.

When the user is determined to be a human being, and the user name and password corresponds to those of an authorized user, the authentication system 1 determines that the answer information given for images presented in the authentication-use image section 102 is somewhat credible. Therefore, the authentication system 1 sends, to the DBMS 21, a request for moving the corresponding image to image group 1, and a request for registering the answer information as tag information in association with the image. Then, the DBMS 21 overwrites the image classification-use data (delete the image from image group 2 and add the image to image group 1), adds the tag information given as an answer for the image to the image data of the image, sets “1” as the number of times that this image has been used for authentication, sets “1” as the number of times that the tag information has been given as the answer, and sets “100%” as the answer ratio (see modification 1 of operation example).

Furthermore, among the answer information items for the images presented in the authentication-use image section 101, the answer information item that had not been associated beforehand with the image can be determined as being somewhat credible. Therefore, the authentication system 1 sends a request to the DBMS 21 for registering all of the tag information items given as answers for the image in association with the image. Then, the DBMS 21 adds “1” to the number of times that the image has been used. Furthermore, among the answer information items given for the image in the authentication operation, the DBMS 21 adds “1” to the number of times that each tag information item known before the test has been given as the answer, adds the tag information not known before the test as new tag information to the image data of the image, and sets “1” as the number of times that each of the new tag information items has been given as the answer. Then, the answer ratio is calculated once again for all of the tags that are registered at this time point, and the obtained answer ratios are saved in the image data (see modification 2 and 3 of the operation example).

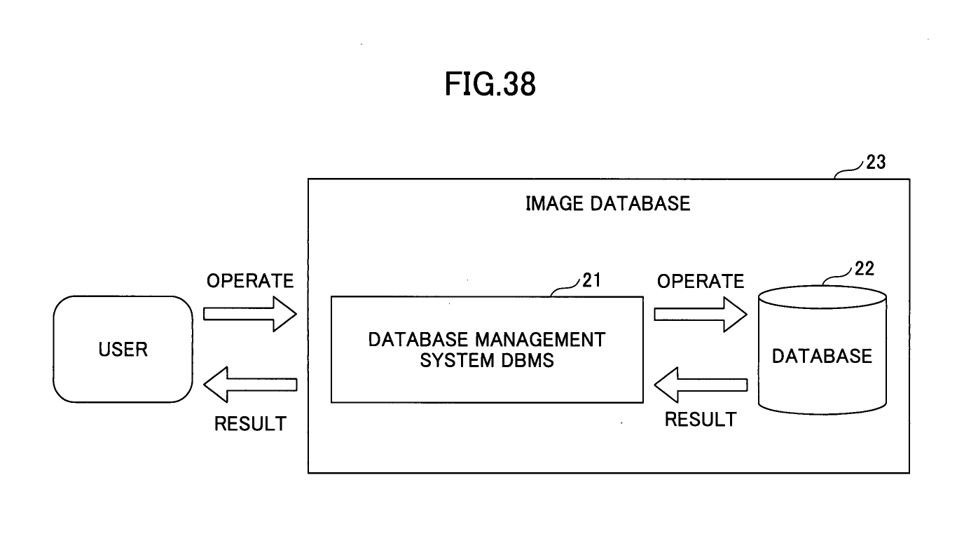

FIG. 38 is for describing how a user operates the image database. A description is given on how a user operates the image database 23 shown in FIG. 35. The user who has undergone the authentication can add images and tag information to the DBMS 21, and make requests for changing data in the DBMS 21 and searching the DBMS 21, with the use of SQL, without going through the authentication system 1. To search for the images, the elements of image data shown in FIG. 36 may be used. When the user finishes operating the image database 23, the DBMS 21 returns the results of the operation (whether there are errors, search results, etc.) to the user.

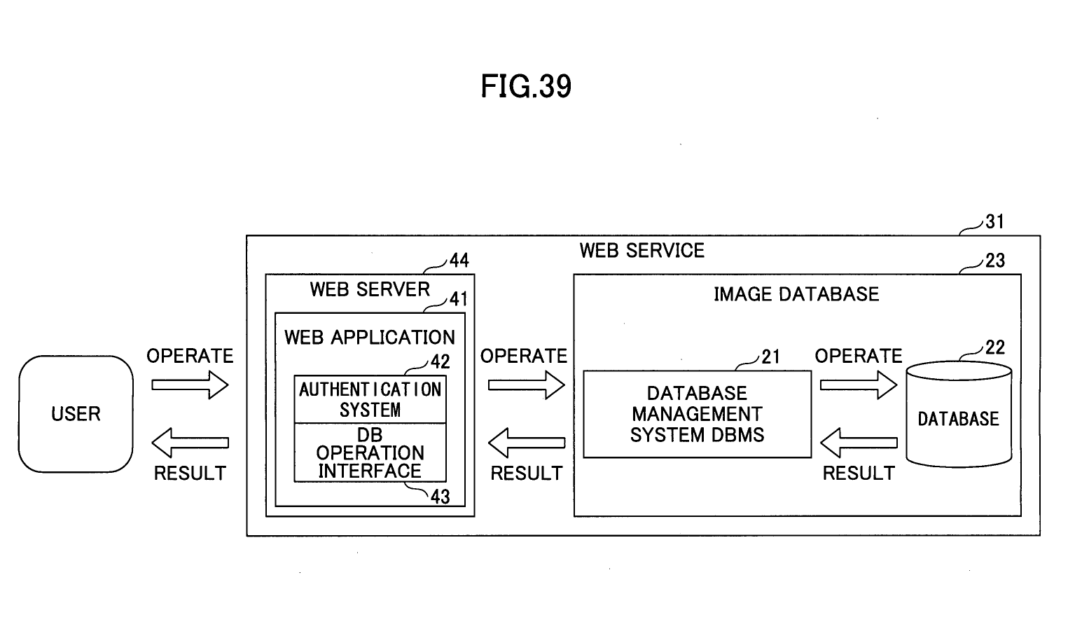

FIG. 39 is for describing the operation when a service using the image database is implemented as a WEB application. An authentication system 42 and an interface 43 for the user to operate the database 22 with SQL are implemented as a WEB application 41.

The communications between the user and a WEB service 31 are performed with HTTP or HTTPS. The user first accesses the authentication starting page to make a request to a WEB server 44 for authentication by the GET method. Then, in the WEB application 41, the authentication system 42 makes a request to the DBMS 21 for images belonging to image group 1 and images belonging to image group 2, with a language such as SQL used for making requests to the database 22. With the use of image classification-use data, the DBMS 21 randomly selects one image ID from the image IDs belonging to image group 1, and randomly selects one image ID from the image IDs belonging to image group 2. Then, the DBMS 21 searches the image data in the database 22 for the images corresponding to all of the selected IDs, extracts the images found as a result of the search, and returns the search results to the authentication system 42 together with tag information.

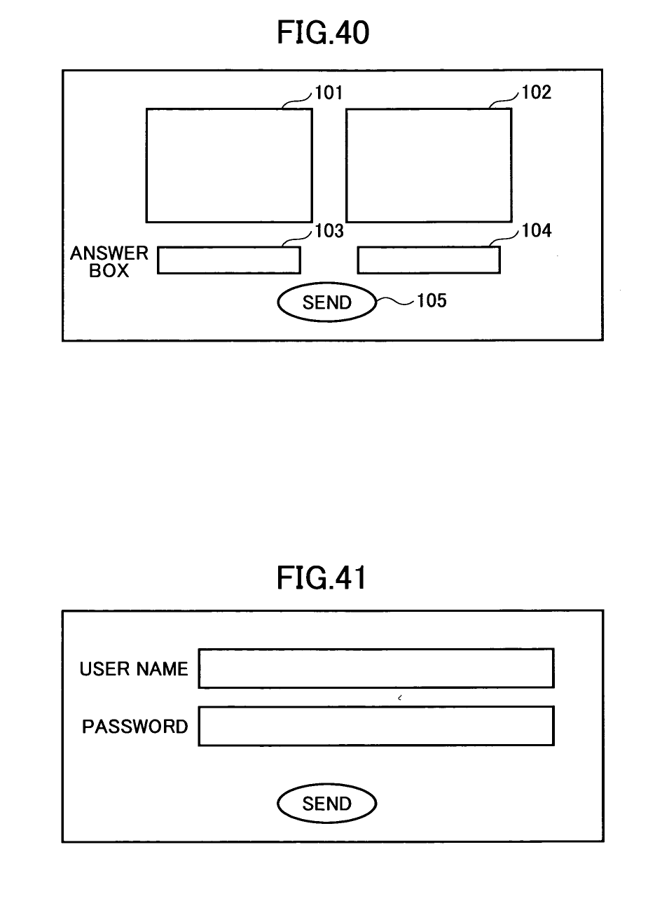

Then, the WEB application 41 displays a screen page presenting authentication-use images on the WEB browser of the user, as shown in FIG. 40. At the screen page shown in FIG. 40, the user that has observed the authentication-use image sections 101 and 102 inputs tag information considered as appropriate in the answer boxes 103 and 104. Furthermore, by pressing the send button 105, the answers (test results) in the answer boxes 103 and 104 are sent to the WEB server 44 by a POST method of HTTP, for example. The WEB server 44 performs authentication by comparing the received answer of the answer box 103 with tag information that is associated beforehand with an image belonging to image group 1 in the database 22. Specifically, the WEB server 44 calculates the percentage of correct answers, based on how many tag information items in the received answer information correspond to the tag information items that are associated beforehand with the authentication-use images presented in the authentication-use image section 101. When the calculated percentage of correct answers is greater than or equal to a predetermined threshold (for example, 40% through 50%), the user is determined to be a human being.

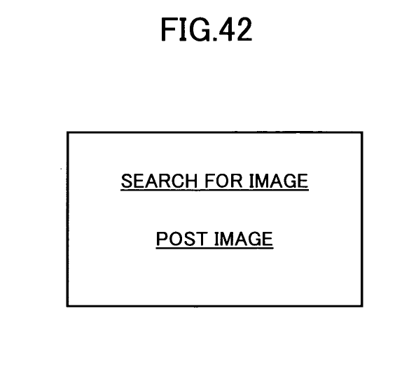

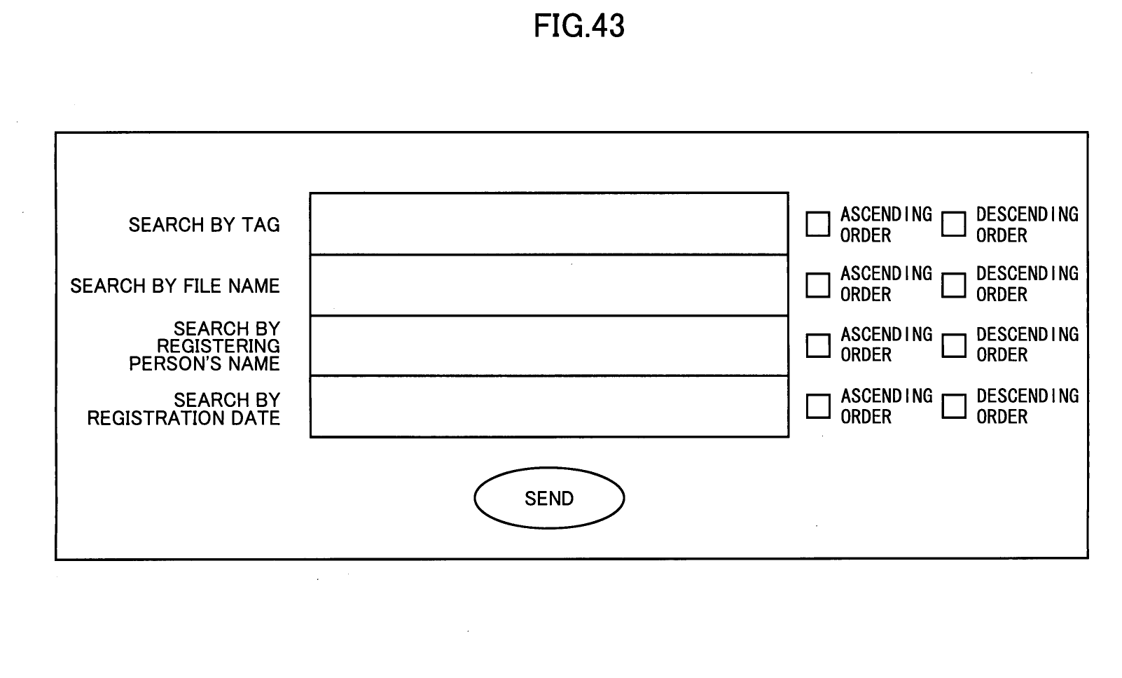

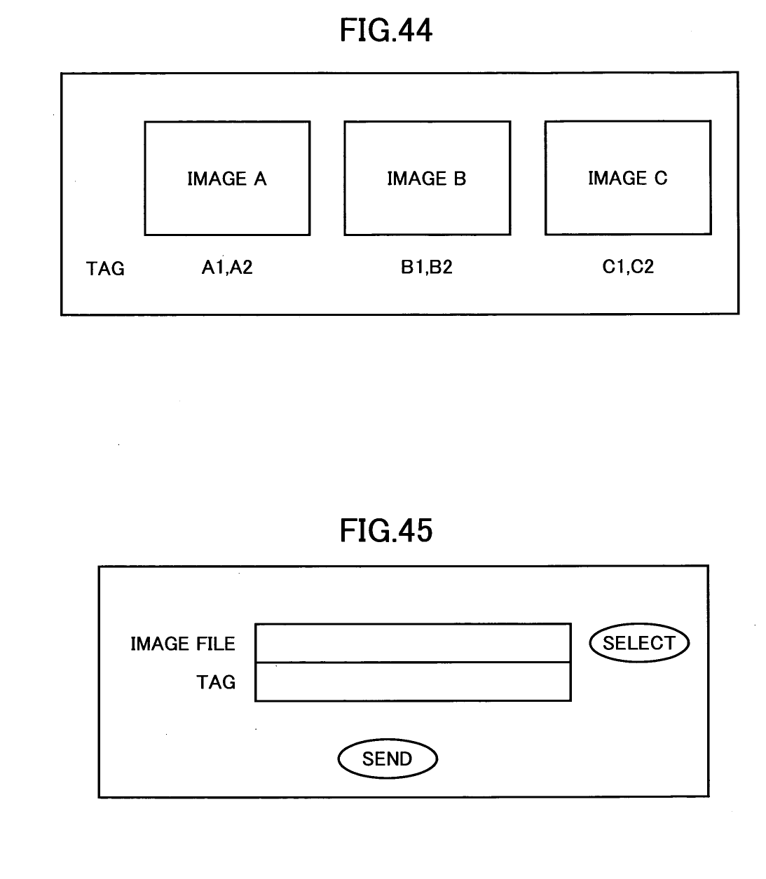

When the user is determined to be a human being, the authentication system 1 displays a screen page as shown in FIG. 41 on the user's WEB browser (more precisely a WEB browser operating in the information processing apparatus used by the user), and the user inputs a user name and a password in the screen page and presses the send button 105. This information is transmitted to the WEB server 44 by a POST method. When the user name and the password are of an authorized user, the WEB server 44 displays a screen page as shown in FIG. 42 to prompt the user to select “search for image” or “post image”. The user clicks either option to send a request for “search for image” or “post image” to the WEB server 44 by a POST method. When the user has selected “search for image”, the WEB server 44 displays a screen page prompting input pertaining to “search for image” as shown in FIG. 43, on the user's WEB browser. The user inputs a search term into the blank space corresponding to the item which the user wants to search for, inputs a tick mark in one of the tick boxes for instructing the order in which the items are to be displayed, and presses the send button. Then, this request is sent to the WEB server 44 by the POST method, and the DB operation interface 43 transfers this request to the DBMS 21 by SQL. The DBMS 21 searches the database 22 for the image data that corresponds to this request, and returns the images and the associated tag information found as a result of the search to the DB operation interface 43 in the instructed displaying order. This information is sent to the user from the WEB server 44, and as a result, the screen page showing the images found as a result of the search is displayed on the user's WEB browser, as shown in FIG. 44. The search results are displayed in the order as instructed in FIG. 43. In the third embodiment, when the tag information is selected as the search term, the displaying order may be in an ascending order or a descending order according to the answer ratios of the tags. Furthermore, when the user has selected “post image” at the screen page of FIG. 42, a screen page for prompting the user to input information pertaining to “post image” as shown in FIG. 45 is displayed on the user's WEB browser. The user selects an image file, inputs the tag information of the selected image, and presses the send button. This information is transmitted to the DB operation interface 43 by a POST method. The DB operation interface 43 sends, to the DBMS 21, an SQL statement for adding data.

With such a configuration, in the image database 23 and the WEB service 31 using the image database 23, tag information can be automatically appended to images that do not have tag information appended while the operation is being performed. Moreover, tag information that is given by a large number of users is selected as the appropriate tag information. Therefore, without the need for a large amount of image data with tag information appended, it can be determined as to whether a user is a human being with high precision, and searching operations can be performed with improved precision.

In this manner, the image database system 23 and the WEB service 31 that uses the image database system 23 can be provided, with which it is determined whether a user is a human being, and only a user who has been determined as a human is allowed to add images or edit data.

With such a feature, in the image database and the service using the image database, it can be determined as to whether a user is a human being with high precision, and searching operations can be performed with improved precision, without the need for a large amount of image data appended with tag information.

Furthermore, the image database system 23 and the WEB service 31 that uses the image database system 23 can be provided, with which the displaying order of the search results are changed according to the answer ratio, when tag information associated with an image is used as the search term to search for the image.

With such a feature, in the image database and the image sharing service, it can be determined as to whether a user is a human being with high precision, and searching operations can be performed with improved precision, without the need for a large amount of data.

A supplemental description is given of the advantages of the authentication system according to the third embodiment, in comparison with the conventional technology.

In a system using the conventional photograph/image content recognition technology, as the frequency of using the same photograph increases, it becomes easier to estimate the relationship between the image and the word appended to the image. Accordingly, the frequency of each image appearing in a test needs to be reduced. For this reason, it is necessary to have a large number of images having words appended expressing objects in the images or meanings of scenes in the images. It is considerably difficult to establish such an image database. Thus, it is becoming considerably difficult to actually implement a visual anti-robot test system using photographs/images.

However, the authentication system according to the third embodiment makes it easy to establish an image database required for such a system.

Furthermore, in recent years and continuing, image sharing services or stock photograph services on websites are gaining popularity, in which a user posts an image, which is shared among other users, so that other users are allowed to use the image in their blogs or documents at a charge or at no charge. In such a service, a word naming an object in the image or giving the meaning of a scene in the image is appended to the image beforehand as tag information by the poster of the image (person who posted the image). Therefore, the image can be searched for with the use of the tag information. However, in such a WEB service, the tag that is appended to the image beforehand depends on the subjective perception of the person who appended the tag. Therefore, it is considerably difficult to search for the desired photograph from a large number of images.

However, the authentication system according to the third embodiment makes it possible to improve the quality of such tag information and improve the precision in performing the searching operations.

### Fourth Embodiment

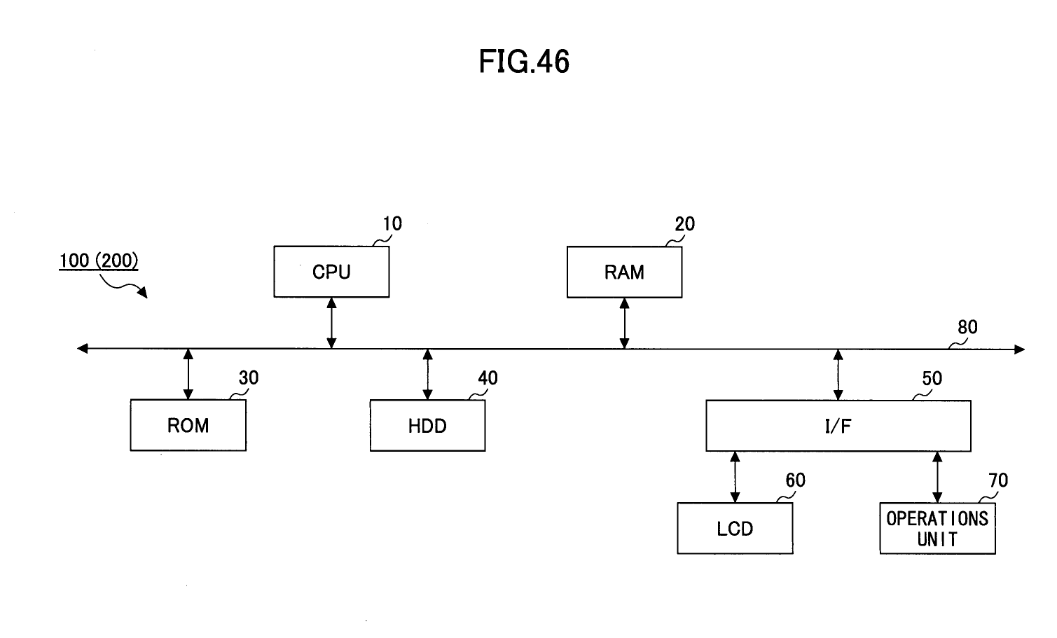

FIG. 46 is a block diagram of the hardware configuration of the client device 100 and the server device 200 according to a fourth embodiment of the present invention. As shown in FIG. 46, the client device 100 and the server device 200 according to the fourth embodiment have the same configuration as typical information processing terminals. The client device 100 and the server device 200 according to the fourth embodiment include a CPU (Central Processing Unit) 10, a RAM (Random Access Memory) 20, a ROM (Read Only Memory) 30, a HDD 40, and an I/F 50, which are interconnected by a bus 80. An LCD (Liquid Crystal Display) 60 and an operations unit 70 are connected to the I/F 50.

The CPU 10 is an arithmetic unit for controlling operations of the entire device. The RAM 20 is a volatile storage medium for writing/reading information at high-speed, which is used as a work area when the CPU 10 processes information. The ROM 30 is a read-only non-volatile recording medium, storing programs such as firmware. The HDD 40 is a non-volatile storage medium for writing/reading information at high-speed, which stores an OS (Operating System) and various control programs and application programs.

The I/F 50 is for connecting various hardware components and networks to the bus 80, and controlling the connection. The LCD 60 is a visual user interface used by the user to confirm the state of the PC. The operations unit 70 is a user interface such as a keyboard and a mouse, used by the user to input information to the device.

In such a hardware configuration, a program stored in the ROM 30, the HDD 40, or a storage medium such as an optical disk (not shown) is read out into the RAM 20. The program is operated according to control by the CPU 10, thereby configuring a software control unit. With the combination of such a software control unit and the hardware, there are provided functional blocks for implementing functions of the client device 100 and the server device 200 according to the fourth embodiment. As for the server device 200, user interfaces such as the LCD 60 and the operations unit 70 can be omitted.

(Functional Configuration)

FIG. 2 illustrates an example of the functional configuration of the authentication system according to the first embodiment. As shown in FIG. 2, the client device 100 includes the input unit 110, the display unit 120, the communications unit 130, and the control unit 140. The server device 200 includes the authentication unit 210, the authentication-use image generating unit 220, the authentication-use image presenting unit 230, the communications unit 240, the service providing unit 250, and the control unit 260.

First, a description is given of the function units included in the client device 100. The input unit 110 receives various instructions input by the user of the client device 100. The input unit 110 is realized by the operations unit 70 shown in FIG. 46. An example of the information input to the input unit 110 is a service request for receiving services such as a Web service from the server device 200.

The display unit 120 is for displaying the operational status of the client device 100, and is realized by the I/F 50 and the LCD 60 shown in FIG. 46. The communications unit 130 is an interface for performing communications with the server device 200, and is realized by the I/F 50 shown in FIG. 46. The control unit 140 implements various control operations for the client device 100, including those for the input unit 110, the display unit 120, and the communications unit 130. The control unit 140 implemented as a program loaded in the RAM 20 shown in FIG. 46, is operated according to control by the CPU 10.

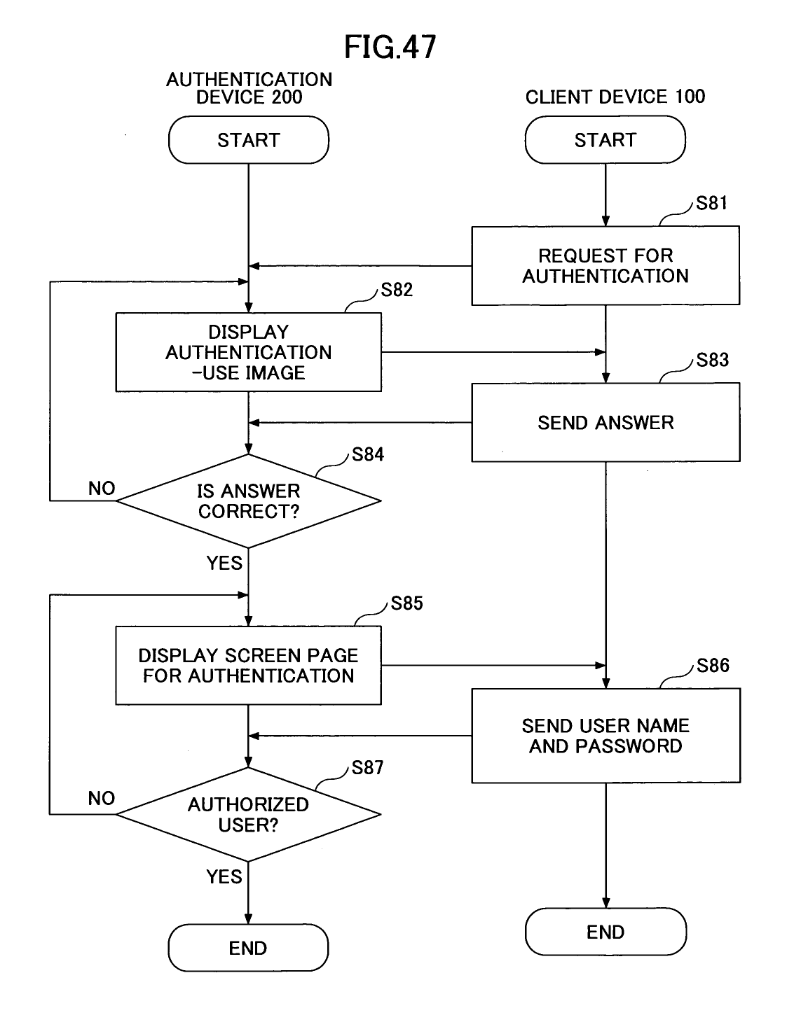

Next, a description is given of the respective function units of the server device 200. The authentication unit 210 performs authentication based on information received from the client device 100. For example, the authentication unit 210 determines (authenticates) whether the user of the client device 100 is an actual human being or an automated computer program. Furthermore, the authentication unit 210 performs user authentication of the client device 100 based on a user name or a password received from the client device 100. These operations are described below with reference to FIG. 47. The authentication unit 210 implemented as a program loaded in the RAM 20 shown in FIG. 46, is operated according to control by the CPU 10.

The authentication-use image generating unit 220 generates an authentication-use image according to an embodiment of the present invention. Examples of the authentication-use image are described below. The authentication-use image generating unit 220, implemented as a program loaded in the RAM 20 shown in FIG. 46, is operated according to control by the CPU 10. The authentication-use image presenting unit 230 presents, to the client device 100, an authentication-use image which has been generated by the authentication-use image generating unit 220. Specifically, the authentication-use image presenting unit 230 generates display information for displaying the authentication-use image on a display unit of the client device 100. The authentication-use image presenting unit 230, implemented as a program loaded in the RAM 20 shown in FIG. 46, is operated according to control by the CPU 10.

The communications unit 240 is an interface for performing communications with the client device 100. The communications unit 240 is realized by the I/F 50 shown in FIG. 46. The service providing unit 250 provides services to the client device 100 in response to a service request received from the client device 100, in the event that the authentication is successful at the authentication unit 210. The service providing unit 250, implemented by an application that is constituted as the program loaded in the RAM 20 shown in FIG. 46 and a recording medium such as the HDD 40 shown in FIG. 46, is operated according to control by the CPU 10. The control unit 260 implements various control operations for the server device 200, including those for the authentication unit 210, the authentication-use image generating unit 220, the authentication-use image presenting unit 230, the communications unit 240, and the service providing unit 250. The control unit 260, implemented as a program loaded in the RAM 20 shown in FIG. 46, is operated according to control by the CPU 10.

(Operational Examples of Authentication System)

FIG. 47 is a flowchart illustrating an example of operations of the authentication system according to the fourth embodiment. The server device 200 performs an authentication operation for determining whether the user of the client device 100 is an actual human being.

First, the client device 100 requests the server device 200 to perform authentication (S81). In this example, the user sends a request from the client device 100 to the server device 200, to perform authentication. The request can be a service request for receiving a service.

In step S82, the server device 200 presents an authentication-use image to the client device 100 for the visual anti-robot test (step S82). The authentication-use image generating unit 220 generates an authentication-use image. Next, the authentication-use image presenting unit 230 presents the authentication-use image generated by the authentication-use image generating unit 220 to the client device 100. Next, the display unit 120 of the client device 100 displays the authentication-use image.

In step S83, the client device 100 sends the test result (answers) to the server device 200 (step S83). The user reads the contents in the authentication-use image presented at step S82, and inputs, with the input unit 110, test result information, i.e., the read contents. The test result information input with the input unit 110 is transmitted to the server device 200.

In step S84, the server device 200 determines whether the test result information received at step S83 is correct (step S84). The authentication unit 210 makes the determination (authentication) by determining whether the test result information received at step S83 is the correct answer for the authentication-use image presented at step S82. When it is determined that the information is correct (Yes in step S84), the process proceeds to step S85. When it is determined that the information is incorrect (No in step S84), the process returns to step S82.

In step S85, the server device 200 displays the screen page for authentication at the client device 100 (step S85). For example, the server device 200 presents a known screen page for authenticating the user, which includes a user name (user identification character string) input form and a password input form, and prompts the user to input this information for user authentication.

In step S86, the client device 100 sends the user name and the password to the server device 200 (step S86). The user inputs, with the input unit 110, the user name and the password into the screen page for authentication presented at step S85. The information including the user name and the password input with the input unit 110 is transmitted to the server device 200.

In step S87, the server device 200 determines whether the user is an authorized user based on the information including the user name and the password received at step S86 (step S87). The authentication unit 210 makes the determination (authentication) by comparing the information including the user name and the password received at step S86 with user information managed in the HDD 40.

When the user is determined to be an authorized user (Yes in step S87), the service providing unit 250 starts providing a service of the actual purpose, such as displaying a content posting form, for example. When the user is determined to be an unauthorized user (No in step S87), the process returns to step S85. By the above-described process, the server device 200 can perform the authentication operation of determining (authenticating) whether the user of the client device 100 is an actual human being.

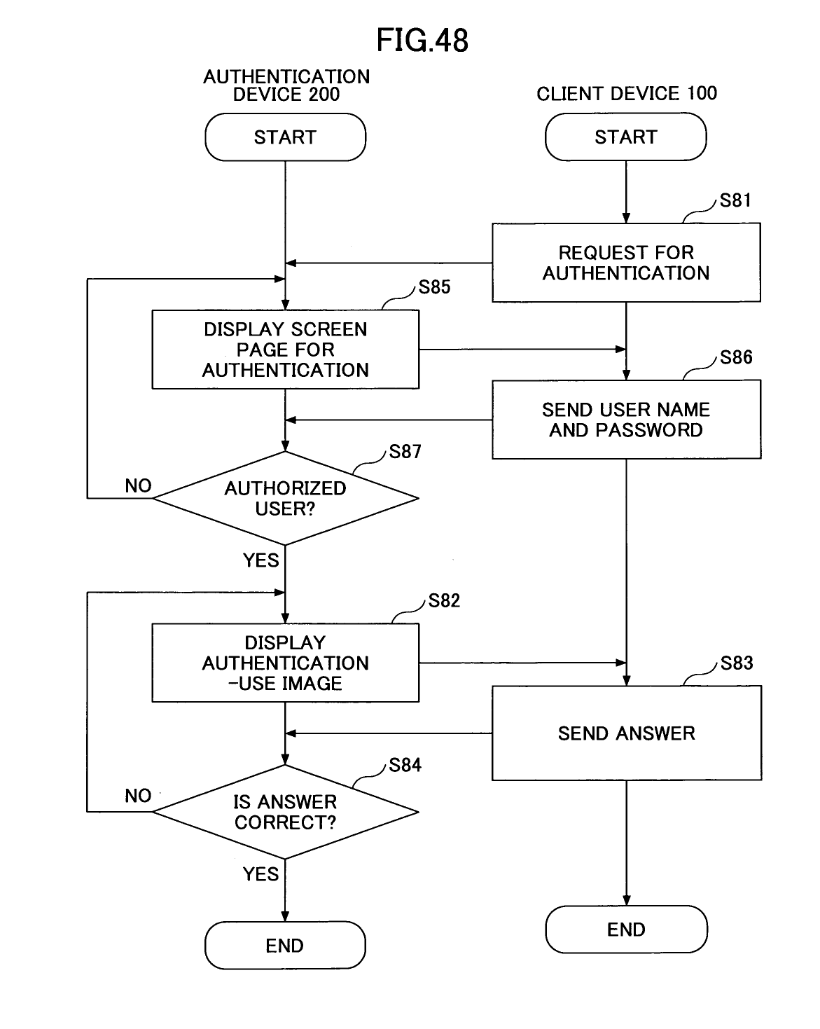

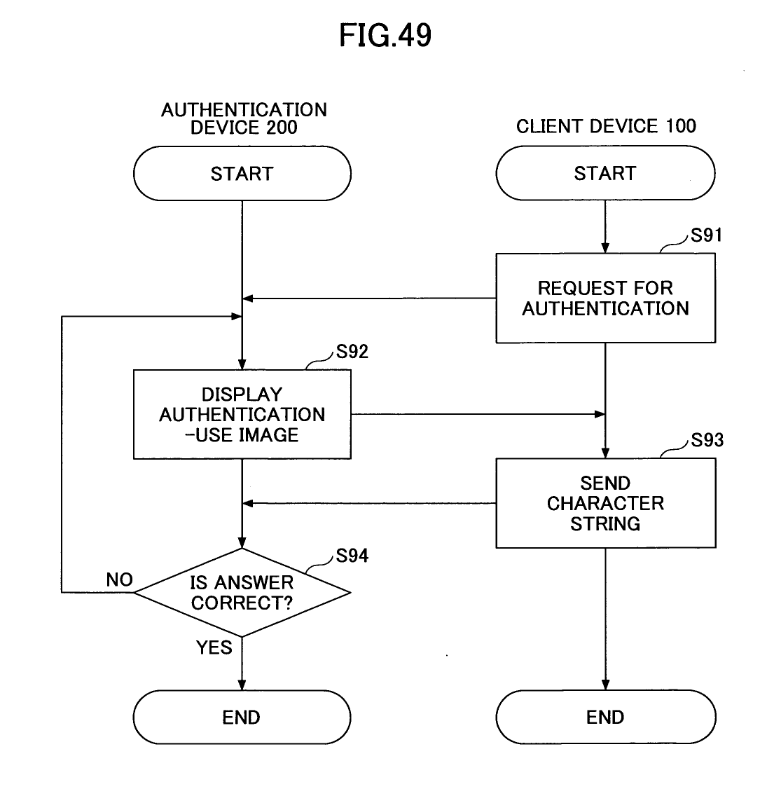

The procedures of steps S82 through S84, corresponding to the visual anti-robot test process, and the procedures of steps S85 through S87, corresponding to the user authentication process, can be performed in the inverse order, as shown in FIG. 48. Furthermore, when the request from the user to the server is to acquire an account, only the procedures of steps S91 through S94 shown in FIG. 49 corresponding to the visual anti-robot test process are performed, and the user registration can be performed (not shown) after these steps. The procedures of steps S91 through S94 shown in FIG. 49 are the same as those of steps S81 through S84 shown in FIG. 47, respectively, and are therefore not further described.

In the following, a description is given of several specific examples of screen pages for authentication and pairs of authentication-use images (group of images) used in the fourth embodiment according to the present invention, which solve the problems of the conventional technology.

(First Example of Authentication-Use Image and Screen Page Presenting Authentication-Use Image)

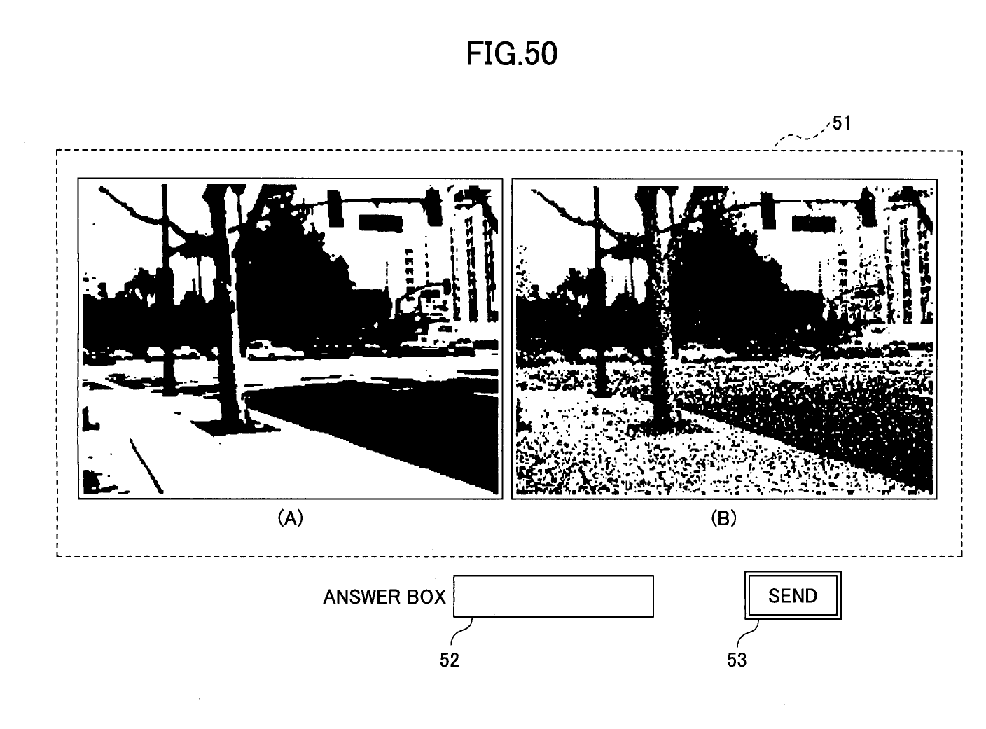

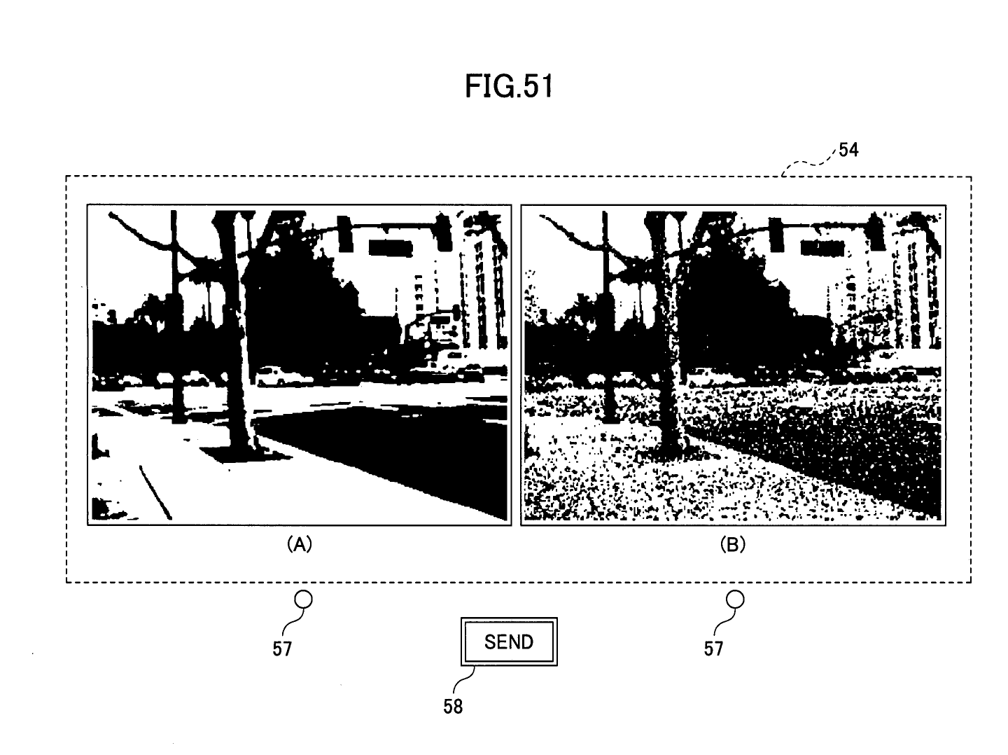

With reference to FIGS. 50 and 51, descriptions are given of examples of authentication-use images according to the fourth embodiment. The images shown in FIG. 50 are a first example of the authentication-use images presented to the client device 100 by the server device 200 in step S82 of FIG. 47. Each of the examples shown in FIGS. 50 and 51 presented in step S82 of FIG. 47 is presented as a pair of authentication-use images (hereinafter, “authentication-use image pair”). In the fourth embodiment, the authentication device presents the authentication-use image pair shown in FIG. 50 to the user, including a photograph image (original photograph image) and an image that is perceived as having degraded quality which is generated from the original photograph image.

The contents of the displayed screen page shown in FIG. 50 include an authentication-use image section 51 at the top, an answer box 52 for inputting the selection results of the user, and a send button 53 for sending the selection of the user input into the answer box 52 to the server device 200.

In FIG. 50, the authentication-use image pair presented in the authentication-use image section 51 includes a clear original photograph image on the left side and a processed image on the right side (image that is perceived as having degraded quality which is generated from the original photograph image), which are arranged horizontally side by side. The original photograph image and the processed image are given identification information expressed by the alphabetical letters (A) and (B), respectively. The user perceives the clearer image, and inputs the corresponding identification information “A” in the answer box 52 with the keyboard, and performs a determining operation (e.g., press the return key) to send the input letter as an answer. Instead of performing the determining operation, the send button 53 can be pressed to send the answer.

In the examples shown in FIGS. 50 and 51, (A) corresponds to the original photograph image (original image) that has not undergone the image quality degrading process, and (B) corresponds to the image (degraded image) obtained by adding noise to the image (A). In order to add noise to the image, a normal distribution random number sequence defined with, for example, an average value μ=0 and a dispersion s2=10 (2 means square), is added to each pixel of the original image. These are presented in a spatially random order for each test.

As evident from FIG. 50, a human being can determine which image has better quality at a glance. A computer program may be able to recognize that the images are different. However, image quality is not an intrinsic characteristic of the image; image quality is something that is sensed by the human being who is observing the image. Accordingly, it is considerably difficult for a computer program to determine the superiority/inferiority of image quality. If the type of the factor causing image degradation (in this example, noise) is known, the computer program may be able to determine the superiority/inferiority of image quality to some extent, by comparing frequency characteristics with the use of two-dimensional frequency analysis (FFT). However, even if this were the case, complex image processing would be required, which would require hardware such as a large memory and a high-speed CPU, which leads to increased cost.

Accordingly, increased complexity in the technology for passing the authentication test (visual anti-robot test) using the first example of the authentication-use image leads to increased cost. Thus, in order to make a nuisance with the use of a “bot”, hardware of higher performance is required, or the frequency of nuisances per unit time needs to be decreased. Therefore, it will become more impractical to make a nuisance. Incidentally, the original image used in the visual anti-robot test is preferably different for each session, and similarly, the order in which the original image and the degraded image are presented is preferably different for each session.

In the present embodiment, noise is used as the factor for degrading the image quality. Other factors may also be used, such as blurring the image or reversing the colors. Another method is to add irregularly-arranged polkadots to the image. Yet another method is to have the user select the processed image with degraded image quality as the answer, instead of the original image.

(Second Example of Screen Page Presenting Authentication-Use Image)

Next, with reference to FIG. 51, a description is given of a second example of the screen page presenting the authentication-use images according to the fourth embodiment of the present invention. The displayed screen page shown in FIG. 51 is presented to the client device 100 by the server device 200 in step S82 of FIG. 47. The contents of the displayed screen page shown in FIG. 51 includes an authentication-use image section 54 for presenting plural authentication-use images, tick buttons 57 provided at each of the images in the authentication-use image section 54 for having the user make a selection, and a send button 58 for sending the user's selection made with the tick buttons 57 to the server device 200.

In FIG. 51, the authentication-use image pair presented in the authentication-use image section 54 includes a clear original photograph image on the left side and a processed image on the right side (image that is perceived as having degraded quality which is generated from the original photograph image), which are arranged horizontally side by side. The original photograph image and the processed image are given identification information of the alphabetical letters (A) and (B), respectively. The user perceives the clearer image, inputs a tick mark in the left tick button 57, and presses the send button 53 to send the answer.

As described above, in the fourth embodiment, the user (client) inputs the ID of the original image as the answer (in this case, (A)), or clicks the check box 57 corresponding to the original image out of the two check boxes 57 appended to the images, to answer which image is not the degraded one. Alternatively, the user (client) may input the ID of the degraded image as the answer (in this case, (B)), or click the check box 57 corresponding to the degraded image. In either case, when the answer is correct, the server determines that the client is a human being.

(Third Example of Screen Page Presenting Authentication-Use Image)

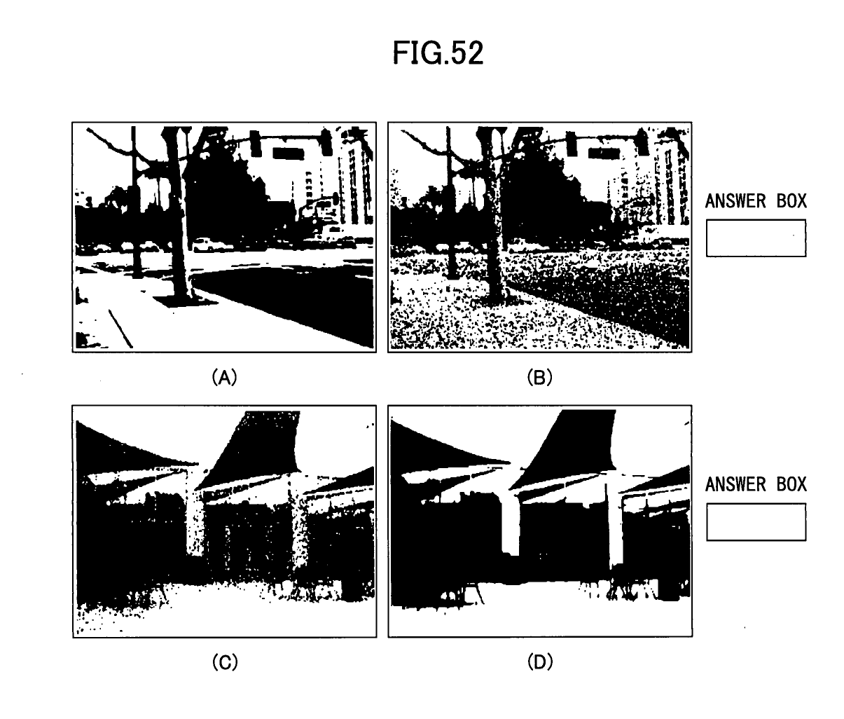

Next, with reference to FIG. 52, a description is given of a third example of the screen page for authentication according to the fourth embodiment of the present invention. In the third example of the screen page for authentication, two pairs of images are presented as the authentication-use images. Each of the images in the image pairs are given identification information expressed by alphabetical letters such as (A) and (B). Furthermore, answer boxes are provided on the right side of each image pair. Each of the examples shown in FIGS. 50 and 51 is a test of a twofold choice. Thus, when either image is selected arbitrarily, there is a 50% probability of selecting the correct answer, which is disadvantageous considering the purpose of such a test. In the third example, as shown in FIG. 52, the server presents plural tests (only two tests are presented in this example as a matter of simplification), and the client inputs the ID of the original image for each test (in this case, (A) and (D)). By increasing the number of tests, the probability of selecting the correct answer by chance can be reduced. For example, when five tests are presented, the probability of selecting the correct answer by chance can be reduced to less than or equal to 5%. Accordingly, in a practical situation, a larger number of tests than 5 are preferably presented. The original image used for the visual anti-robot test is preferably different for each session, and similarly, the order in which the original image and the degraded image are presented is preferably different for each session.

(Fourth Example of Screen Page Presenting Authentication-Use Image)

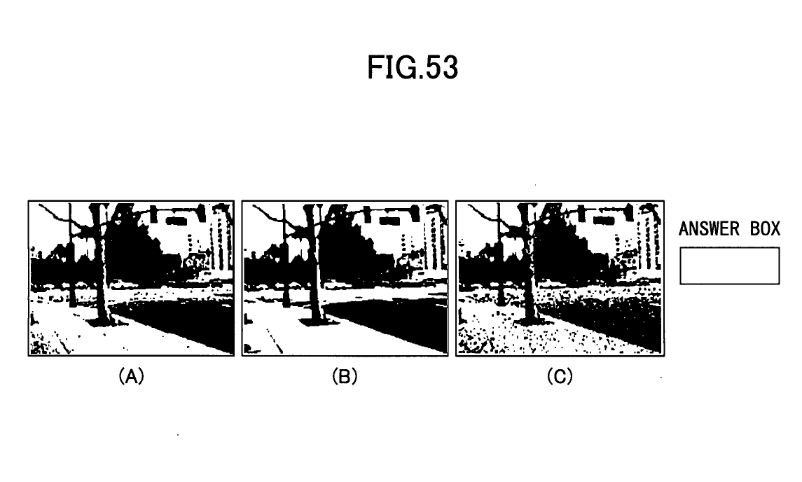

Next, with reference to FIG. 53, a description is given of a fourth example of the screen page for authentication according to the fourth embodiment of the present invention. The fourth example of the screen page for authentication presents, as the authentication-use images, an original image (B), and plural degraded images (A) and (C) (in this case, two images as a matter of simplification) which are obtained by superposing different levels of noise on the original image (B) so as to obtain different perceived image qualities. In this example, the noise superposed in (C) is greater than the noise superposed on (A). The client provides, as the answer, the IDs of the images in a descending order of image quality. In this case, the answer is “(B), (A), (C)”. For human being, it is considerably easy to determine the order of superiority in the image quality. However, image quality is not an intrinsic characteristic of the image; image quality is something that is sensed by the human being who is observing the image. Accordingly, it is considerably difficult for a computer program to determine the superiority/inferiority of image quality. The original image used in the visual anti-robot test is preferably different for each session, and similarly, the order in which the original image and the degraded image are presented is preferably different for each session. With such a configuration, the probability of selecting the correct answer by chance can be reduced. It is better to have a larger number of degraded images with respect to the original. However, by using two or more sets of images as shown in FIG. 52, the probability of selecting the correct answer by chance can be further reduced. In the present embodiment, noise is used as the factor for degrading the image quality. Other factors may also be used, such as blurring the image.

A modification of the fourth example is described with reference to FIG. 53. As shown in FIG. 53, the server presents to the client, as the authentication-use images, an original image (B), and plural degraded images (A) and (C) (in this case, two images as a matter of simplification). The degraded images (A) and (C) are obtained by superposing noise on the original image (B). The levels of noise are different for the degraded images (A) and (C), so that the perceived image quality is different for each image. The client provides, as the answer, the ID of the original image. In this case, the answer is “(B)”. The noises of different levels can be achieved by changing the value of the dispersion (s2) of the normal distribution random number, for example. In this modification, the noise superposed in (C) is greater than the noise superposed on (A). These are presented in a spatially random order for each test. The original image used in the visual anti-robot test is preferably different for each session, and similarly, the order in which the original image and the degraded image are presented is preferably different for each session. With such a configuration, the probability of selecting the correct answer by chance can be reduced. It is better to have a larger number of degraded images with respect to the original. However, by using two or more sets of images as shown in FIG. 52, the probability of selecting the correct answer by chance can be further reduced.

(Fifth Example of Screen Page Presenting Authentication-Use Image)

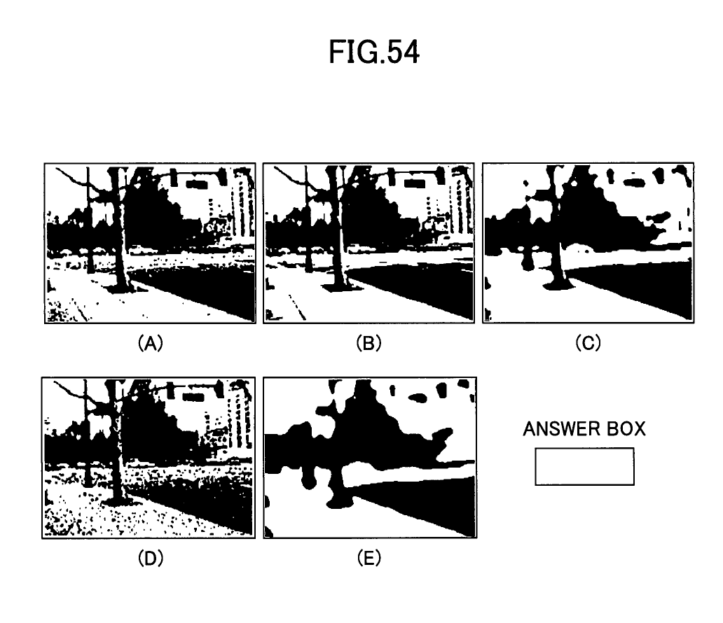

With reference to FIG. 54, a description is given of a fifth example of the screen page for authentication according to the fourth embodiment of the present invention. As shown in FIG. 54, the fifth example of the screen page for authentication presents, as the authentication-use images, an original image (B), degraded images (A) and (D) which are obtained by superposing different levels of noise on the original image (B) so as to obtain different perceived image qualities, and degraded images (C) and (E) which are obtained by blurring the original image by different degrees. Blurred images can be obtained by using a Gaussian filter or a mean filter on the original image. The larger the size of the filter, the more the image becomes blurred. These are presented in a spatially random order for each test. The client inputs the ID of the original image among these images as the answer (in this case, (B)). By using degraded images that have been degraded by different factors as described above, it becomes even more difficult for a computer program to determine the superiority/inferiority of image quality. The original image used in the visual anti-robot test is preferably different for each session, and similarly, the order in which the original image and the degraded image are presented is preferably different for each session. With such a configuration, the probability of selecting the correct answer by chance can be reduced. It is better to have a larger number of degraded images with respect to the original. However, by using two or more sets of images as shown in FIG. 52, the probability of selecting the correct answer by chance can be further reduced.

(Sixth Example of Screen Page Presenting Authentication-Use Image)

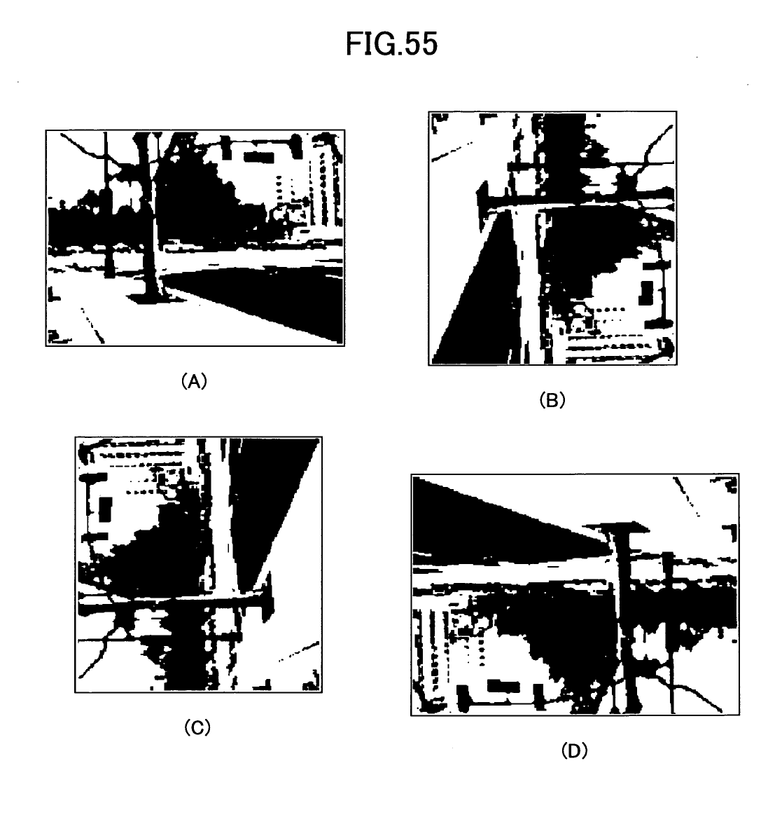

With reference to FIG. 55, a description is given of a sixth example of the screen page for authentication according to the fourth embodiment of the present invention. As shown in FIG. 55, the sixth example of the screen page for authentication presents, as the authentication-use images, an original image (A) and rotated images (B), (C), and (D) obtained by rotating the original image (A). The client inputs the ID of the original image among these images as the answer (in this case, (A)). As evident from FIG. 55, a human being can determine which image is presented in the proper orientation at a glance. A human being acquires the ability of determining the orientation of an image in the process of growing up. However, it is considerably difficult for a computer program to determine the orientation of an image. Therefore, by performing such a test, a human being can be distinguished from a computer program. By using two or more sets of images as shown in FIG. 52, the probability of selecting the correct answer by chance can be further reduced.

Furthermore, in the examples of the aforementioned authentication-use images, when an authentication operation (visual anti-robot test) is performed by the same method every time, the person attempting to make a nuisance may create a “bot” that is dedicated to the particular authentication operation, in order to pass the test. Particularly, if the website has a considerably large number of accesses per day, the cost of creating such a “bot” may be decreased to an acceptable amount.

In a modification of the fourth embodiment of the present invention, there is provided a procedure (step) of randomly selecting one of the examples of the authentication-use images to be presented by the server device 200 in each of the sessions (each of the operations shown in FIG. 47). This would make it difficult to create a “bot” and increase the difficulty and cost for making the nuisance, thereby reinforcing security.

### Fifth Embodiment

A description is given of a fifth embodiment of the present invention with reference to figures. The operation configuration, the hardware configuration, the functional configuration, and the overall operations of an authentication system according to the fifth embodiment are substantially the same as those of the first embodiment, and are therefore not further described. In the authentication system according to the fifth embodiment, the screen page for authentication presented at step S82 in FIG. 47 is different from that of the fourth embodiment.

In step S82 of FIG. 47 according to the fifth embodiment, the server device 200 sends an HTML file to the client. A test program is embedded in the HTML file, which opens in the client's browser. The test program is created with ECMAScript such as Java (registered trademark) Script or a programming language such as Java (registered trademark).

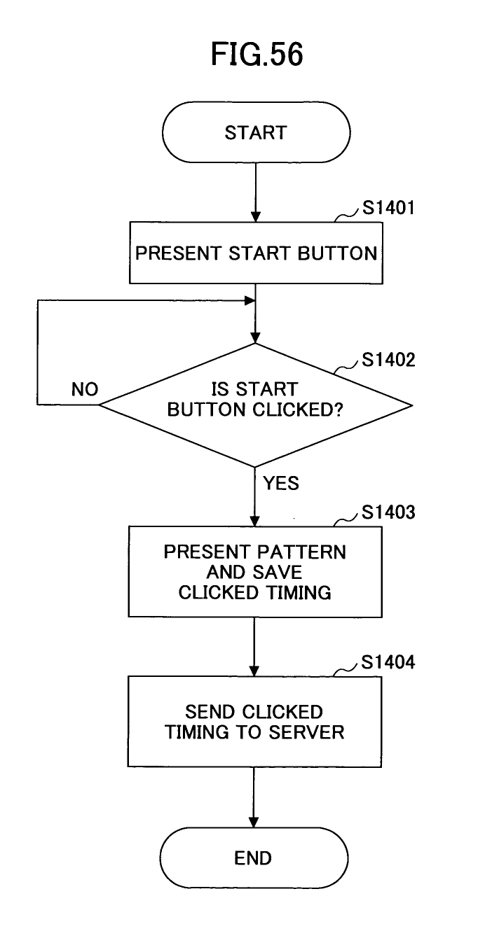

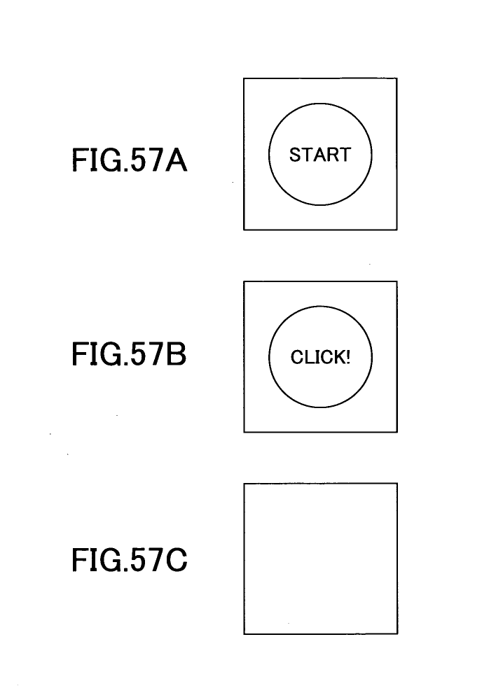

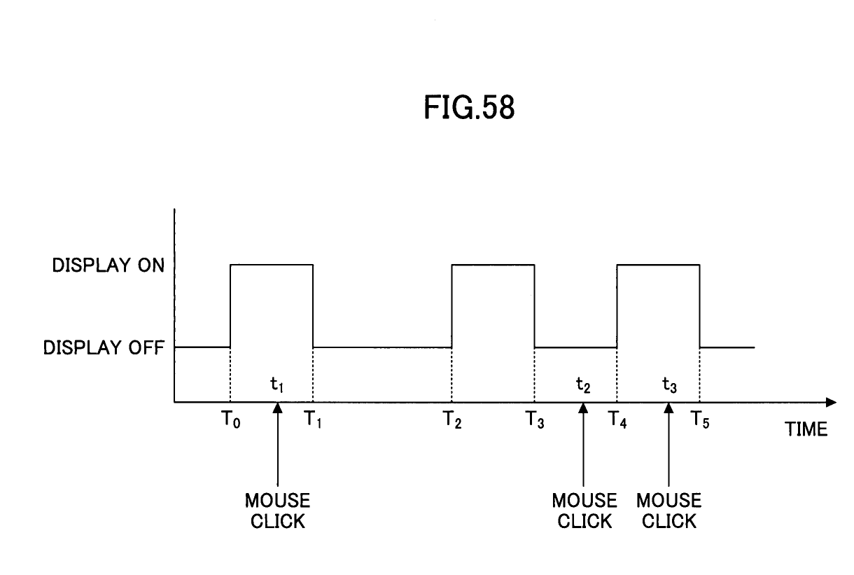

Operations of the test program are described with reference to FIG. 56. As shown in FIG. 56, first, a button shown in FIG. 57A is presented, indicating the start of the test (step S1401). When the user clicks this button (Yes in step S1402), a button shown in FIG. 57B prompting the user to click the button and a space shown in FIG. 57C are presented at timings as indicated in the timing chart shown in FIG. 58.

The timing of displaying the button prompting the user to click the button is randomly determined when the program is sent out from the server, and the determined timing is passed to the program as a parameter. Therefore, the button is presented at random timings for each of the sessions. The user clicks the button with a mouse when this button is displayed. As shown in FIG. 58, the button is displayed (ON) or not displayed (OFF) as follows: ON at T0, OFF at T1, ON at T2, OFF at T3, ON at T4, and OFF at T5. Furthermore, t1, t2, and t3 indicate that the user has clicked the button with a mouse.

The program executed at the client saves the timings at which the user clicks the button. Each time equals the time that has passed from when the test started (step S1403). When the test ends, the program encrypts the times that have been saved, and sends them to the server (step S1404). The procedure at step S1404 corresponds to step S83 in the fourth embodiment. The clicking times are encrypted with the use of a key embedded in the test program beforehand, which key is required for encrypting the times. A symmetric (private) key method or a public (asymmetric) key method is used for the encryption. When a symmetric key method is used, the same key is used for the encryption by the test program and the decryption by the server. When a public key method is used, the public key is used for the encryption by the test program, and a private key corresponding to the public key is used is used for the decryption by the server. A different key (or pair of keys) is used for each session according to the required level of encryption.

The server uses the symmetric key or the private key to decrypt the response from the client. When the time of the response is appropriate with respect to the display timing that is set beforehand (Yes in step S84), the server determines that the user is a human being. Accordingly, the server presents to the client a screen page for user authentication, including a form for inputting a character string to identify the user (user name) and a form for inputting a password (step S85). The server prompts the user to input this information for authentication, and the user inputs the user name and the password (step S86). When the input user name and password correspond to an authorized user (Yes in step S87), the server starts providing the service.

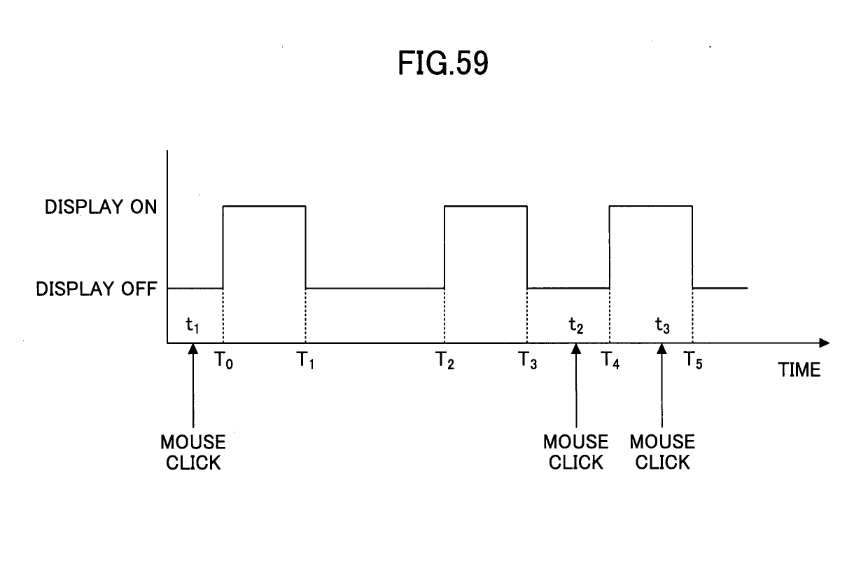

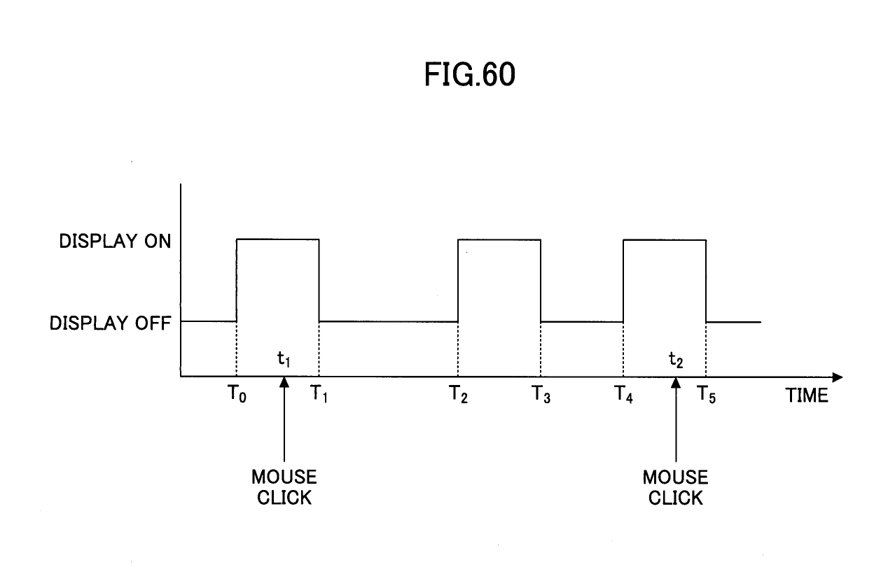

As long as the user clicks the button with a mouse any time between “display ON” and the next “display ON”, the user is determined to be a human being. When the mouse is clicked at a shifted timing as shown in FIG. 59, or when the number of times the mouse is clicked does not match the number of times the button is presented (No in step S87), the user is determined not to be a human, and screen page of user authentication is not presented.

It is considerably difficult for a so-called “bot” to pass such a test according to the fifth embodiment. Even if the “bot” were to pass such a test, it would be required to perform considerably complex processes. Such processes require a large memory and a high-speed CPU, which inevitably leads to increased cost. Therefore, it will be impractical to make a nuisance with the use of “bot”. In a system such as CAPTCHA which uses images including characters that are made obscure, it may be difficult even for a human being to read such characters, which is disadvantageous in terms of usability. However, in the present system, the user is only required to perform a considerably simple task of clicking a displayed button with a mouse, thereby minimizing the decrease in usability.

In the fifth embodiment, the user clicks a mouse as a response. However, the response can be made by striking a key of a keyboard, or by touching a screen of a touch screen panel.

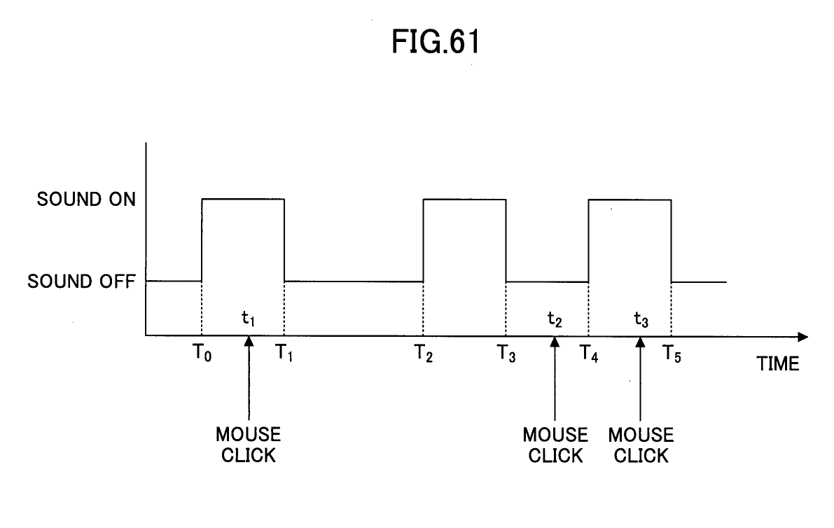

In the fifth embodiment, the user is prompted to respond by clicking buttons displayed as shown in FIGS. 57A through 57C. However, the user may be prompted to perform an operation in response to a sound. The sound may be a spoken word such as “click” or a beep sound. In this case, the buttons shown in FIGS. 57A through 57C are displayed in synchronization with the sounds, and the user clicks the buttons in accordance with the sounds. FIG. 61 is a timing chart of this example, corresponding to FIG. 59. As for the test program, it is only necessary to add a mouse click event. Therefore, the test may be performed by having the user click an arbitrary position in the displayed test program, without displaying any buttons.

In the fifth embodiment, the user is prompted to respond by clicking a button with a mouse at mouse-clicking timings. The user may also be prompted to click plural of buttons. FIG. 62 is a displayed screen page showing such an example. In the example shown in FIG. 62, buttons with numbers are displayed. The numbers given to the buttons are randomly determined when the program is sent out from the server, and the determined numbers are passed to the program as parameters. Therefore, the numbers are randomly assigned to the buttons for each of the sessions.

The user clicks the buttons in the order of the numbers, and finally clicks the end button. The program saves the order in which the user clicked the buttons. When it is determined that the test has ended as the end button is clicked, the program encrypts the saved order, and sends it to the server. When this order is the same as an order set beforehand (Yes in step S84), the server determines that the user is a human being, and presents to the client a screen page for user authentication, including a form for inputting a character string to identify the user (user name) and a form for inputting a password (step S85).

In this system also, the user is only required to perform a considerably simple task of clicking displayed buttons with a mouse, thereby minimizing the decrease in usability. In the present embodiment, plural buttons are labeled with different numbers, thereby clearly indicating the order or making it easy to guess the order. However, the buttons can be labeled with other characters, which also make it easy to guess the order, such as alphabetical letters “a, b, c . . . ”.

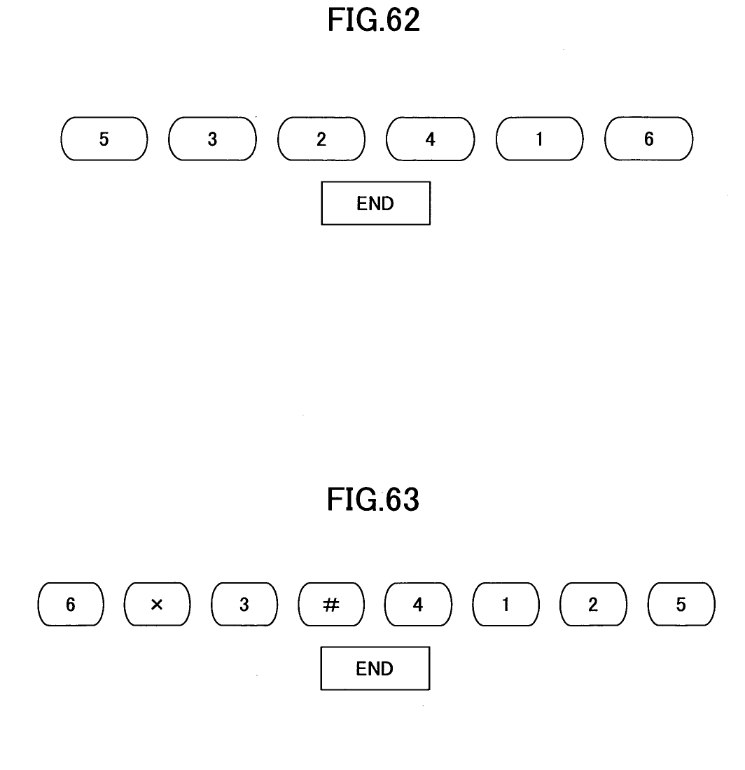

FIG. 63 illustrates a modification of the example shown in FIG. 62. In FIG. 63, the test program displays, in the client's browser, buttons with symbols that are totally unrelated to the numbers of the other buttons. The numbers assigned to the buttons are randomly determined when the program is sent out from the server, and are passed to the program as parameters. Therefore, the numbers are randomly assigned to the buttons for each of the sessions.

The user only clicks the buttons with numbers, in the order of the numbers, and finally clicks the end button. The program saves the order in which the user clicked the buttons. When it is determined that the test has ended as the end button is clicked, the program encrypts the saved order, and sends it to the server. When this order is the same as an order set beforehand (Yes in step S84), the server determines that the user is a human being, and presents to the client a screen page for user authentication, including a form for inputting a character string to identify the user (user name) and a form for inputting a password (step S85). With such a configuration, the probability of a “bot” selecting the correct answer by chance can be reduced even further than the example described with reference to FIG. 62.

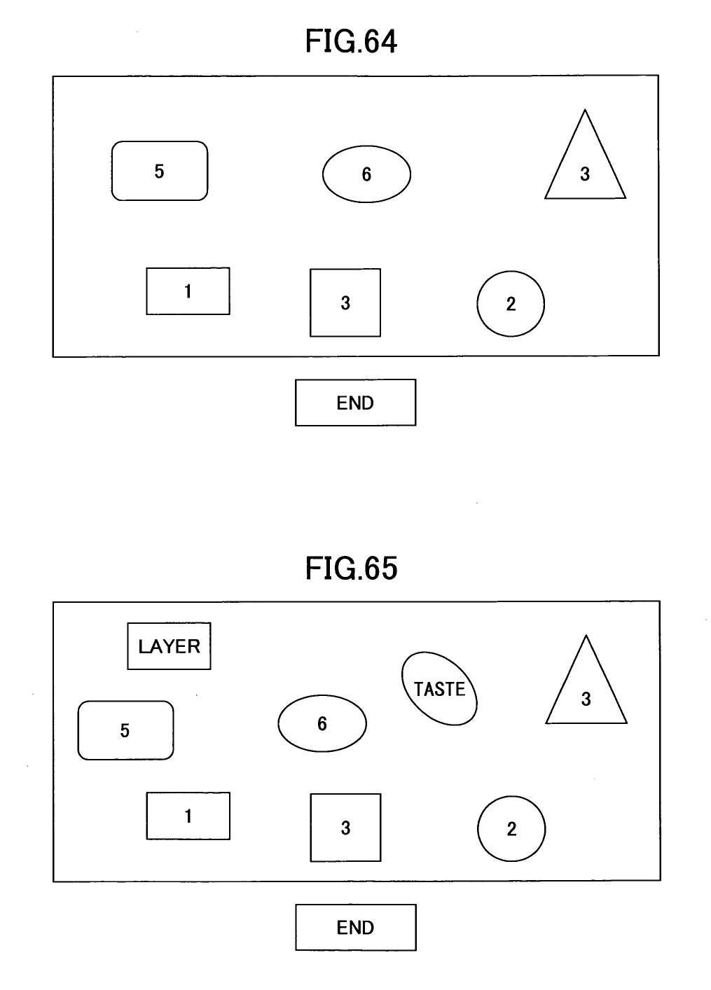

FIG. 64 illustrates another example of the test program according to the fifth embodiment of the present invention.

The test program displays an image including figures with numbers as shown in FIG. 64 on the client's browser. The positions for displaying the figures with the numbers are randomly determined when the program is sent out from the server, and the determined positions are passed to the program as parameters. Therefore, figures are presented at random positions for each of the sessions.

The user clicks the buttons in the order of the numbers, and finally clicks the end button. The program saves the order in which the user clicked the buttons. When it is determined that the test has ended as the end button is clicked, the program encrypts the saved order, and sends it to the server. When the clicked positions are within a region of figures set beforehand, and the order of clicking the figures is the same as an order set beforehand (Yes in step S84), the server determines that the user is a human being, and presents to the client a screen page for user authentication, including a form for inputting a character string to identify the user (user name) and a form for inputting a password (step S85).

In this system also, the user is only required to perform a considerably simple task of clicking displayed buttons with a mouse, thereby minimizing the decrease in usability. In the present embodiment, plural buttons labeled with different numbers, thereby clearly indicating the order or making it easy to guess the order. However, the buttons can be labeled with other characters which make it easy to guess the order, such as alphabetical letters “a, b, c . . . ”.

FIG. 65 illustrates a modification of the example shown in FIG. 64. In FIG. 65, the test program displays, in the client's browser, buttons with symbols that are totally unrelated to the numbers of the other buttons. The positions for displaying the figures with the numbers are randomly determined when the program is sent out from the server, and the determined positions are passed to the program as parameters. Therefore, figures are presented at random positions for each of the sessions.

The user clicks the buttons in the order of the numbers, and finally clicks the end button. The program saves the order in which the user clicked the buttons. When it is determined that the test has ended as the end button is clicked, the program encrypts the saved order, and sends it to the server. When the clicked positions are within a region of figures set beforehand, and the order of clicking the figures is the same as an order set beforehand (Yes in step S84), the server determines that the user is a human being, and presents to the client a screen page for user authentication, including a form for inputting a character string to identify the user (user name) and a form for inputting a password (step S85).

In this system also, the user is only required to perform a considerably simple task of clicking displayed buttons with a mouse, thereby minimizing the decrease in usability. In the present embodiment, plural buttons labeled with different numbers, thereby clearly indicating the order or making it easy to guess the order. However, the buttons can be labeled with other characters which make it easy to guess the order, such as alphabetical letters “a, b, c . . . ”.

### Sixth Embodiment

A description is given of a sixth embodiment of the present invention with reference to figures. The operation configuration, the hardware configuration, the functional configuration, and the overall operations of an authentication system according to the sixth embodiment are substantially the same as those of the first embodiment, and are therefore not further described. In the authentication system according to the sixth embodiment, the screen page for authentication presented at step S82 in FIG. 47 is different from that of the fourth embodiment.

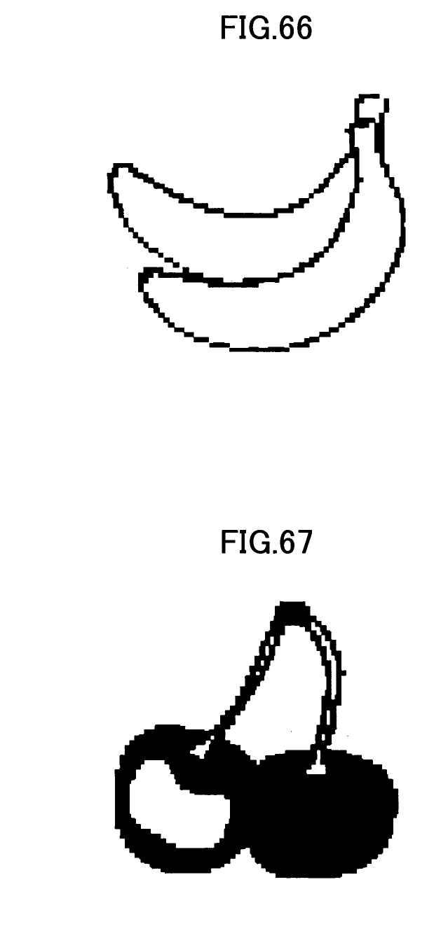

In step S82 of FIG. 47 according to the sixth embodiment, the server device 200 combines two or more kinds of arbitrary images as shown in FIGS. 66 and 67, and presents an image for the visual anti-robot test as shown in FIG. 68. In addition to the image shown in FIG. 68, the server device 200 presents information for displaying a question such as “input two words indicating the presented image”.

In the case of a combination of images that can be easily recognized as shown in FIGS. 66 and 67, the human being can supplement the hidden parts in his brain, to estimate the original images. Accordingly, the human being can easily input “banana” and “cherry” in response to a request for recognition. However, when a computer program attempts to recognize such an image, the computer program cannot restore the original image unless the original image or the combination method is clearly known.

Moreover, even when the computer program is able to restore an original image, the computer program needs to recognize the image. Thus, in order to extract the two words of “banana” and “cherry” from a “bot”, a complex image process is required as the preprocess. Such a preprocess requires a large memory and a high-speed CPU, which inevitably leads to increased cost. Accordingly, increased complexity in the technology for passing the authentication test according to the sixth embodiment leads to increased cost. Thus, in order to make a nuisance with the use of a “bot”, hardware of higher performance is required, or the frequency of nuisances per unit time needs to be decreased. Therefore, it will become more impractical to make a nuisance.

In the present invention, the images are combined in the form of thin strips. The width of the strips is not fixed. The width can be different in each of the sessions. However, depending on the image, the human being may not be able to recognize the image if the strips are too wide or too narrow. In the sixth embodiment, the strips are arranged side by side along a horizontal direction. However, the strips may be arranged side by side along a vertical direction or an oblique direction. The direction in which strips are arranged may be different for each of the sessions.

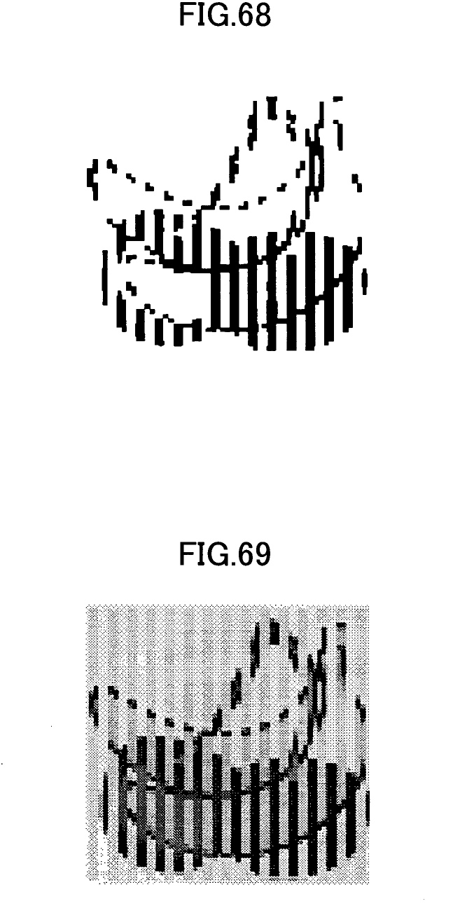

When two images are combined in the form of strips, the backgrounds of the images preferably have the same color or texture. This way it is advantageous in that the edges cannot be detected (by a “bot”) upon separating the images. When the background colors of the combined images are different as in the example shown in FIG. 69, the edges may be detected by each background color, and the images may be recognized.

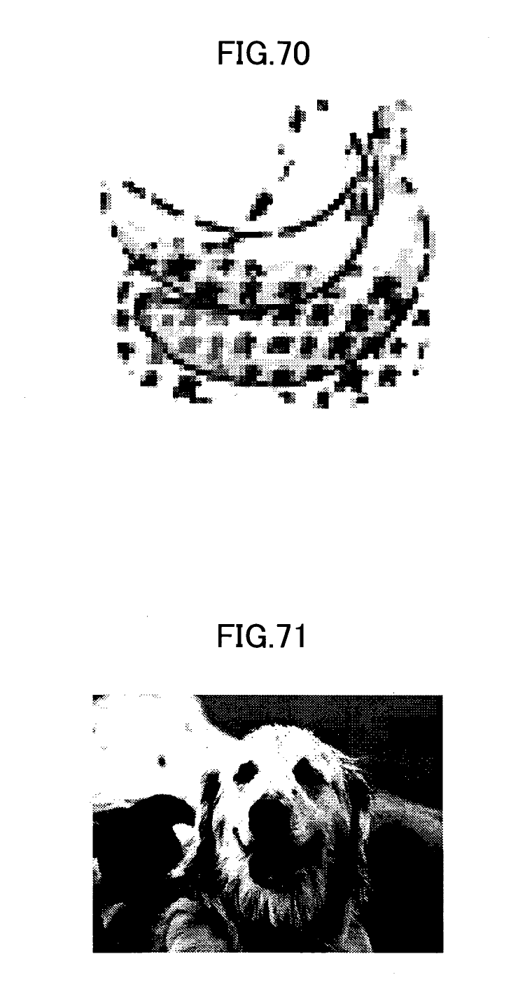

The presented images may be combined in the form of a jigsaw puzzle as shown in FIG. 70, instead of in the form of strips as shown in FIG. 68. An image with a dithered mask is also effective. In the present invention, the number of images that can be presented is expressed by N×(N−1)×M, where N is the number of types of images, and M is the number of variations of combinations of the images.

In the above embodiment, if the number of variations is small, the person attempting to make a nuisance may create a “bot” that is dedicated to the particular test, in order to pass the test. Particularly, if the website has a considerably large number of accesses per day, the cost of creating such a “bot” may be decreased to an acceptable amount. Thus, the combinations are preferably randomly changed, in order to increase the variations of images to be presented. Such an operation increases the difficulty and the cost for creating and executing a “bot”. Therefore, it will become more impractical to make a nuisance.

As described above, if the number of variations of images to be presented is small, the “bot” may pass the test. However, it is difficult to prepare a vast number of illustrations. Therefore, images to be presented can be created with combinations of natural images. However, it is necessary to use an image with which “only a human being can past the test and a robot cannot past the test” in the visual anti-robot test. Accordingly, the image not only needs to be difficult for a robot to recognize, but the image also needs to be easy for a human being to recognize. Incidentally, a natural image means an image such as a photograph. A normatural image means an illustration, a lineal drawing, and CG (Computer Graphics).

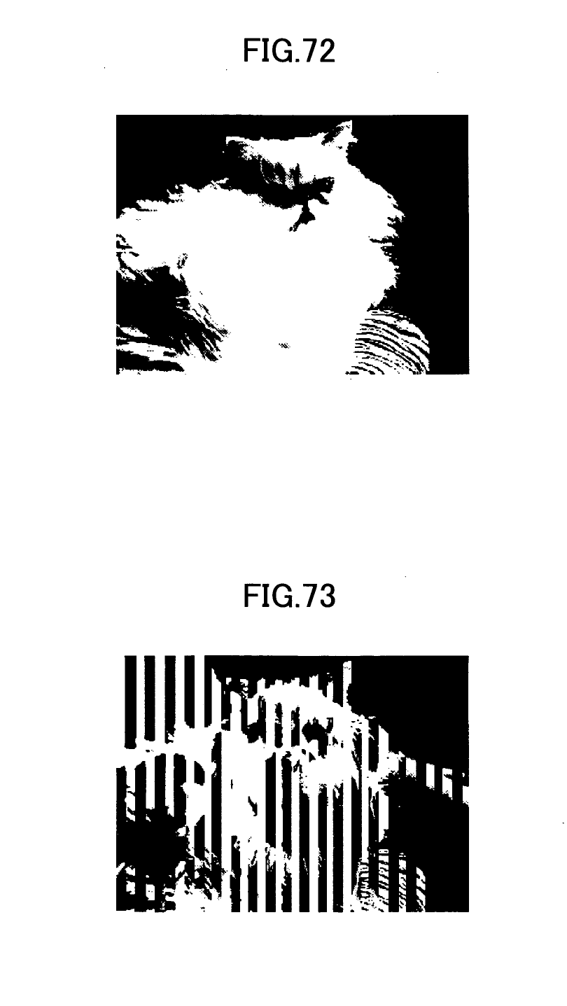

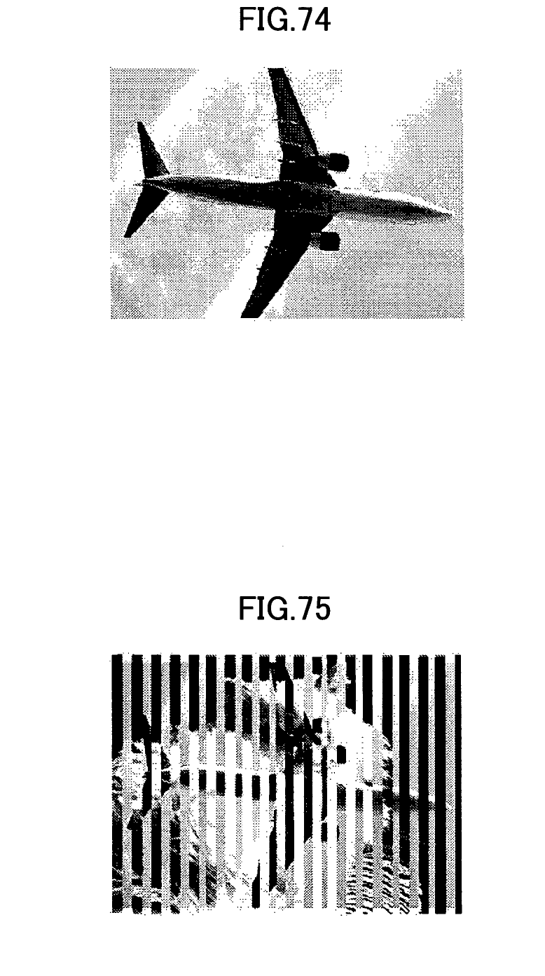

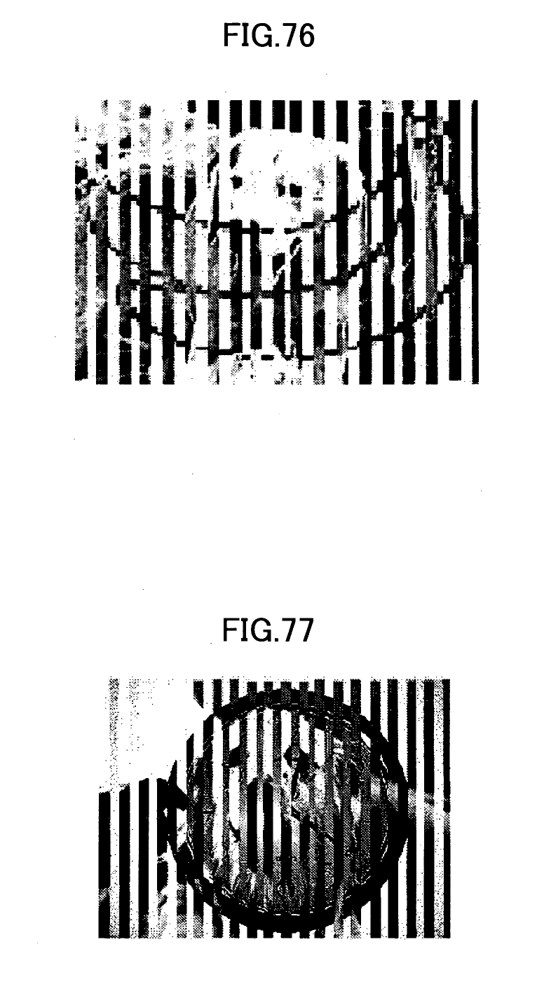

For example, when images of the same genre such as “an animal and an animal” are combined (FIG. 73), including a “dog” shown in FIG. 71 and a “cat” shown in FIG. 72, the images may be difficult for a human being to recognize. It is easier to complement the hidden parts with simplified images. Therefore, when combining two natural images, images of different categories such as “an animal and an inanimate being” are preferably combined (FIG. 75), including a “cat” shown in FIG. 72 and an “airplane” shown in FIG. 74. This reduces erroneous recognitions made by human beings. Erroneous recognitions can be further reduced by combining a natural image and an illustration as shown in FIG. 76.

In a test for making a user answer what the combined images are, it may be possible to pass the test by combining common nouns with the use of a dictionary, without recognizing the images at all. In this case, when there are only two images used for the combination, it may be easy to pass the test. Thus, it is effective to combine a recognition question, which cannot be answered unless the user recognizes the image.

For example, the image shown in FIG. 77 is presented, and in addition, a question is presented saying “Q1:” What are in the image? Please give two objects”. When the user passes this question by giving the answer “A1: A dog and a clock”, the next question is presented. An example of the next question is “Q2: What time is this image indicating?” When the user gives the answer “A2: Four o'clock”, the user passes the authentication test.

Q1 is a combination of two common nouns in a dictionary, which may be easy for a robot to find, but Q2 cannot be answered unless the image is recognized. A human can easily recognize the image and give the correct answer to Q2, but Q2 is a difficult question for a robot.

Examples of questions that cannot be answered unless the image is recognized are “Q2: What is the shape of this clock?” The answer is “A2: A circle”. It is possible to prepare plural variations of Q2, and present them randomly for each of the sessions. Such an operation increases the difficulty and the cost for creating and executing a “bot”. Therefore, it will become more impractical to make a nuisance.

The present invention is not limited to the specifically disclosed embodiment, and variations and modifications may be made without departing from the scope of the present invention.

The present application is based on Japanese Priority Patent Application No. 2008-063170, filed on Mar. 12, 2008, and Japanese Priority Patent Application No. 2008-234029, filed on Sep. 11, 2008, the entire contents of which are hereby incorporated herein by reference.

What is claimed is:

1. An authentication method performed by an authentication device to authenticate a user, the authentication method comprising:
an authentication-use image generating step of generating an authentication-use image comprising authentication-use information corresponding to an image expressing one or more characters and/or symbols which is provided on a background, wherein an edge formed by a difference in image density does not exist between the background and the image expressing the characters and/or the symbols;
an authentication-use image presenting step of presenting, to the user, the authentication-use image generated at the authentication-use image generating step; and
an authentication step of performing authentication by comparing character and/or symbol information input by the user based on the authentication-use image presented at the authentication-use image presenting step, with the characters and/or the symbols in the authentication-use image.

2. The authentication method according to claim 1, wherein:
in the authentication-use image generated at the authentication-use image generating step, the background is constituted by a first texture and the authentication-use information corresponding to the image expressing the characters and/or the symbols is constituted by a second texture that is different from the first texture.

3. The authentication method according to claim 2, wherein:
an average value of an image density of the first texture and an average value of an image density of the second texture are substantially equal.

4. The authentication method according to claim 1, wherein:
the authentication-use image generated at the authentication-use image generating step is a stereogram image in which the image expressing the characters and/or the symbols is embedded.

5. The authentication method according to claim 1, wherein:
in the image expressing the characters and/or the symbols included in the authentication-use image generated at the authentication-use image generating step, each of the characters and/or the symbols is constituted by plural characters and/or symbols.

6. The authentication method according to claim 1, wherein:
in the image expressing the characters and/or the symbols included in the authentication-use image generated at the authentication-use image generating step, each of the characters and/or the symbols is constituted by a group of dots indicating features of the corresponding character and/or symbol.

7. The authentication method according to claim 1, wherein:
the authentication-use image presenting step further comprises a step of prompting the user to select the characters and/or the symbols included in the authentication-use image; and
the authentication step comprises a step of performing the authentication by comparing the character and/or symbol information corresponding to the characters and/or the symbols selected by the user based on the authentication-use image presented at the authentication-use image presenting step, with the characters and/or the symbols in the authentication-use image.

8. The authentication method according to claim 1, wherein:
the authentication-use image presenting step further comprises a step of presenting a plurality of the authentication-use images and prompting the user to select at least one of the plural authentication-use images that satisfies a predetermined condition; and
the authentication step comprises a step of performing the authentication by comparing the authentication-use image selected by the user from among the plural authentication-use images presented at the authentication-use image presenting step, with the predetermined condition.

9. An authentication method performed by an authentication device to authenticate a user, the authentication method comprising:
an authentication-use video generating step of generating an authentication-use video comprising authentication-use information corresponding to an image expressing one or more characters and/or symbols constituted by a second texture which is provided on a background constituted by a first texture, wherein a positional relationship between the background and the authentication-use information changes with time;
an authentication-use video presenting step of presenting, to the user, the authentication-use video generated at the authentication-use video generating step; and
an authentication step of performing authentication by comparing character and/or symbol information input by the user based on the authentication-use video presented at the authentication-use video presenting step, with the characters and/or the symbols in the authentication-use video.

10. The authentication method according to claim 9, wherein:
in the authentication-use video generated at the authentication-use video generating step, each of the characters and/or the symbols in the image expressing the characters and/or the symbols is constituted by a group of dots indicating features of the corresponding character and/or symbol, and a plurality of the images expressing the characters and/or the symbols is continuously arranged.

11. The authentication method according to claim 9, wherein:
the authentication-use video presenting step further comprises a step of prompting the user to select the characters and/or the symbols included in the authentication-use video; and
the authentication step comprises a step of performing the authentication by comparing the character and/or symbol information corresponding to the characters and/or the symbols selected by the user based on the authentication-use video presented at the authentication-use video presenting step, with the characters and/or the symbols in the authentication-use video.

12. The authentication method according to claim 9, wherein:
the authentication-use video presenting step further comprises a step of presenting a plurality of the authentication-use videos and prompting the user to select at least one of the plural authentication-use videos that satisfies a predetermined condition; and
the authentication step comprises a step of performing the authentication by comparing the authentication-use video selected by the user from among the plural authentication-use videos presented at the authentication-use video presenting step, with the predetermined condition.

13. An authentication device for authenticating a user, the authentication device comprising:
an authentication-use image/video generating unit configured to generate any one of
an authentication-use image comprising authentication-use information corresponding to an image expressing one or more characters and/or symbols which is provided on a background, wherein an edge formed by a difference in image density does not exist between the background and the image expressing the characters and/or the symbols,
the authentication-use image wherein the background is constituted by a first texture and the authentication-use information corresponding to the image expressing the characters and/or the symbols is constituted by a second texture that is different from the first texture,
the authentication-use image corresponding to a stereogram image in which the image expressing the characters and/or the symbols is embedded,
the authentication-use image wherein in the image expressing the characters and/or the symbols, each of the characters and/or the symbols is constituted by plural characters and/or symbols, and
an authentication-use video comprising the authentication-use information corresponding to the image expressing the characters and/or symbols constituted by the second texture which is provided on the background constituted by the first texture, wherein a positional relationship between the background and the authentication-use information changes with time;
an authentication-use image/video presenting unit configured to present, to the user, the authentication-use image or the authentication-use video generated by the authentication-use image/video generating unit; and
an authentication unit configured to perform authentication by comparing character and/or symbol information input by the user based on the authentication-use image or the authentication-use video presented by the authentication-use image/video presenting unit, with the characters and/or the symbols in the authentication-use image or the authentication-use video.

14. A computer-readable recording medium having recorded therein instructions for causing a computer to execute the authentication method according to claim 1.
